(19) United States
(12) Patent Application Publication
(10) Pub. No.: US 2010/0085363 A1
(43) Pub. Date: Apr. 8, 2010

(54) Photo Realistic Talking Head Creation, Content Creation, and Distribution System and Method

(75) Inventors: Shawn A. Smith, Los Angeles, CA (US); Roberta Jean Smith, Santa Monica, CA (US); Peter Gately, Santa Barbara, CA (US); Nicolas Antczak, Sherman Oaks, CA (US)

Correspondence Address: HARVEY LUNENFELD, 8 PATRICIAN DRIVE, E. NORTHPORT, NY, 11731, US

(73) Assignee: PRTH-Brand-CIP

(21) Appl. No.: 12/400,778

(22) Filed: Mar. 9, 2009

Related U.S. Application Data
(63) Continuation-in-part of application No. 12/296,912, filed on Sep. 22, 2009.
Application No. 12/296,912 is a continuation-in-part of application No. 10/219,689, filed on Aug. 14, 2002, now Pat. No. 7,027,054.
(60) Provisional application No. 61/035,022, filed on Mar. 9, 2008.

(51) Int. Cl. G06T 13/00

(52) U.S. Cl. 345/473

(57) ABSTRACT

A system and method for creating, distributing, and viewing photo-realistic talking head based multimedia content over a network, comprising a server and a variety of communication devices, including cell phones and other portable wireless devices, and a software suite, that enables users to communicate with each other through creation, use, and sharing of multimedia content, including photo-realistic talking head animations combined with text, audio, photo, and video content. Content is uploaded to at least one remote server, and accessed via a broad range of devices, such as cell phones, desktop computers, laptop computers, personal digital assistants, and cellular smartphones. Shows comprising the content may be viewed with a media player in various environments, such as internet social networking sites and chat rooms via a web browser application, or applications integrated into the operating systems of the digital devices, and distributed via the internet, cellular wireless networks, and other suitable networks.

This application is a continuation-in-part of U.S. patent application Ser. No. 12/296,912, filed Oct. 10, 2008, which is a continuation-in-part of U.S. patent application Ser. No. 10/219,689, filed Aug. 14, 2002, now U.S. Pat. No. 7,027,054, and this application claims the benefit of U.S. Provisional Application No. 61/035,022, filed Mar. 9, 2008, the full disclosures of which all are incorporated herein by reference. The above referenced documents are not admitted to be prior art with respect to the present invention by their mention herein.

### CROSS-REFERENCES TO RELATED APPLICATIONS

The present application is related to U.S. patent application Ser. No. 12/296,912, filed Oct. 10, 2008, which is the U.S. National Stage Application of International Application No. PCT/US06/13679, filed Apr. 10, 2006. The present application is also related to copending European Patent Application No. 06749903.8, filed Nov. 10, 2008, which is the European Regional Stage Application of International Application No. PCT/US06/13679, filed Apr. 10, 2006. The present application is also related to copending Japanese Patent Application based on PCT/US06/13679, filed Oct. 10, 2008, which is the Japanese National Stage Application of International Application No. PCT/US06/13679, filed Apr. 10, 2006. The present application is also related to copending Canadian Patent Application No. based on PCT/US06/13679, filed Dec. 5, 2008, which is the Canadian National Stage Application of International Application No. PCT/US06/13679, filed Apr. 10, 2006. The present application is also related to copending Australian Patent Application No. 2006352758, filed Nov. 7, 2008, which is the Australian National Stage Application of International Application No. PCT/US06/13679, filed Apr. 10, 2006. The present application is also related to copending New Zealand Patent Application No. 572648, filed Nov. 7, 2008, which is the New Zealand National Stage Application of International Application No. PCT/US06/13679, filed Apr. 10, 2006. The above referenced documents are not admitted to be prior art with respect to the present invention by their mention herein.

### BACKGROUND OF THE INVENTION

1. Field of the Invention

The present invention relates generally to talking heads and more particularly to a system and method for creating, distributing, and viewing photo-realistic talking heads, photo-realistic head shows, and content for the photo-realistic head shows.

2. Background Art

Digital communications are an important part of today's world. Individuals and businesses communicate with each other via networks of all types, including wireless cellular networks and the internet, each of which is typically bandwidth limited. Personal computers, handheld devices, personal digital assistants (PDA's), web-enabled cell phones, e-mail and instant messaging services, pc phones, video conferencing, and other suitable means are used to convey information between users, and satisfy their communications needs via wireless and hard wired networks. Information is being conveyed in both animated and text based formats having video and audio content, with the trend being toward animated human beings, which are capable of conveying identity, emphasizing points in a conversation, and adding emotional content.

Various methods have been used to generate animated images of talking heads, which yield more personalized appearance of newscasters, for example, yet, these animated images typically lack the photo realistic quality required to convey personal identity, emphasize points in a conversation, and add emotional content, are often blurred, have poor lip synchronization, require substantially larger bandwidths than are typically available on most present day networks and/or the internet, and are difficult and time consuming to create. In most instances, photographic realistic images of actual human beings having motion have been limited and/or of low quality, as a result of artifacts that blur the video image when compressed to reduce file size and streamed to reduce download time.

News casting is a fundamental component of electronic communications media, the newscaster format being augmented by graphics and pictures, associated with news coverage, the use of animated images of talking heads, having photo realistic quality and yielding personalized appearance is one of many applications in which such talking heads may be used.

Different methods and apparatus for producing, creating, and manipulating electronic images, particularly associated with a head, head construction techniques, and/or a human body, have been disclosed. However, none of the methods and apparatus adequately satisfies these aforementioned needs for use with handheld devices, cell phones, personal digital assistants, smart phones, and the like.
U.S. Pat. No. 6,919,892 (Cheiky, et al.) discloses a photo realistic talking head creation system and method comprising: a template; a video camera having an image output signal of a subject; a mixer for mixing the template and the image output signal of the subject into a composite image, and an output signal representational of the composite image; a prompter having a partially reflecting mirror between the video camera and the subject, an input for receiving the output signal of the mixer representational of the composite image, the partially reflecting mirror adapted to allow the video camera to collect the image of the subject therethrough and the subject to view the composite image and to align the image of the subject with the template; storage means having an input for receiving the output image signal of the video camera representational of the collected image of the subject and storing the image of the subject substantially aligned with the template.
U.S. Pat. No. 7,027,054 (Cheiky, et al.) discloses a do-it-yourself photo realistic talking head creation system and method comprising: a template; a video camera having an image output signal of a subject; a computer having a mixer program for mixing the template and image output signal of the subject into a composite image, and an output signal representational of the composite image; a computer adapted to communicate the composite image signal thereto the monitor for display thereto the subject as a composite image; the monitor and the video camera adapted to allow the video camera to collect the image of the subject therethrough and the subject to view the composite image and the subject to align the image of the subject therewith the template; storage means having an input for receiving the output signal of the video camera representational of the collected image of the subject, and storing the image of the subject substantially aligned therewith the template.

However, in today's world, communications devices are becoming ever smaller and more portable, giving the ability of average day human beings to communicate with each other globally. There is thus a need for a system and method for creating, distributing, and viewing photo-realistic talking head based multimedia content over a network that may be used to create a photo realistic talking head library, using a substantially small portable device, such as a cell phone or other wireless device. A system and method for creating, distributing, and viewing photo-realistic talking head based multimedia content over a network, and, in particular, a system and method for creating, distributing, and viewing photo-realistic talking heads, photo-realistic head shows, and content for the photo-realistic head shows is necessary. The system and method for creating, distributing, and viewing photo-realistic talking head based multimedia content over the network may comprise a server and a variety of communication devices, including cell phones and other portable wireless devices, and a software suite, that enables users to communicate with each other through creation, use, and sharing of multimedia content, including photo-realistic talking head animations combined with text, audio, photo, and video content. Content should be capable of being uploaded to at least one remote server, and accessed via a broad range of devices, such as cell phones, desktop computers, laptop computers, personal digital assistants, and cellular smartphones. Shows comprising the content should be capable of being viewed with a media player in various environments, such as internet social networking sites and chat rooms via a web browser application, or applications integrated into the operating systems of the digital devices, and distributed via the internet, cellular wireless networks, and other suitable networks.

There is thus a need for a system and method for creating, distributing, and viewing photo-realistic talking head based multimedia content over a network, and, in particular, a system and method for creating, distributing, and viewing photo-realistic talking heads, photo-realistic head shows, and content for the photo-realistic head shows, which allows a user to generate photo realistic animated images of talking heads, talking head shows, and talking head show content quickly, easily, and conveniently. The system and method for creating, distributing, and viewing photo-realistic talking head based multimedia content over a network should yield images that have the photo realistic quality required to convey personal identity, emphasize points in a conversation, and add emotional content, show the animated photo realistic images clearly and distinctly, with high quality lip synchronization, and require less bandwidth than is typically available on most present day networks and/or the internet, and be capable of being used with a wide variety of handheld and portable devices.

The system and method for creating, distributing, and viewing photo-realistic talking head based multimedia content over a network should be capable of being used over a variety of networks, including wireless cellular networks, the internet, WiFi networks, WiMax networks, intranets, and other suitable networks.

The system and method for creating, distributing, and viewing photo-realistic talking head based multimedia content over a network should be capable of capturing frames of an actual human being, and creating a library of photo realistic talking heads in different angular positions. The library of photo realistic talking heads may then be used to create an animated performance of, for example, by the actual human being or user using tools of the system and method for creating, distributing, and viewing photo-realistic talking head based multimedia content over a network for creating photo-realistic head shows and show content.

The human being or user should be capable of developing his or her own photo-realistic talking head shows having the photo realistic quality required to convey personal identity, emphasize points in a conversation, and add emotional content. The animated photo realistic images should show the animated talking head clearly and distinctly, with high quality lip synchronization, and require less bandwidth than is typically available on most present day networks and/or the internet.

The library of photo realistic talking heads should be capable of being constructed quickly, easily, and efficiently by an individual having ordinary computer skills, and minimizing production time, using markers and/or guides, which may be used as templates for mixing and alignment with images of an actual human being in different angular positions.

A library of different ones of marker libraries and/or guide libraries should be provided, each of the marker libraries and/or guide libraries having different ones of the markers and/or guides therein, and each of the markers and/or guides for a different angular position. Each of the marker libraries and/or guide libraries should be associated with facial features for different angular positions of the user and be different one from the other, thus, allowing a user to select the marker library and/or guide library from the library of different ones of the marker libraries and/or guide libraries, having facial features and characteristics close to those of the user.

The talking heads should be capable of being used in a newscaster format, associated with news coverage, the use of animated images of talking heads, having photo realistic quality and yielding personalized appearance, for use in a number and variety of applications.

The system and method for creating, distributing, and viewing photo-realistic talking head based multimedia content over a network should also optionally be capable of creating a library of computer based two dimensional images from digital videotape footage taken of an actual human being. A user should be capable of manipulating a library of markers and/or a library of 3D rendered guide images or templates that are mixed, using personal computer software, and displayed on a computer monitor or other suitable device to provide a template for ordered head motion. A subject or newscaster should be capable of using the markers and/or the guides to maintain the correct pose alignment, while completing a series of facial expressions, blinking eyes, raising eyebrows, and speaking a phrase that includes target phonemes or mouth forms. The session should optionally be capable of being recorded continuously on high definition digital videotape. A user should optionally be capable of assembling the talking head library with image editing software, using selected individual video frames containing an array of distinct head positions, facial expressions and mouth shapes that are frame by frame comparable to the referenced source video frames of the subject. Output generated with the system and method for creating, distributing, and viewing photo-realistic talking head based multimedia content over a network should be capable of being used in lieu of actual video in various applications and presentations on a personal computer, PDA or cell phone. The do-it-yourself photo realistic talking head creation system should also be optionally capable of constructing a talking head presentation from script commands.

The system and method for creating, distributing, and viewing photo-realistic talking head based multimedia content over a network should be capable of being used with portable devices and portable wireless devices. These portable devices and portable wireless devices should include digital communications devices, portable digital assistants, cell phones, notebook computers, video phones, digital communications devices having video cameras and video displays, and other suitable devices.

The portable devices and portable wireless devices should be handheld devices, and the portable wireless devices should be capable of wirelessly transmitting and receiving signals.

A human subject should be capable of capturing an image of himself or herself with a video camera of such a device and view live video of the captured image on a video display of the device.

Markers and/or guide images of the human subject should be capable of being superimposed on the displays of the portable devices and/or portable wireless devices of the do-it-yourself photo realistic talking head creation systems.

Each of the displays of such devices should be capable of displaying a composite image of the collected image of the human subject and a selected alignment template. The display and the video camera should allow the video camera to collect the image of the human subject, the human subject to view the composite image, and align the image of his or her head with the alignment template head at substantially the same angular position as the specified alignment template head angular position.

Such portable devices and/or portable wireless devices should be capable of being connected to a personal computer via a wired or wireless connection, and/or to a remote server via a network of sufficient bandwidth to support real-time video streaming and/or transmission of suitable signals. Typical networks include cellular networks, wireless networks, wireless digital networks, distributed networks, such as the internet, global network, wide area network, metropolitan area network, or local area network, and other suitable networks.

More than one user should be capable of being connected to a remote server at any particular time. Captured video streams and/or still images should be capable of being communicated to the computer and/or the server for processing into a photo realistic talking head library, or optionally, processing should be capable of being carried out in the devices themselves.

Software applications and/or hardware should be capable of residing in such devices, computers and/or remote servers to analyze composite signals of the collected images of the human subjects and the alignment templates, and determine the accuracy of alignment to the markers and/or the guide images.

The system and method for creating, distributing, and viewing photo-realistic talking head based multimedia content over a network should be capable of using voice prompts created by a synthetically generated voice, actual recorded human voice, or via a live human technical advisor, and communicated to the human subject in real-time to assist the user during the alignment process, and alternatively and/or additionally using video prompts. The human subject may then follow the information in the prompts to adjust his or her head position, and when properly aligned initiate the spoken phrase portion of the capture process. Voice and/or video prompts may be used to assist the human subject in other tasks as well, such as when to repeat a sequence, if proper alignment is possibly lost during the capture and/or alignment process, and/or when to start and/or stop the session

Different methods and apparatus for producing, creating, and manipulating electronic images, particularly associated with a head, head construction techniques, and/or a human body, have been known. However, none of the methods and apparatus adequately satisfies these aforementioned needs.

Different apparatus and methods for displaying more than one image simultaneously on one display, and image mixing, combining, overlaying, blending, and merging apparatus and methods have been known. However, none of the methods and apparatus adequately satisfies these aforementioned needs.

Different methods and apparatus for producing, creating, and distributing content. However, none of the methods and apparatus adequately satisfies these aforementioned needs.

For the foregoing reasons, there is a need for a system and method for creating, distributing, and viewing photo-realistic talking head based multimedia content over a network, which allows a user to generate photo realistic animated images of talking heads quickly, easily, and conveniently. The system and method for creating, distributing, and viewing photo-realistic talking head based multimedia content over a network should yield images that have the photo realistic quality required to convey personal identity, emphasize points in a conversation, and add emotional content, show the animated photo realistic images clearly and distinctly, with high quality lip synchronization, and require less bandwidth than is typically available on most present day networks and/or the internet.

The system and method for creating, distributing, and viewing photo-realistic talking head based multimedia content over the network may comprise a server and a variety of communication devices, including cell phones and other portable wireless devices, and a software suite, that enables users to communicate with each other through creation, use, and sharing of multimedia content, including photo-realistic talking head animations combined with text, audio, photo, and video content. Content should be capable of being uploaded to at least one remote server, and accessed via a broad range of devices, such as cell phones, desktop computers, laptop computers, personal digital assistants, and cellular smartphones. Shows comprising the content should be capable of being viewed with a media player in various environments, such as internet social networking sites and chat rooms via a web browser application, or applications integrated into the operating systems of the digital devices, and distributed via the internet, cellular wireless networks, and other suitable networks.

### SUMMARY

The present invention is directed to a system and method for creating, distributing, and viewing photo-realistic talking head based multimedia content over a network, comprising a server and a variety of communication devices, including cell phones and other portable wireless devices, and a software suite, that enables users to communicate with each other through creation, use, and sharing of multimedia content, including photo-realistic talking head animations combined with text, audio, photo, and video content. Content is uploaded to at least one remote server, and accessed via a broad range of devices, such as cell phones, desktop computers, laptop computers, personal digital assistants, and cellular smartphones. Shows comprising the content may be viewed with a media player in various environments, such as internet social networking sites and chat rooms via a web browser application, or applications integrated into the operating systems of the digital devices, and distributed via the internet, cellular wireless networks, and other suitable networks.

The system and method for creating, distributing, and viewing photo-realistic talking head based multimedia content over a network allows a user to generate photo realistic animated images of talking heads quickly, easily, and conveniently. The system and method for creating, distributing, and viewing photo-realistic talking head based multimedia content over a network yield images that have the photo realistic quality required to convey personal identity, emphasize points in a conversation, and add emotional content, show the animated photo realistic images clearly and distinctly, with high quality lip synchronization, and requires less bandwidth than is typically available on most present day networks and/or the internet.

The system and method for creating, distributing, and viewing photo-realistic talking head based multimedia content over a network may be used to create a photo realistic talking head library, using portable wireless devices, such as a cell phones, personal digital assistants, smartphones, handheld devices, and other wireless devices, and is capable of being used over a variety of networks, including wireless cellular networks, the internet, WiFi networks, WiMax networks, Voice Over IP (VOIP) networks, intranets, and other suitable networks.

The portable wireless devices include digital communications devices, portable digital assistants, cell phones, notebook computers, video phones, smartphones, digital communications devices having video cameras and video displays, and other suitable devices, and, in particular, portable wireless devices capable of wirelessly transmitting and receiving signals. Typical networks include cellular networks, wireless networks, wireless digital networks, distributed networks, such as the internet, global network, wide area networks, metropolitan area networks, local area networks, WiFi networks, WiMax networks, Voice Over IP (VOIP), and other suitable networks.

A human being or user is capable of developing his or her own photo-realistic talking head shows, including show content, having photo realistic quality required to convey personal identity, emphasize points in a conversation, and emotional content. The animated photo realistic images show the animated talking head clearly and distinctly, with high quality lip synchronization, and require less bandwidth than is typically available on most present day networks and/or the internet.

The library of photo realistic talking heads is capable of being constructed quickly, easily, and efficiently by an individual having ordinary computer skills, and minimizing production time, using markers and/or guides, which may be used as templates for mixing and alignment with images of an actual human being in different angular positions. The markers and/or guide images of the human subject are capable of being superimposed on the displays of the portable devices and/or portable wireless devices.

A library of different ones of marker libraries and/or guide libraries may be provided, each of the marker libraries and/or guide libraries having different ones of sets of markers and/or guides therein, each of the sets of markers and/or guides for a different angular position. Each of the marker libraries and/or guide libraries are associated with facial features for different angular positions of the user and are different one from the other, thus, allowing a user to select a particular marker library and/or guide library from the library of different ones of the marker libraries and/or guide libraries, having facial features and characteristics close to those of the user.

Each of the displays of the handheld devices and other suitable devices are capable of displaying a composite image of the collected image of the human subject and selected markers and/or a selected alignment template. The display and the video camera allows the video camera to collect the image of the human subject, the human subject to view the composite image, and align the his or her image with the markers and/or the alignment template. The markers and/or the guides may be retrieved from the remote server during the alignment process, but may alternatively be resident within the wireless handheld devices or other suitable devices.

The photo-realistic head shows and associated content may be created using the wireless handheld devices.

The talking heads are capable of being used in a newscaster format, associated with news coverage, the use of animated images of talking heads, having photo realistic quality and yielding personalized appearance, for use in a number and variety of applications.

A human subject or user is capable of capturing an image of himself or herself with a video camera of such a device and view live video of the captured image on a video display of the device. The human subject or user is capable of constructing photo-realistic talking head shows, including content associated with the photo-realistic talking head shows.

### DRAWINGS

These and other features, aspects, and advantages of the present invention will become better understood with regard to the following description, appended claims, and accompanying drawings where:

FIG. 1 is a schematic representation of steps of a method for creating, distributing, and viewing photo-realistic talking head based multimedia content over a network, in accordance with the present invention;

FIG. 2 is a diagrammatic representation of a photo realistic talking head library;

FIG. 3 is a view of a guide, which is used as an alignment template;

FIG. 4 is a view of a subject to be incorporated into the photo realistic talking head library of FIG. 2;

FIG. 5 is a composite view of the subject of FIG. 4 aligned with the guide of FIG. 3;

FIG. 6A is a composite view of the subject of FIG. 4 horizontally displaced from the guide of FIG. 3;

FIG. 6B is a composite view of the subject of FIG. 4 vertically displaced from the guide of FIG. 3;

FIG. 6C is a composite view of the subject of FIG. 4 and the guide of FIG. 3 in close proximity to being aligned;

FIG. 7 shows an enlarged one of a selected image of the photo realistic talking head library of FIG. 2 at a particular angular position, and ones of different eye characteristics, and ones of different mouth characteristics at the particular angular position of the selected image, each also of the photo realistic talking head library of FIG. 2;

FIG. 8 shows a typical one of the selected images of the photo realistic talking head library of FIG. 2 at the particular angular position of FIG. 7, and typical ones of the different eye characteristics obtained by the subject having eyes closed and eyes wide open at the particular angular position of FIG. 7, and typical ones of the different mouth characteristics at the particular angular position of FIG. 7, obtained by the subject mouthing selected sounds;

FIG. 9 shows typical eye region and typical mouth region of the subject for obtaining the ones of the different eye characteristics and the typical ones of the different mouth characteristics of FIG. 8;

FIG. 10 shows a coordinate system having tilt, swivel, and nod vectors;

FIG. 11 shows an optional naming convention, that may be used for optional labels;

FIG. 12 is a diagrammatic representation of a guide library;

FIG. 13A is a view of a wire mesh model of the guide;

FIG. 13B is a view of the wire mesh model of the guide of FIG. 13A having phong shading;

FIG. 13C is a view of the guide of FIG. 13B having phong shading, photo mapped with a picture of a desired talking head or preferred newscaster;

FIG. 14A is a view of another guide showing typical facial features;

FIG. 14B is a view of another guide showing other typical facial features;

FIG. 14C is a view of another guide showing other typical facial features;

FIG. 14D is a view of another guide showing other typical facial features;

FIG. 14E is another view of the guide of FIG. 3 showing other typical facial features;

FIG. 14F is a view of another guide showing other typical facial features;

FIG. 15 is diagrammatic representation of a library of guide libraries associated therewith the guides of FIGS. 14A-F;

FIG. 16 is a schematic representation of a method of constructing a photo realistic talking head of the present invention;

FIG. 17 is a schematic representation of additional optional steps of the method of constructing the photo realistic talking head of FIG. 14;

FIG. 18A is a view of another subject showing markers that may be used for alignment alternatively to the guide or alignment template of FIG. 3, showing the subject aligned;

FIG. 18B is a view of the subject of FIG. 18A off alignment, showing appearance of the markers when the subject is not fully aligned;

FIG. 18C is a view of the subject of FIG. 18A with the subject angularly displaced from the angles of FIG. 18A, showing the subject aligned;

FIG. 19 is a schematic representation of a do-it-yourself photo realistic talking head creation system, constructed in accordance with the present invention;

FIG. 20 is a partial block diagram and diagrammatic representation of an alternate embodiment of a do-it-yourself photo realistic talking head creation system;

FIG. 21 is a schematic representation of the do-it-yourself photo realistic talking head creation system of FIG. 19 communicating wirelessly with the server of the do-it-yourself photo realistic talking head creation system of FIG. 19;

FIG. 22 is a schematic representation of the do-it-yourself photo realistic talking head creation system of FIG. 20 communicating wirelessly with the server of the do-it-yourself photo realistic talking head creation system of FIG. 20;

FIG. 23 is a schematic representation of a do-it-yourself photo realistic talking head creation system having a plurality of the cell phones communicating wirelessly with the server of the do-it-yourself photo realistic talking head creation system of FIG. 21;

FIG. 24 is a schematic representation of a do-it-yourself photo realistic talking head creation system having a plurality of the cell phones communicating wirelessly with the server of the do-it-yourself photo realistic talking head creation system of FIG. 22;

FIG. 25 is a schematic representation of a do-it-yourself photo realistic talking head creation system having a plurality of personal digital assistants communicating wirelessly with the server of the do-it-yourself photo realistic talking head creation system of FIG. 21;

FIG. 26 is a schematic representation of a do-it-yourself photo realistic talking head creation system having a plurality of the cell phones communicating with the server via the internet;

FIG. 27 is a schematic representation of a do-it-yourself photo realistic talking head creation system having a plurality of the cell phones communicating wirelessly with the server of the do-it-yourself photo realistic talking head creation system of FIG. 21 via the internet through a wireless cellular network;

FIG. 28 is a schematic representation of a do-it-yourself photo realistic talking head creation system having a plurality of the cell phones communicating wirelessly with the server of the do-it-yourself photo realistic talking head creation system of FIG. 22 via the internet through a wireless cellular network;

FIG. 29 is a schematic representation of a do-it-yourself photo realistic talking head creation system having a plurality of the cell phones and other devices communicating wirelessly with the server of the do-it-yourself photo realistic talking head creation system via a cellular network connected to the internet and/or a plain old telephone system;

FIG. 30 is a schematic representation of a do-it-yourself photo realistic talking head creation system connected wirelessly to the internet and to the wireless cellular network, which are each connected to the server;

FIG. 31 is a schematic representation of an alternate method of constructing a photo realistic talking head of the present invention, using;

FIG. 32 is a schematic representation of additional optional steps of the method of constructing the photo realistic talking head of FIG. 31;

FIG. 33 is a schematic representation of additional optional steps of the method of constructing the photo realistic talking head of FIG. 31;

FIG. 34 is a block diagram of a video capture device;

FIG. 35 is a block diagram of an alternate embodiment of a do-it-yourself photo realistic talking head creation system, constructed in accordance with the present invention;

FIG. 36 is a block diagram of an alternate embodiment of a do-it-yourself photo realistic talking head creation system, constructed in accordance with the present invention;

FIG. 37 is a schematic representation of a show content creation and uploading method;

FIG. 38 is a schematic representation of selected device platforms that may be used with photo-realistic talking head applications;

FIG. 39 is a schematic representation of a process for caller personalized brand placement;

FIG. 40 is a schematic representation of show content creation methods;

FIG. 41 is a schematic representation of a process for creating photo-realistic talking head content for chat, blog or multi-media applications;

FIG. 42 is a schematic representation of a process for creating photo-realistic talking head content for phone, or voicemail applications;

FIG. 43 is a schematic representation of a photo-realistic talking head phone application;

FIG. 44 is a schematic representation of a photo-realistic talking head voice mail application;

FIG. 45 is a schematic representation of a process for embedding lip synchronization data;

FIG. 46 is a schematic representation of a process for inserting branding by matching words associated with a user's parameters and preferences and a recipient's parameters and preferences;

FIG. 47 is a schematic representation of a distributed web application network;

FIG. 48 is a schematic representation of another distributed web application network;

FIG. 49 is a schematic representation of an embedded lip synchronization system and method;

FIG. 50 is a schematic representation of a photo realistic talking head phone;

FIG. 51 is a schematic representation of an embedded lip synchronization system and method on a mobile information device;

FIG. 52 is a schematic representation of a speech-driven personalized brand placement system;

FIG. 53 is a schematic representation of a photo realistic talking head voicemail;

FIG. 54 is a device platform and remote server system, alternatively referred to as a photo realistic talking head web application;

FIG. 55 is a schematic representation of a show segment editor application;

FIG. 56 is a schematic representation of a show compilation editor application;

FIG. 57 is a schematic representation of a directory structure of a local asset library;

FIG. 58 is a schematic representation of a directory structure of an encrypted asset library;

FIG. 59 is a schematic representation of a directory structure of a graphics assets portion of the local asset library;

FIG. 60 is a schematic representation of a directory structure of a sound library portion of the local asset library;

FIG. 61 is a schematic representation of a vocal analysis and lip synchronization application;

FIG. 62 is a schematic representation of a local computer (Full Version) system, alternatively referred to as a photo realistic talking head content production system;

FIG. 63 is a schematic representation of a vocal analysis and lip synchronization application's graphical user interface;

FIG. 64 is a schematic representation of a production segment editor application's graphical user interface;

FIG. 65 is a schematic representation of a show compilation editor application's graphical user interface;

FIG. 66 is a schematic representation of a graphical user interface of a chat application;

FIG. 67 is a schematic representation of a graphical user interface of a blog application;

FIG. 68 is a schematic representation of a graphical user interface of a voice mail application;

FIG. 69 is a schematic representation of a graphical user interface of another voice mail application;

FIG. 70 is a schematic representation of a graphical user interface of a multimedia and/or television/broadcast application;

FIG. 71 is a schematic representation of a graphical user interface of a multimedia help application for a user's device;

FIG. 72 is a schematic representation of a graphical user interface of a multimedia personal finance center for personal banking;

FIG. 73 is a schematic representation of a graphical user interface of a multimedia sub category of a personal finance center, having a virtual ATM within a personal finance center;

FIG. 74 is a schematic representation of a graphical user interface of a multimedia message center;

FIG. 75 is a schematic representation of a graphical user interface of a multimedia game start menu;

FIG. 76 is a schematic representation of a graphical user interface of a multimedia game in play mode;

FIG. 77 is a schematic representation of a graphical user interface of a multimedia trivia game;

FIG. 78 is a schematic representation of a graphical user interface of a multimedia critic's reviews;

FIG. 79 is a schematic representation of a graphical user interface of a multimedia personal navigator;

FIG. 80 is a schematic representation of a graphical user interface of a multimedia gas station location sub category of a personal navigator;

FIG. 81 is a schematic representation of a graphical user interface of another multimedia critic's reviews; and

FIG. 82 is a schematic representation of a graphical user interface of a multimedia movie review sub category of a critic's reviews.

### DESCRIPTION

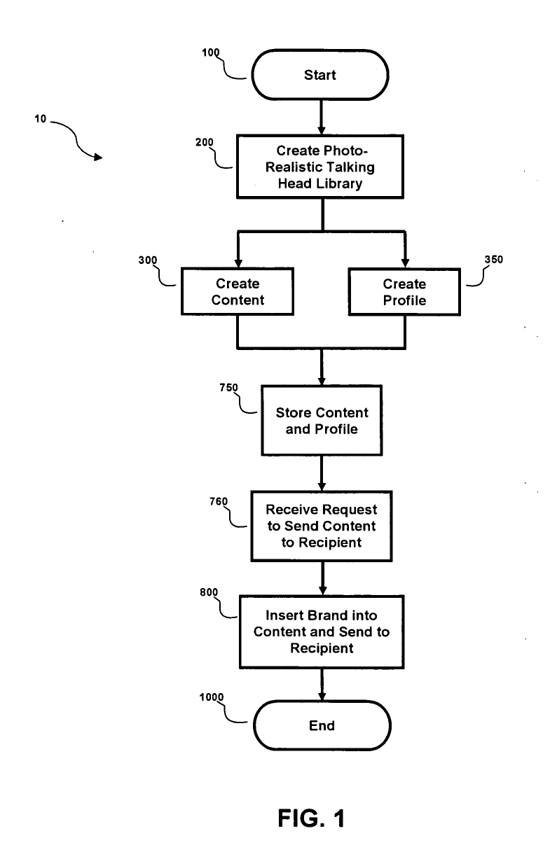

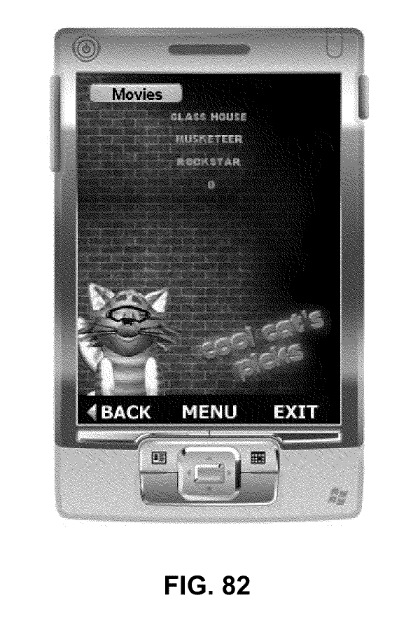

The preferred embodiments of the present invention will be described with reference to FIGS. 1-82 of the drawings. Identical elements in the various figures are identified with the same reference numbers.

### I. Overview

FIG. 1 is a schematic representation of steps of a method for creating, distributing, and viewing photo-realistic talking head based multimedia content over a network 10, in accordance with the present invention.

The method for creating, distributing, and viewing photo-realistic talking head based multimedia content over a network 10 comprises: starting the method for creating, distributing, and viewing photo-realistic talking head based multimedia content over a network 10 at step 100; creating a photo-realistic talking head library and storing the photo-realistic talking head library on a photo realistic talking head system of the present invention at step 200; creating content and uploading the content to the photo realistic talking head system at step 300; creating a profile for branding at step 350; storing the content and the profile on the photo realistic talking head system at step 750; receiving a request requesting the photo realistic talking head system to send the content to a recipient at step 760; inserting branding by the photo realistic talking head system and sending the content to the recipient at step 800; and ending the method for creating, distributing, and viewing photo-realistic talking head based multimedia content over a network 10 at step 1000.

### II. Creating a Photo-Realistic Talking Head Library

A photo-realistic talking head library 12 is created at step 200 of the method for creating, distributing, and viewing photo-realistic talking heads 10.

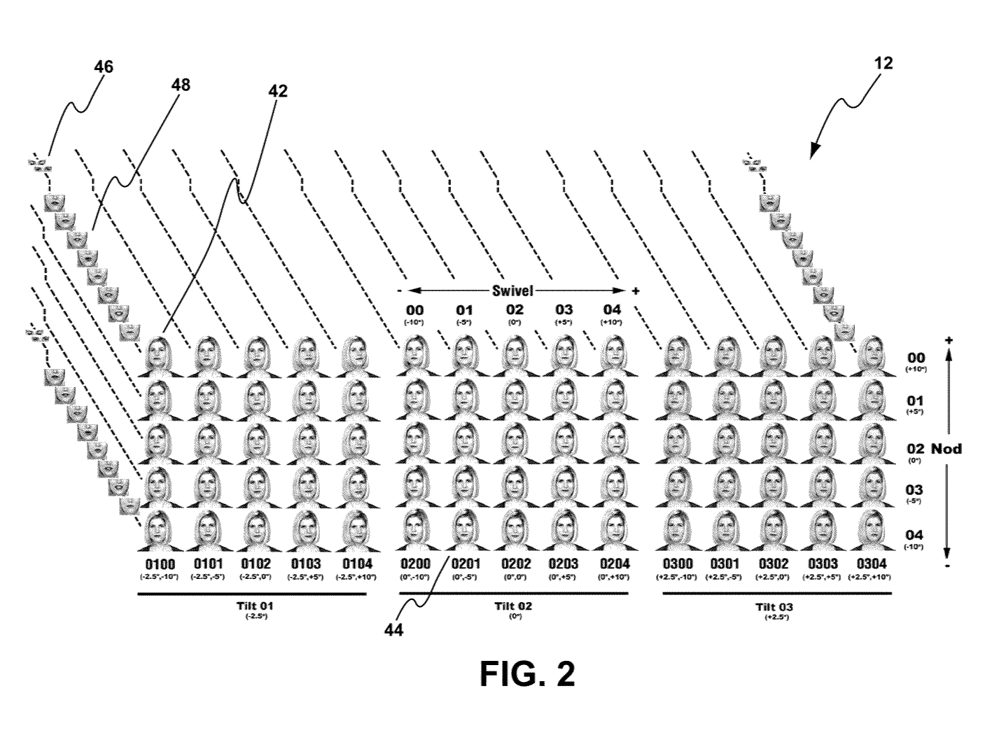

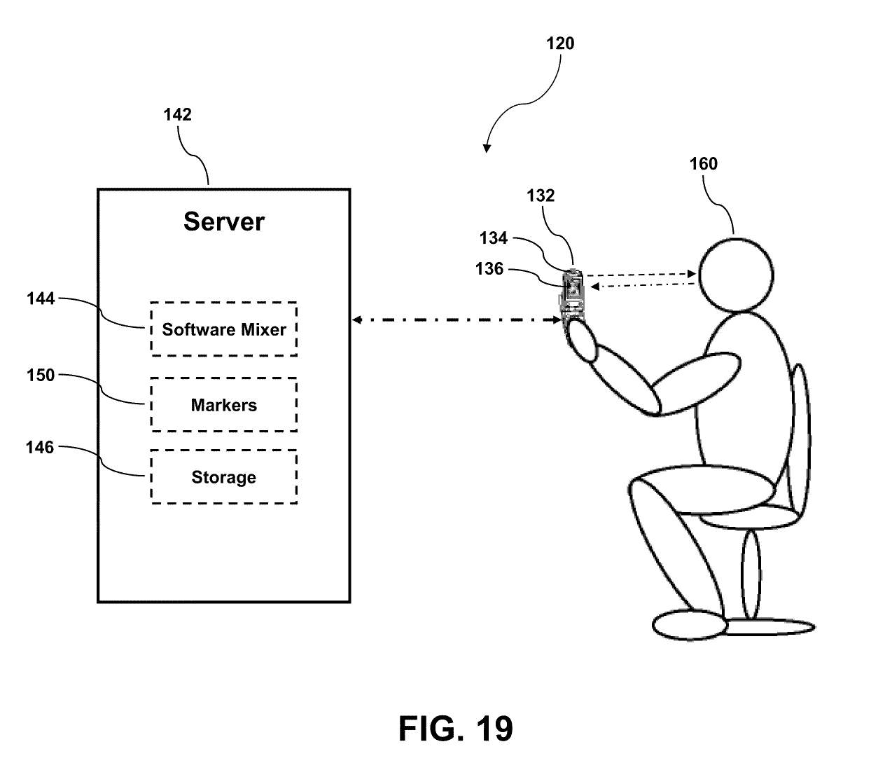

The photo-realistic talking head library 12 and methods for creating the photo-realistic talking head library 12 are shown in FIGS. 2-36. FIGS. 19-36 show alternate embodiments for creating photo-realistic talking head creation talking heads.

Photo-realistic talking heads may be used in a variety of portable wireless devices, such as cell phones, handheld devices, and the like, having video cameras and displays that may be used by a subject to align himself or herself with markers and/or guides during the creation of the photo-realistic talking head library 12, and to display the photo-realistic talking heads.

FIG. 2 shows the photo realistic talking head library 12 constructed of ones of selected images 42 of subject 26 at different angular positions 44 and different eye characteristics 46 and different mouth characteristics 48 at each of the angular positions 44.

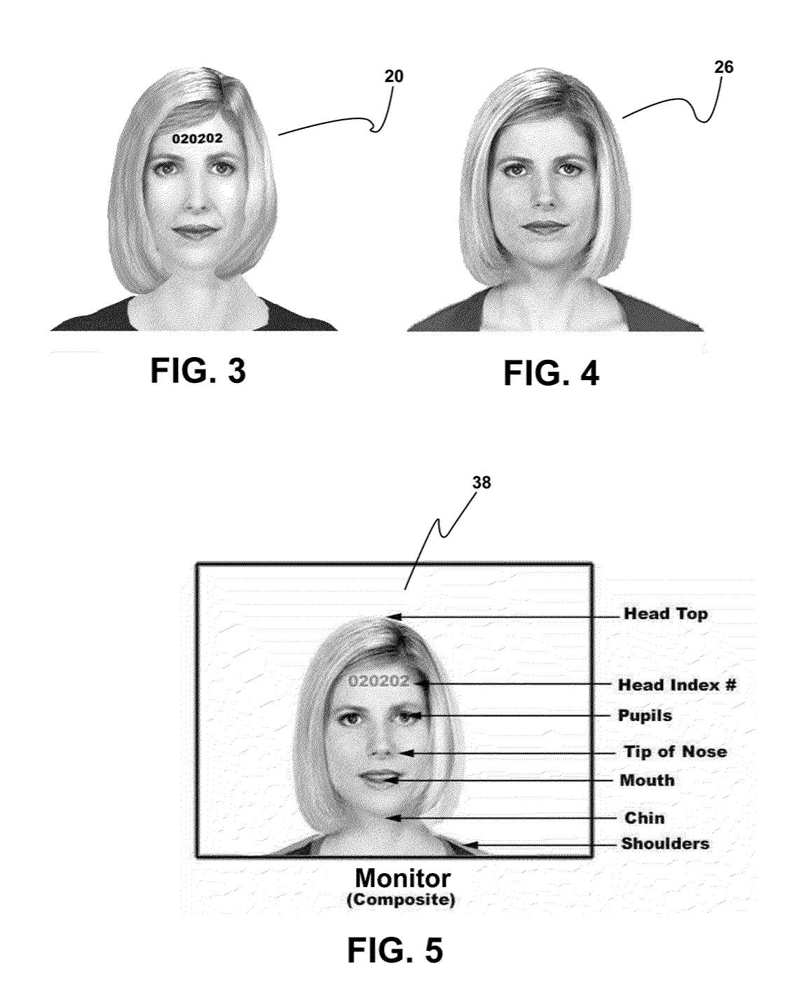

FIG. 3 shows a guide 20, which is used as an alignment template, for aligning the subject 26, shown in FIG. 4, with composite output image 38, shown in FIG. 5.

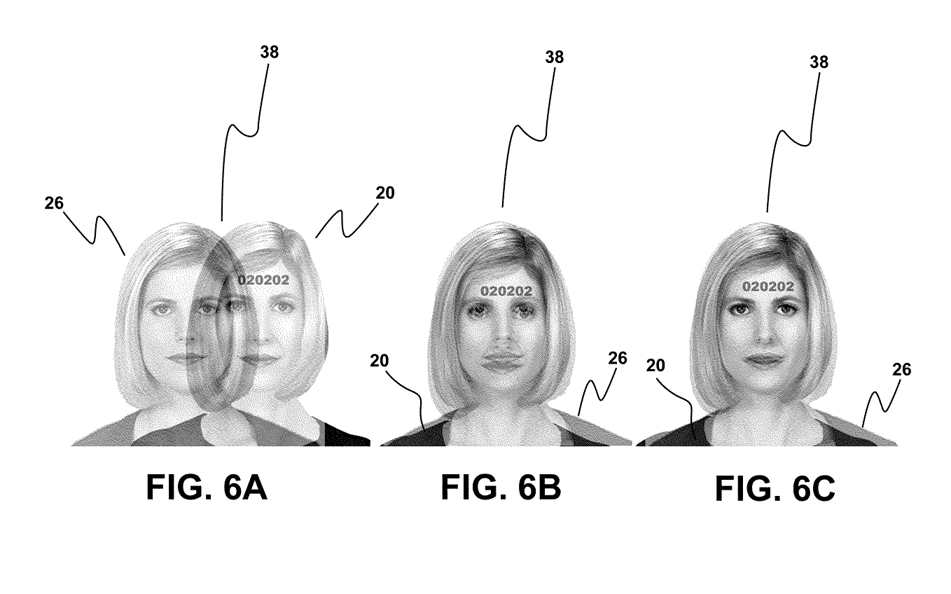

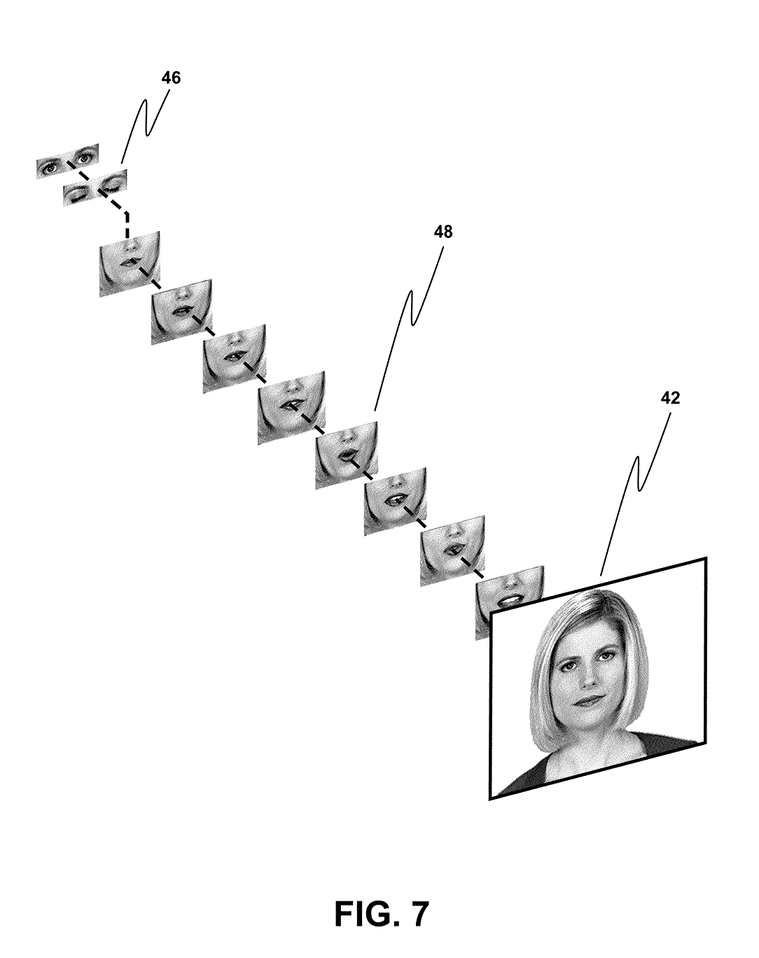

FIGS. 6A-6C show the composite output image 38 at different stages of alignment of the subject 26 with the guide 20. FIG. 6A shows the subject 26 horizontally displaced from the guide 20; FIG. 6B shows the subject 26 vertically displaced from the guide 20; and FIG. 6C shows the subject 26 and the guide 20 in closer alignment. FIG. 5 shows the subject 26 aligned with the guide 20.

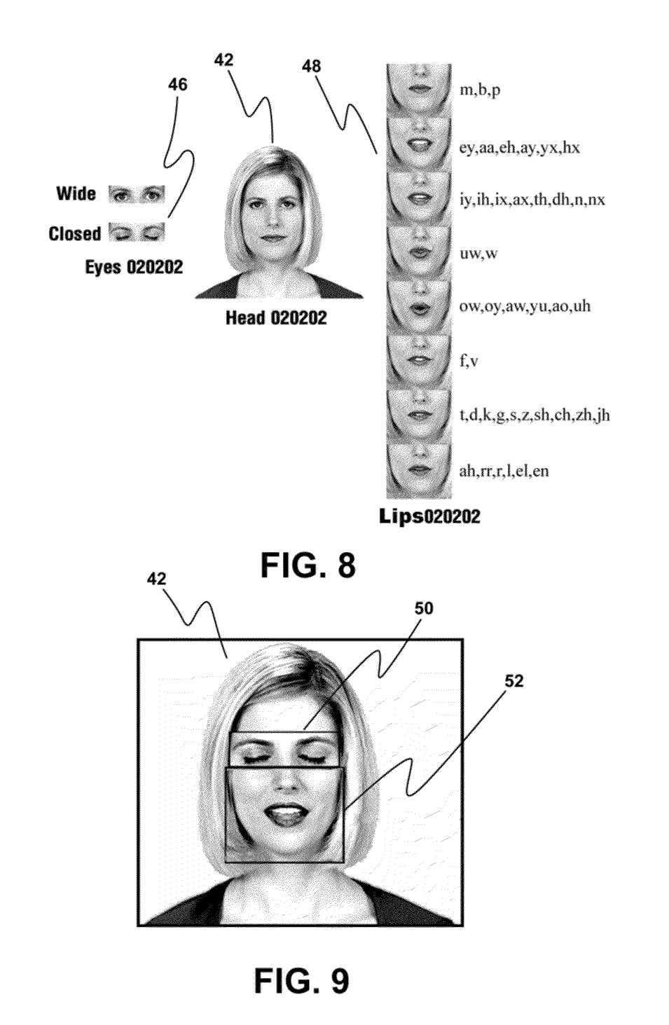

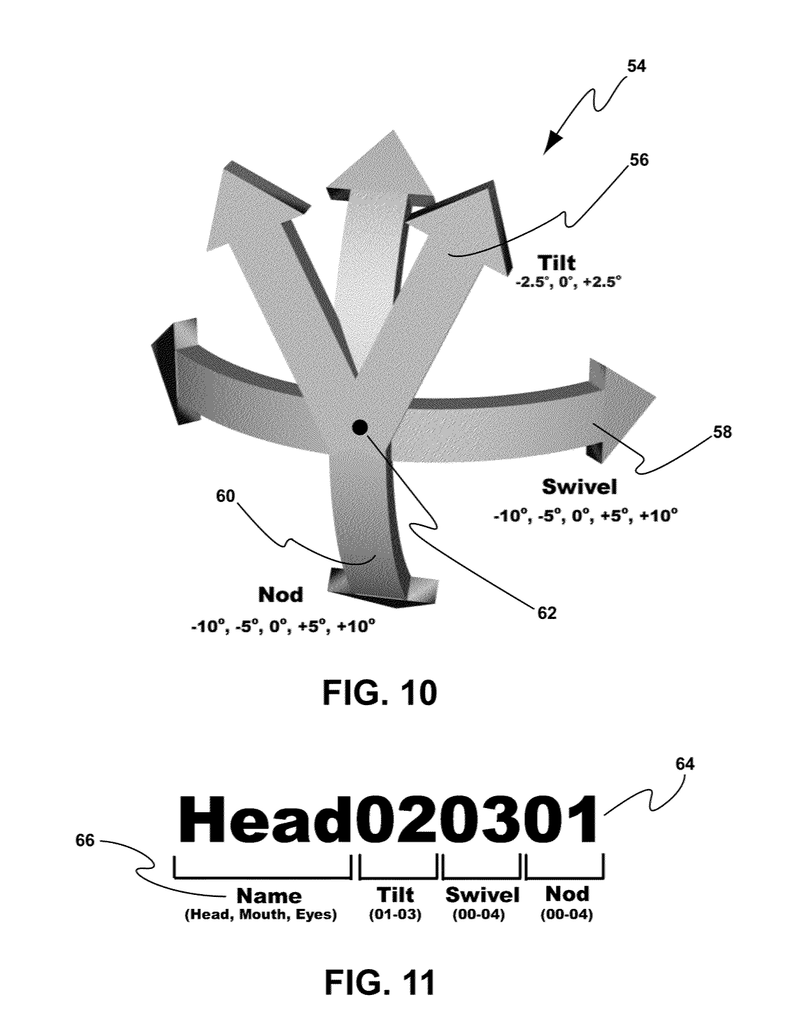

The photo realistic talking head library 12 is constructed of ones of the selected images 42 at different angular positions 44 and different eye characteristics 46 and different mouth characteristics 48 at each of the angular positions 44, shown in FIG. 2, in accordance with coordinate system and optional naming convention of FIGS. 10 and 11, respectively. FIG. 7 shows an enlarged one of the selected images 42 at a particular angular position of FIG. 2, and ones of the different eye characteristics 46 and ones of the different mouth characteristics 48 at the particular angular position of the selected image 42. FIG. 8 shows a typical one of the selected images 42 at the particular angular position of FIG. 7, and typical ones of the different eye characteristics 46 obtained by the subject 26 having eyes closed and eyes wide open at the particular angular position of FIG. 7, and typical ones of the different mouth characteristics 48 at the particular angular position of FIG. 7, obtained by the subject 26 mouthing selected sounds. Once the subject 26 aligns his or herself with the guide 20 at the particular angular positions, the subject 26 performs closes and opens the eyes, and speaks a set of prose, which includes selected phonemes. The subject 26 may also, optionally, perform additional facial gestures such as smiling and/or frowning. FIG. 9 shows typical eye region 50 and typical mouth region 52 of the subject 26 for obtaining the ones of the different eye characteristics 46 obtained by the subject 26 having eyes closed and eyes wide open at the particular angular position of FIG. 7, and typical ones of the different mouth characteristics 48 at the particular angular position of FIG. 7, respectively.

FIG. 10 shows coordinate system 54 having tilt 56, swivel 58, and nod 60 vectors for the different angular positions 44 of the subject 26, the guide 20, the selected images 42, and the different eye characteristics 46 and the different mouth characteristics 48 associated therewith the selected images 42 of the photo realistic talking head library 12. The tilt 56, the swivel 58, and the nod 60 vectors, each designate direction and angular position therefrom neutral 62, typical angles and directions of which are shown in FIG. 10, although other suitable angles and directions may be used. The swivel 58 vector uses azimuthal angular position (side to side) as the angular component thereof, and the nod 60 vector uses elevational angular position (up or down) as the angular component thereof. The tilt 56 vector is upwardly left or right directed angularly either side of the nod 60 vector.

FIG. 11 shows optional naming convention 64 associated therewith the tilt 56, the swivel 58, and the nod 60 vectors for the subject 26, the guide 20, the selected images 42, and the different eye characteristics 46 and the different mouth characteristics 48 associated therewith the selected images 42 of the photo realistic talking head library 12. Other suitable optional naming conventions may be used or actual vector directions and angles. The optional naming convention 64 uses a consecutive numbering scheme having the tilt 56 vectors monotonically increasing upward from 01 for each of the designated directions and angles from a minus direction to a plus direction; thus, for the typical angles of −2.5°, 0°, and +2.5° for the tilt 56, the optional naming convention 64 uses 01, 02, and 03 to designate the typical angles of −2.5°, 0°, and +2.5°, respectively. The optional naming convention 64 uses a consecutive numbering scheme having the swivel 58 and the nod 60 vectors monotonically increasing upward from 00 for each of the designated directions and angles from a minus direction to a plus direction; thus, for the typical angles of −10°, −5°, 0°, +5°, and +10° for the swivel 58 and the nod 60, the optional naming convention 64 uses 00, 01, 02, and 03 to designate the typical angles of −10°, −5°, 0°, +5°, and +10°, respectively. Suitable angles other than the typical angles of −2.5°, 0°, and +2.5° for the tilt 56, and/or suitable angles other than the typical angles of −10°, −5°, 0°, +5°, and +10° for the swivel 58 and the nod 60 may be used; however, the monotonically increasing consecutive numbering scheme may still be used, starting at 01 for the tilt 56, and 00 for the swivel 58 and the nod 60 for other directions and angles from negative through zero degrees to positive angles. Name 66 uses head, mouth, and eyes as optional labels or designators, head for the selected image 42, the subject 26, or the guide 20, eye for the eye characteristic 46, and mouth for the mouth characteristic 48. Head020301, thus, represents, for example, the selected image 42 having the tilt 56, the swivel 58, and the nod 60 as 0°, +5°, −5°, respectively, for the typical angles shown in FIG. 10.

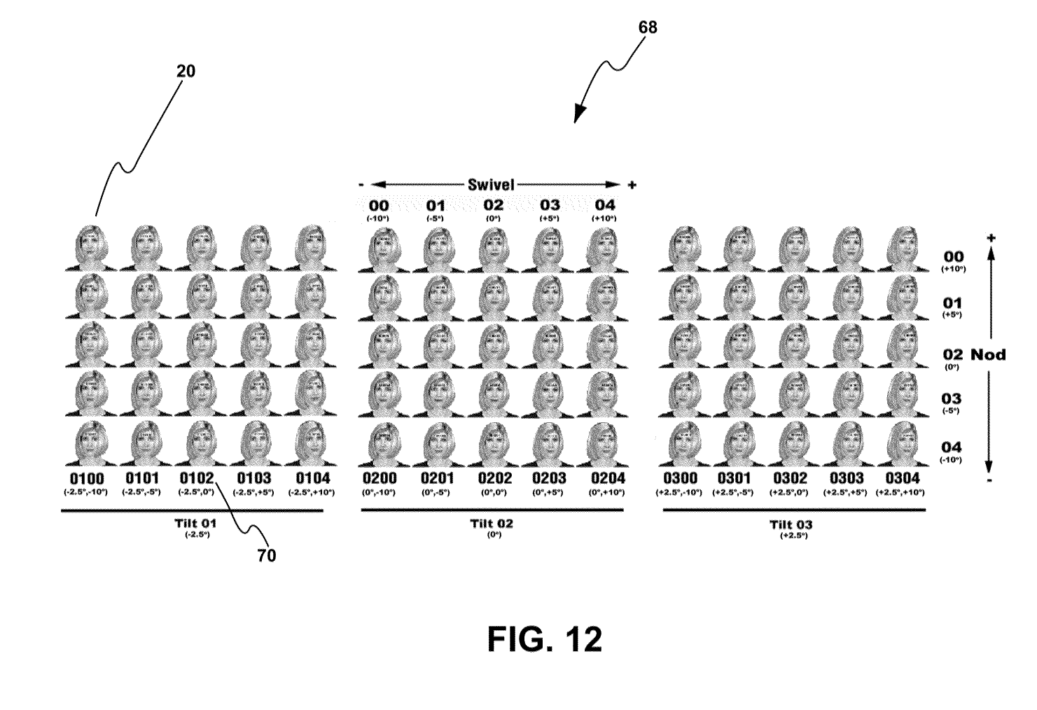

FIG. 12 shows a guide library 68 having ones of the guides 20 at different angular positions 70, shown in accordance with the coordinate system 54 of FIG. 10 and the optional naming convention 64 of FIG. 11. Each of the guides 20 of FIG. 11 is used to construct corresponding ones of the selected images 42 at corresponding ones of the angular positions 44 and the different eye characteristics 46 and the different mouth characteristics 48 at the corresponding ones of the angular positions 44 corresponding to the angular positions 70 of each of the guides 20 thereof the guide library 68. The subject 26, thus, aligns himself or herself with the guide 20 in the composite output image 38 each at a different one of the angular positions 70 to construct each of the selected images 42, opens and closes his or her eyes to construct each of the ones of the different eye characteristics 46 at the particular angular position of each of the aligned selected images 42, and repetitively mouths each of the ones of the different mouth characteristics 48 at the particular angular position of each of the aligned selected images 42 corresponding to each of the angular positions 70, and, thus, constructs the photo realistic talking head library 12 of FIG. 2.

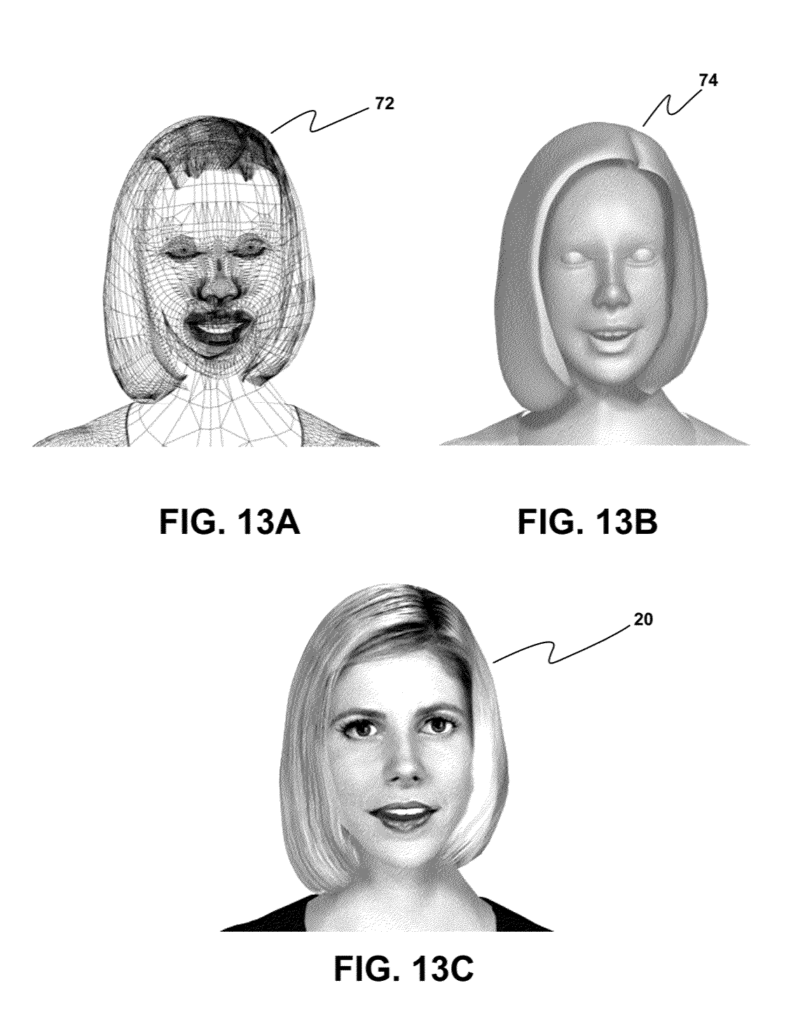

FIGS. 13A-C show a diagrammatic representation of typical stages in the development one of the guides 20. It should be noted, however, that other suitable techniques may be used to develop ones of the guides 20. Each of the guides 20 is typically a medium resolution modeled head, that resembles a desired talking head, a preferred newscaster, or a generic talking head or newscaster in a different angular position, a typical one of the guides 20 being shown in FIG. 13C, each of the guides 20 being used as a template for aligning the subject 26 thereto at a selected one of the different angular positions. Each of the guides 20 may be constructed, using a suitable technique, such as laser scanning, artistic modeling, or other suitable technique, which typically results in the guides 20 each being a 3D modeled head having approximately 5000 polygons. Modeling software, such as 3D modeling software or other suitable software, may be used to create the guides 20. Typical commercial 3D modeling software packages that are available to create the guides 20 are: 3D Studio Max, Lightwave, Maya, and SoftImage, although other suitable modeling software may be used. First, an underlying wire mesh model 72 is created, as shown in FIG. 13A. Phong shading is typically added to the wire mesh model 72 to create a shaded model 74, as shown in FIG. 13B, which has a solid appearance. The shaded model 74 having the solid appearance is then typically photo mapped with a picture of the desired talking head, the preferred newscaster, or the generic talking head or newscaster to create the guide 20 of FIG. 13C, which resembles the desired talking head, preferred newscaster, or the generic talking head or newscaster. The guide 20 is rendered in specific head poses, with an array of right and left, up and down, and side-to-side rotations that correspond to desired talking head library poses of the selected images 42 of the photo realistic talking head library 12, which results in the guide library 68 having ones of the guides 20 at different angular positions, each of which is used as an alignment template at each of the different angular positions. Each of the guides 20 are typically stored as bitmapped images, typically having 512×384 pixels or less, typically having a transparent background color, and typically indexed with visible indicia typically in accordance with the coordinate system 54 of FIG. 10 and the optional naming convention 64 of FIG. 11, although other suitable indicia and storage may be used.

The subject 26 sees a superposition of his or her image and the image of the guide 20 in the monitor 39, and aligns his or her image with the image of the guide 20, as shown at different stages of alignment in FIGS. 5, 6A, 6B, and 6C.

Now again, the guide 20 is rendered in specific head poses, with an array of right and left, up and down, and side-to-side rotations that correspond to desired talking head library poses of the selected images 42 of the photo realistic talking head library 12, which results in the guide library 68 having ones of the guides 20 at different angular positions, each of which is used as an alignment template at each of the different angular positions.

The photo realistic talking head library 12 is capable of being constructed quickly, easily, and efficiently by an individual having ordinary computer skills, and minimizing production time, using the guides 20, which may be used as the templates for mixing and alignment with images of an actual human being in different angular positions.

A library 75 of different ones of the guide libraries 68 are provided, each of the guide libraries 68 having different ones of the guides 20 therein, and each of the guides 20 for a different angular position. Each of the guide libraries 68 has facial features different one from the other, thus, allowing a user to select the guide library 68 therefrom the library 75 having facial features and characteristics close to those of the user.

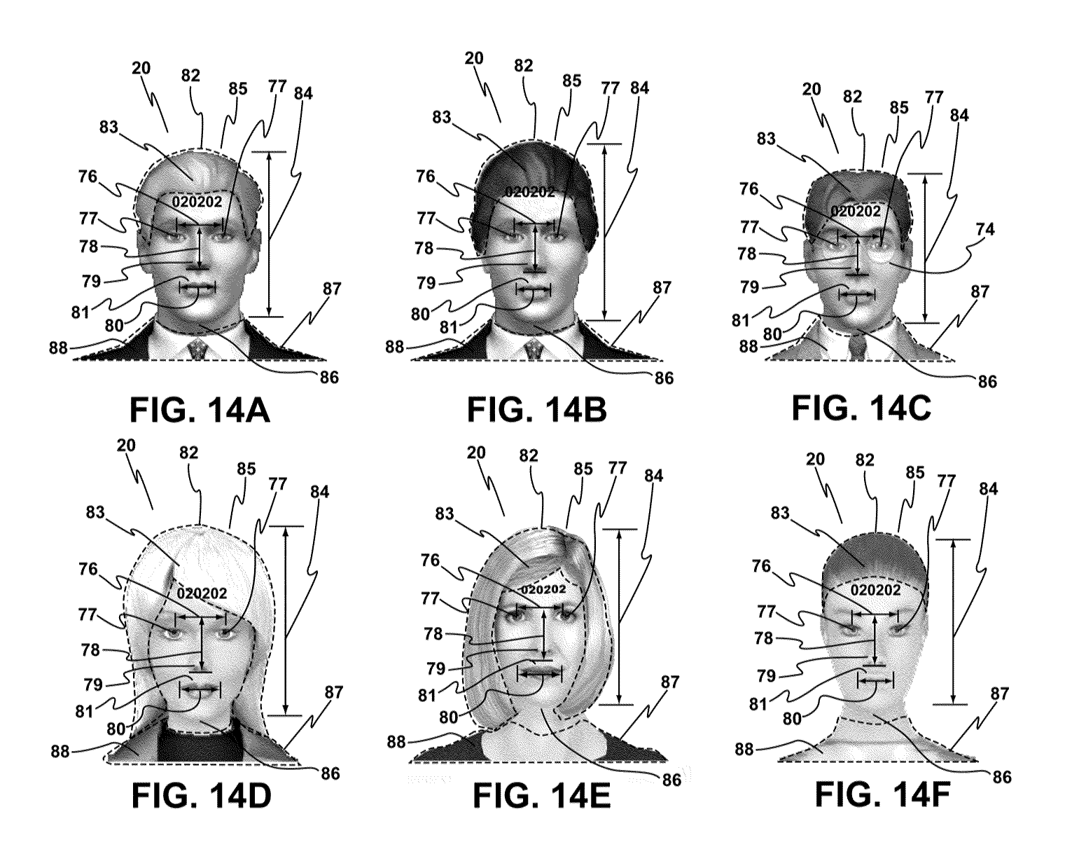

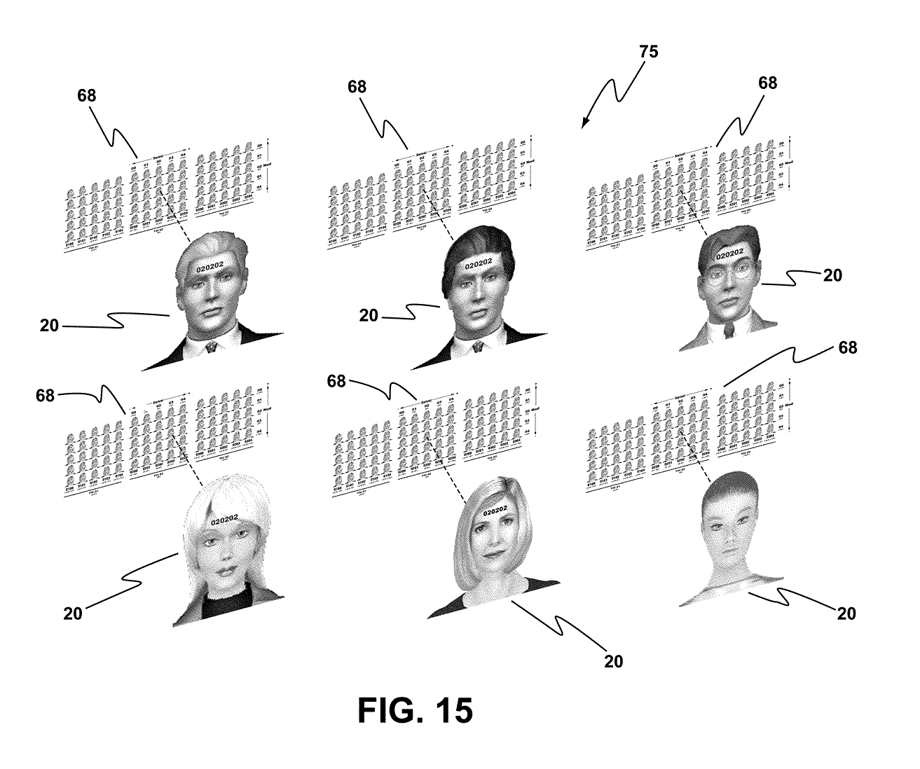

FIGS. 14A-F show typical ones of the guides 20 having different facial features. Proper alignment of the subject 26 with the guide 20 is achieved when various key facial features and shoulder features are used to facilitate alignment. The subject 26 may choose from the library 75 of different ones of the guide libraries 68, shown in FIG. 15, and select the best match with respect to his or her facial features. Distance 76 between pupils 77, length 78 of nose 79, width 80 of mouth 81, style 82 of hair 83, distance 84 between top of head 85 and chin 86, shape 87 of shoulders 88, and optional eyewear 89, are typical alignment features that provide targets for the subject 26 to aid in aligning himself or herself with the guide 20. The closer the guide 20 is in size, appearance, proportion, facial features, and shoulder features to the subject 26, the better the alignment will be, and, thus, the resulting photo realistic talking head library 12.

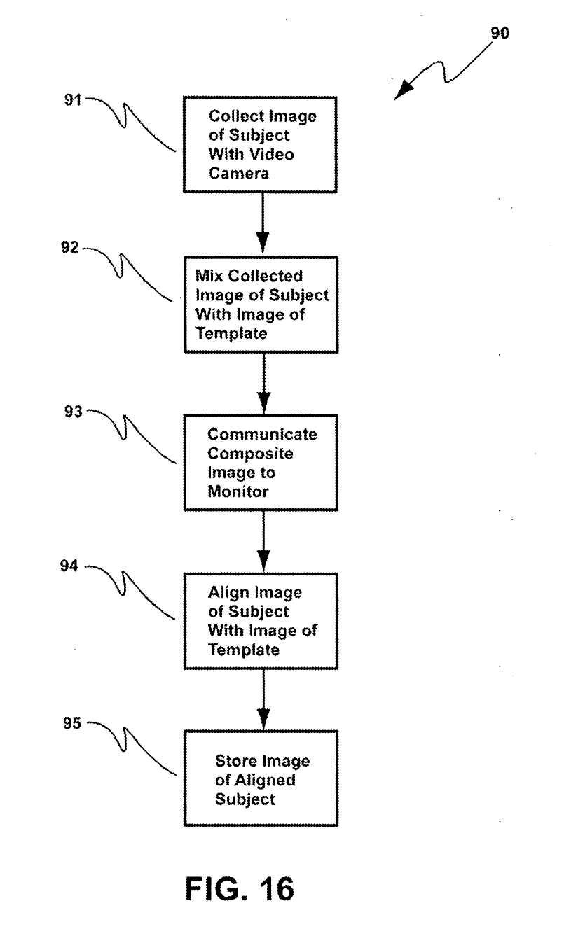

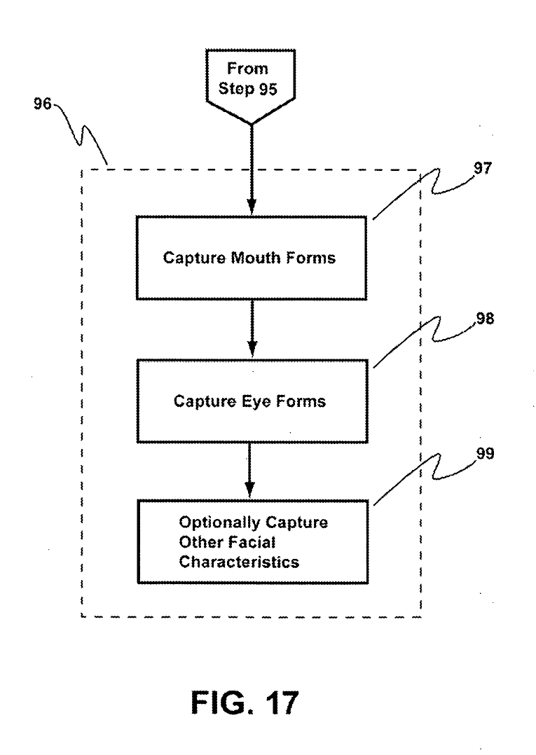

FIG. 16 shows steps of a method of constructing a photo realistic talking head 90, which comprises at least the following steps: collecting the image of a subject with a video camera or other device 91; mixing the collected image of the subject with the image of a guide or template, thus, creating a composite image thereof the subject and the guide or template 92; and communicating the composite image thereto a monitor or television for display to the subject 93, the monitor or television adapted to facilitate the subject aligning the image of the subject with the image of the guide or template; aligning the image of the subject with the image of the guide or template 94; storing the image of the aligned subject 95. The step of mixing the collected image of the subject with the image of the guide or template, thus, creating the composite image thereof the subject and the guide or template 92 is preferably performed therein a computer having a mixer program, the mixer program adapted to create the composite image therefrom the collected image and the image of the template, although other suitable techniques may be used. The method of constructing a photo realistic talking head 90 may have additional optional steps, as shown in FIG. 17, comprising: capturing facial characteristics 96; including capturing mouth forms 97; capturing eye forms 98; optionally capturing other facial characteristics 99.

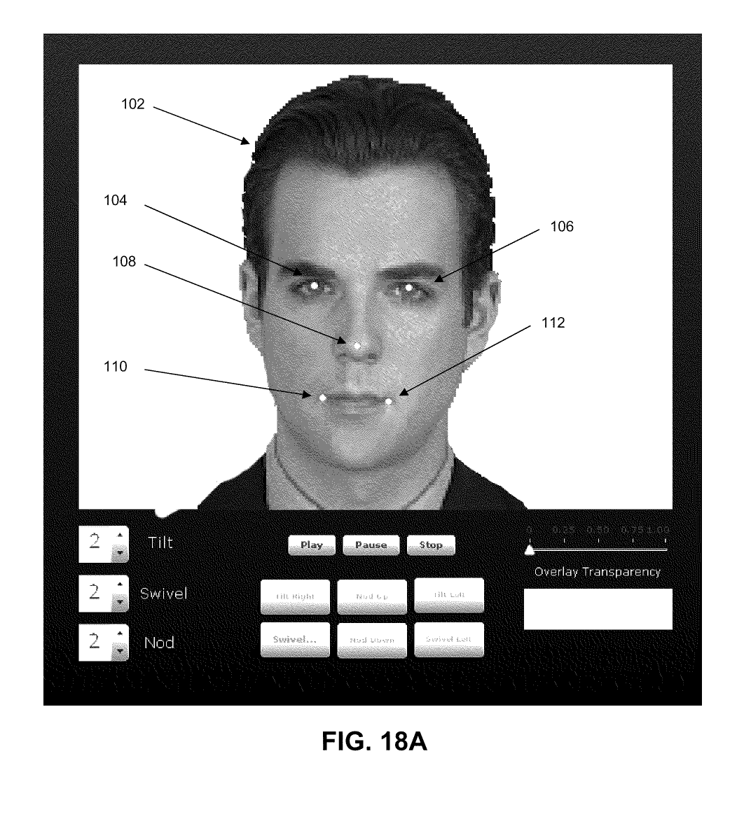

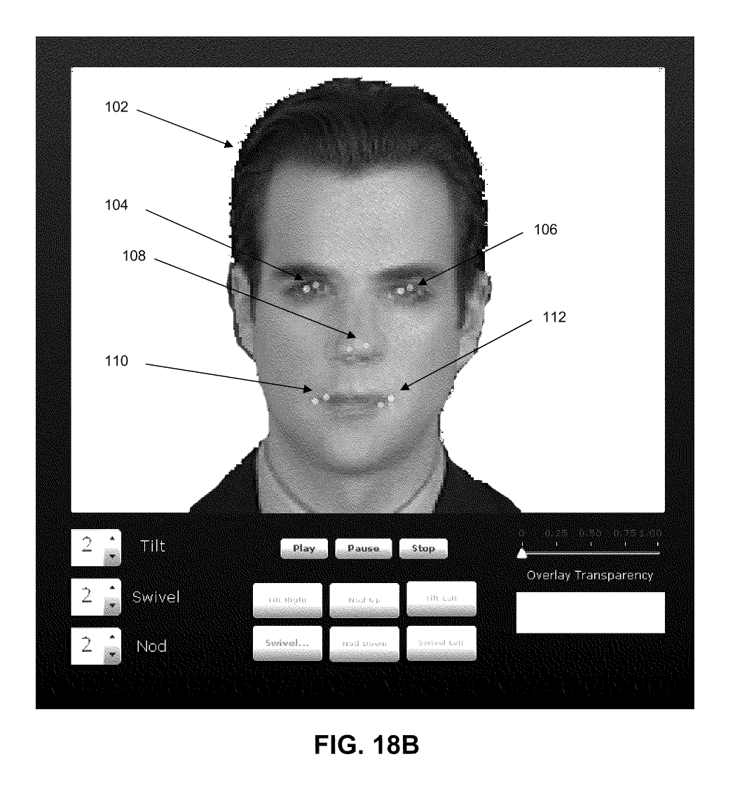

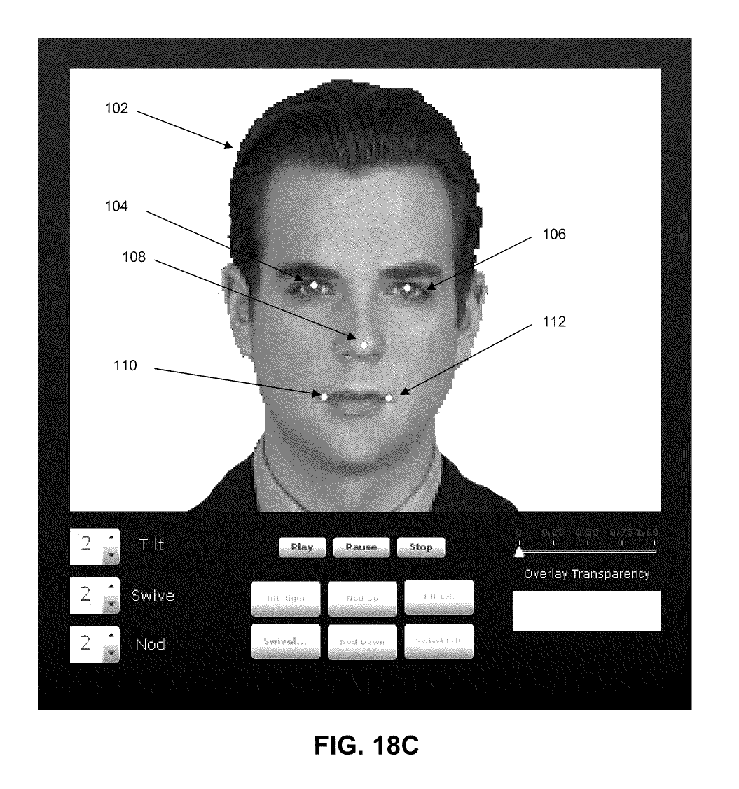

FIGS. 18A, 18B, and 18C show an alternative method of aligning a subject 102, using markers 104, 106, 108, 110, and 112 for alignment alternatively to using the guide or alignment template of FIG. 3.

The markers 104, 106, 108, 110, and 112 are used to align key facial features, such as eyes, tip of the nose, and corners of the mouth, although other suitable facial features may be used. The markers 104, 106, 108, 110, and 112 are typically used as an alternative to the guide 20 of FIG. 3, but may optionally be used in combination with the guide 20.

FIG. 18A shows the subject 102 aligned with the markers 104, 106, 108, 110, and 112 for tilt, swivel, and nod angles of 2°, 2°, and 2°, respectively.

FIG. 18B shows the subject 102 not aligned with the markers 104, 106, 108, 110, and 112 for the tilt, swivel, and nod angles of 2°, 2°, and 2°, respectively.

FIG. 18C is a view of the subject of FIG. 18A with the subject angularly displaced from the tilt, swivel, and nod angles of 2°, 2°, and 2°, respectively, of FIG. 18A, showing the subject aligned.

FIGS. 19-30 show alternate embodiments of do-it-yourself photo realistic talking head creation systems that use portable devices and portable wireless devices. These portable devices and portable wireless devices include digital communications devices, portable digital assistants, cell phones, notebook computers, video phones, handheld devices and other suitable devices. The portable devices and portable wireless devices include digital communications devices that have video cameras and video displays, and in particular built-in video cameras and video displays.

A human subject may, for example, capture an image of himself or herself with a video camera of such a device and view live video of the captured image on a video display of the device.

Markers and/or guide images of the human subject are superimposed on the displays of the portable devices and/or portable wireless devices of do-it-yourself photo realistic talking head creation systems of FIGS. 19-36.

Each of the displays of such devices displays a composite image of the collected image of the human subject and a selected alignment template comprising markers and/or guides, as aforedescribed, the display and the video camera adapted to allow the video camera to collect the image of the human subject and the human subject to view the composite image and the human subject to align the image of the head of the human subject with the alignment template head at substantially the same angular position as the specified alignment template head angular position.

Such portable devices and/or portable wireless devices may, for example, communicate with a server via a wired or wireless connection, and/or to a remote server via a network of sufficient bandwidth to support real-time video streaming and/or transmission of suitable signals. Typical networks include cellular networks, distributed networks, such as the internet, global network, wide area network, metropolitan area network, or local area network, WiFi, WiMax, Voice Over IP (VOIP), and other suitable networks.

More than one user may be connected to a remote server at any particular time. Captured video streams and/or still images may be communicated to the server for processing into a photo realistic talking head library, or optionally, processing may be carried out in the devices themselves.

Software applications and/or hardware may reside in such devices, computers and/or remote servers to analyze composite signals of the collected images of the human subjects and the alignment templates, and determine the accuracy of alignment to the markers and/or the guide images.

Voice prompts may be created by a synthetically generated voice, actual recorded human voice, or via a live human technical advisor, and communicated to the human subject in real-time to assist the user during the alignment process. Video prompts may alternatively and/or additionally be used. The human subject may then follow the information in the prompts to adjust his or her head position, and when properly aligned initiate the spoken phrase portion of the capture process. Voice and/or video prompts may be used to assist the human subject in other tasks as well, such as when to repeat a sequence, if proper alignment is possibly lost during the capture and/or alignment process, and/or when to start and/or stop the session

The portable devices and/or wireless handheld devices may be cell phones, personal digital assistants (PDA's), web-enabled phones, portable phones, personal computers, laptop computers, tablet computers, video phones, televisions, handheld televisions, wireless digital cameras, wireless camcorders, e-mail devices, instant messaging devices, pc phones, video conferencing devices, mobile phones, handheld devices, wireless devices, wireless handheld devices, and other suitable devices, that have a video camera and a display or other suitable cameras and displays.

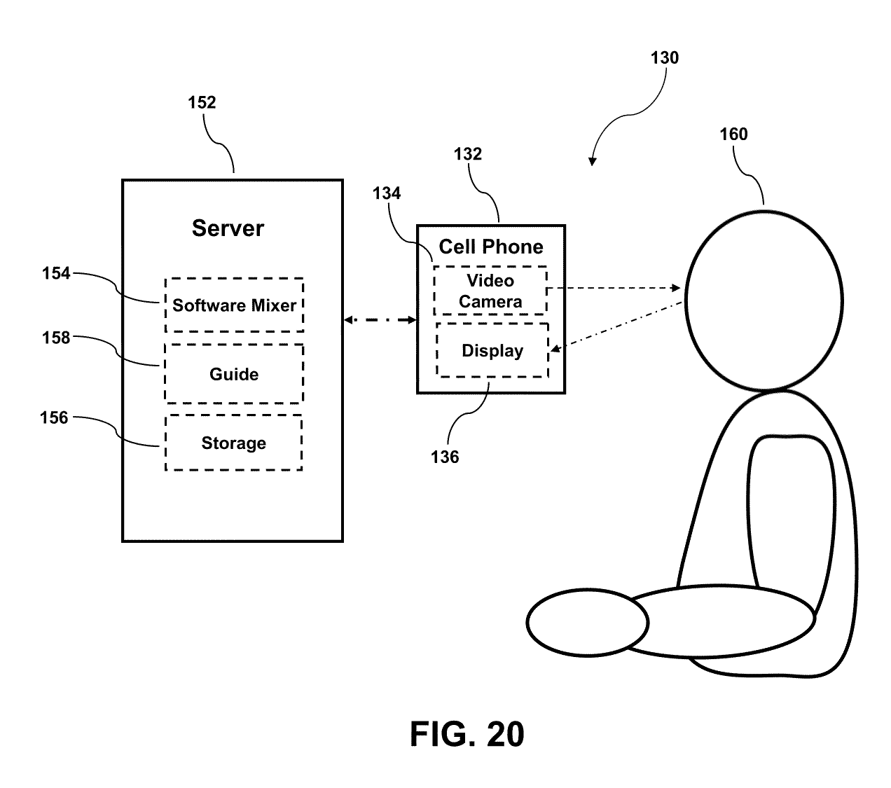

FIGS. 19 and 20 show do-it-yourself photo realistic talking head creation system 120 and do-it-yourself photo realistic talking head creation system 130, respectively. The do-it-yourself photo realistic talking head creation system 120 and the do-it-yourself photo realistic talking head creation system 130 each have cell phone 132, each of the cell phones 132 having video camera 134 and display 136.

The do-it-yourself photo realistic talking head creation system 120 of FIG. 19 has server 142, which is typically a remote server, the server 142 having software mixer 144, storage 146, and markers 150, which are substantially the same as the markers 104, 106, 108, 110, and 112, or other suitable markers may be used.

The do-it-yourself photo realistic talking head creation system 130 of FIG. 20 alternatively has server 152, which is also typically a remote server, the server 152 having software mixer 154, storage 156, and guide 158.

It should be noted that the markers 150 are typically preferred over the guide 158, as the markers 104, 106, 108, 110, and 112, or other suitable markers, are typically easier to see, easier to distinguish from the subject, and easier to use for alignment than the guide 158 or the guide 20 on small devices, such as cell phones, other small wireless device, or handheld devices.

The guide 158 is substantially the same as the guide 20. Use of the guide 158 or the guide 20 as an alignment template, for aligning the subject, using the composite output image 38, shown in FIG. 5, may be more difficult to use on small devices, such as cell phones, other small wireless device, or handheld devices, but may provide an acceptable approach for use with larger devices, such as with computers having larger displays or monitors or laptop computers having large enough displays to easily distinguish features of the composite image. Use or the markers 104, 106, 108, 110, and 112, or other suitable markers, is expected to decrease eye fatigue during the alignment process compared to the use of the guide 20.

An image of subject 160 is collected by the video camera 134 of the cell phone 132 of the do-it-yourself photo realistic talking head creation system 120 of FIG. 19. The software mixer 144 of the server 142 creates a composite image of the collected image of the subject 160 and the markers 150 that are displayed on the display 136. The subject 160 aligns his or her key facial features, such as eyes, tip of the nose, and corners of the mouth, with the markers 150, and the storage 146 may then be used to store ones of selected images.

Alternatively, an image of the subject 160 may collected by the video camera 134 of the cell phone 132 of the do-it-yourself photo realistic talking head creation system 130 of FIG. 20. The software mixer 154 of the server 152 creates a composite image of the collected image of the subject 160 and the guide 158 that is displayed on the display 136, which may be aligned one with the other by the subject 160, and the storage 156 may then be used to store ones of selected images.

The video camera 134 is preferably a high definition digital video camera, which can produce digital video frame stills comparable in quality and resolution to a digital still camera, although other suitable cameras and/or electronic image collection apparatus may be used.

The storage 146 or 156 may be optical storage media and/or magnetic storage media or other suitable storage may be used.

The markers 150, the guide 158, and the software mixer 14, may be a computer program, which may be loaded and/or stored in the server 142 or the server 152, although other suitable markers, guides, and/or mixers may be used.

The do-it-yourself photo realistic talking head creation system 120 of FIG. 19 may then be described as:
An apparatus for constructing a photo realistic human talking head, comprising:
   a handheld device;
   a network;
   a server;
   the handheld device and the server communicating, via the network, one with the other;
   a library of alignment templates,
      the server comprising the library of alignment templates,
      each the alignment template being different one from the other and comprising a plurality of markers associated with facial features of a subject for a particular head angular position, comprising a head tilt, a head nod, and a head swivel component,
      each the alignment template head angular position different one from the other;
   a controller,
      the server comprising the controller,
      the controller selecting an alignment template from the library of alignment templates corresponding to a specified alignment template head angular position and having an image output signal representational of the alignment template;
   a video camera,
      the handheld device comprising the video camera,
      the video camera collecting an image of a human subject having a head having a human subject head angular position, comprising a human subject head tilt, a human subject head nod, and a human subject head swivel component,
      the video camera having an output signal representational of the collected image of the human subject,
      the handheld device communicating the output signal of the video camera representational of the collected image of the human subject to the server via the network;
   the server,
      the server having an input receiving the output signal of the video camera representational of the collected image of the human subject,
         the server having a mixer,
         the server receiving the selected alignment template image output signal from the controller, and communicating the selected alignment template image output signal and the received collected image signal of the human subject to the mixer,
         the mixer receiving the selected alignment template image output signal and the communicated collected image signal of the human subject, and mixing one with the other into an output signal representational of a composite image of the collected image of the human subject and the selected alignment template, and communicating the composite image signal of the collected image of the human subject and the selected alignment template to the server,
         the server having an output signal representational of the composite image signal of the collected image of the human subject and the selected alignment template received from the mixer,
         the server communicating the output signal representational of the composite image signal of the collected image of the human subject and the selected alignment template to the handheld device via the network;
   a display,
      the handheld device comprising the display,
      the display having an input receiving the output signal representational of the composite image signal of the collected image of the human subject and the selected alignment template,
      the display and the video camera adapted to allow the video camera to collect the image of the human subject and the human subject to view the composite image and the human subject to align the image of the head of the human subject with the markers of the alignment template;
   storage means storing a library of collected images of the human subject with the head of the subject at different human subject head angular positions,
      the server comprising the storage means,
      the server communicating the received collected image signal of the human subject to the storage means,
      the storage means receiving and storing the received collected image signal of the human subject as a stored image of the human subject, when the human subject has the head of the human subject substantially aligned with the markers of the alignment template,
      the stored image of the human subject having the human subject head angular position substantially the same as the specified alignment template head angular position,
      each the stored image in the library of collected images being different one from the other,
      each the stored image human subject head angular position different one from the other;
      each the stored image human subject head angular position of the library of collected images corresponding to and substantially the same as and aligned with a selected the alignment template of the library of alignment templates;
      each the stored image representing a different frame of a photo realistic human talking head.

The do-it-yourself photo realistic talking head creation system 130 of FIG. 20 may then be described as:
An apparatus for constructing a photo realistic human talking head, comprising:
   a handheld device;
   a network;
   a server;
   the handheld device and the server communicating, via the network, one with the other;
   a library of alignment templates,
      the server comprising the library of alignment templates,
      each the alignment template being different one from the other and representational of an alignment template frame of a photo realistic human talking head having an alignment template head angular position, comprising a template head tilt, a template head nod, and a template head swivel component,
      each the alignment template frame different one form the other,
      each the alignment template head angular position different one from the other;
   a controller,
      the server comprising the controller,
      the controller selecting an alignment template from the library of alignment templates corresponding to a specified alignment template head angular position and having an image output signal representational of the alignment template;
   a video camera,
      the handheld device comprising the video camera,
      the video camera collecting an image of a human subject having a head having a human subject head angular position, comprising a human subject head tilt, a human subject head nod, and a human subject head swivel component,
      the video camera having an output signal representational of the collected image of the human subject,
      the handheld device communicating the output signal of the video camera representational of the collected image of the human subject to the server via the network;
   the server,
      the server having an input receiving the output signal of the video camera representational of the collected image of the human subject,
         the server having a mixer,
         the server receiving the selected alignment template image output signal from the controller, and communicating the selected alignment template image output signal and the received collected image signal of the human subject to the mixer,
         the mixer receiving the selected alignment template image output signal and the communicated collected image signal of the human subject, and mixing one with the other into an output signal representational of a composite image of the collected image of the human subject and the selected alignment template, and communicating the composite image signal of the collected image of the human subject and the selected alignment template to the server,
         the server having an output signal representational of the composite image signal of the collected image of the human subject and the selected alignment template received from the mixer,
         the server communicating the output signal representational of the composite image signal of the collected image of the human subject and the selected alignment template to the handheld device via the network;
   a display,
      the handheld device comprising the display,
      the display having an input receiving the output signal representational of the composite image signal of the collected image of the human subject and the selected alignment template,
      the display and the video camera adapted to allow the video camera to collect the image of the human subject and the human subject to view the composite image and the human subject to align the image of the head of the human subject with the alignment template head at substantially the same angular position as the specified alignment template head angular position;
   storage means storing a library of collected images of the human subject with the head of the subject at different human subject head angular positions,
      the server comprising the storage means,
      the server communicating the received collected image signal of the human subject to the storage means,
      the storage means receiving and storing the received collected image signal of the human subject as a stored image of the human subject, when the human subject has the head of the human subject substantially aligned with the alignment template head,
      the stored image of the human subject having the human subject head angular position substantially the same as the specified alignment template head angular position,
      each the stored image in the library of collected images being different one from the other,
      each the stored image human subject head angular position different one from the other;
      each the stored image human subject head angular position of the library of collected images corresponding to and substantially the same as and aligned with a selected the alignment template head angular position of the library of alignment templates;
      each the stored image representing a different frame of a photo realistic human talking head.

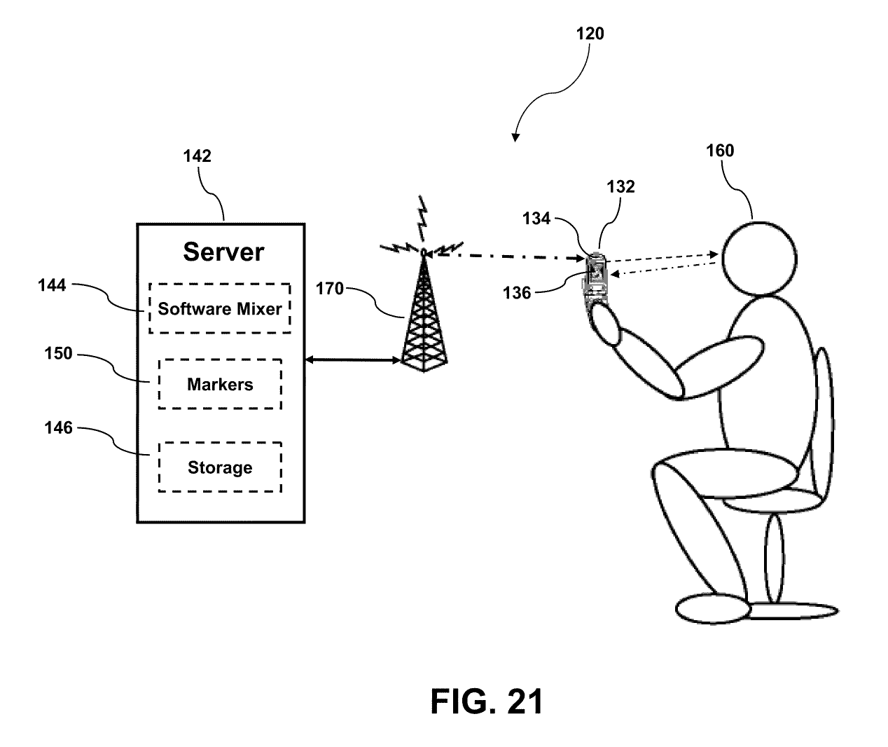

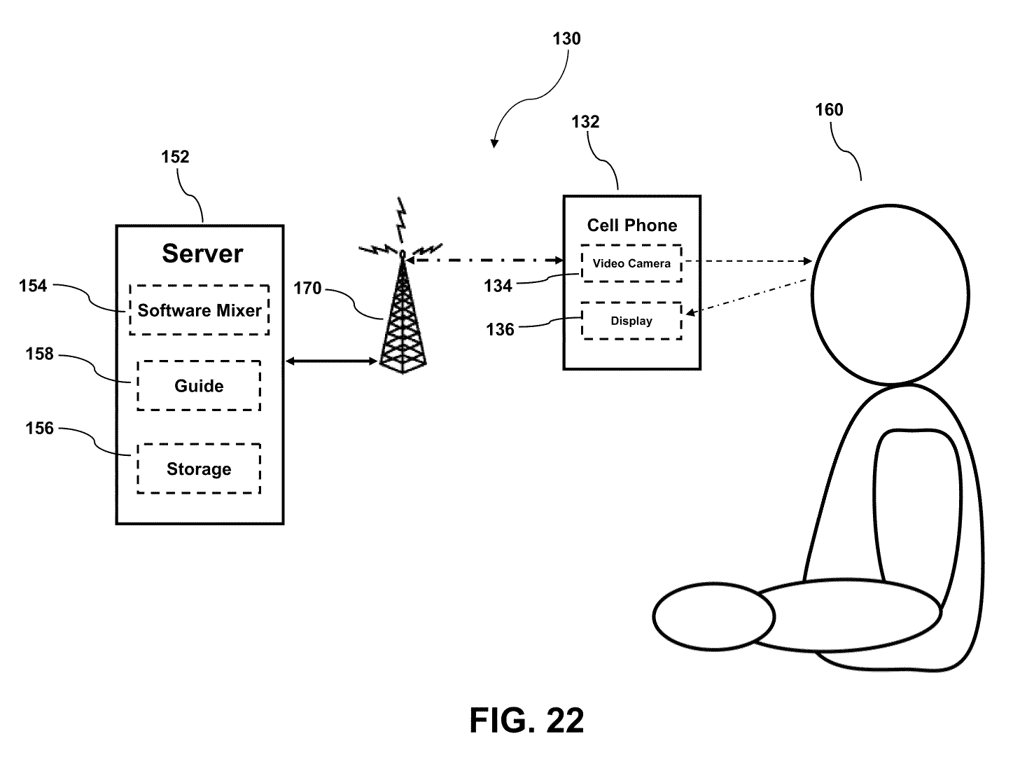

FIGS. 21 and 22 show the cell phones 132 of the do-it-yourself photo realistic talking head creation system 120 and 130, respectively, communicating wirelessly with the servers 142 and 152, respectively. The cell phones 132 typically communicate wirelessly with the servers 142 and 152, which may be located on one or more wireless cellular networks, or other suitable networks, via antennas 170.

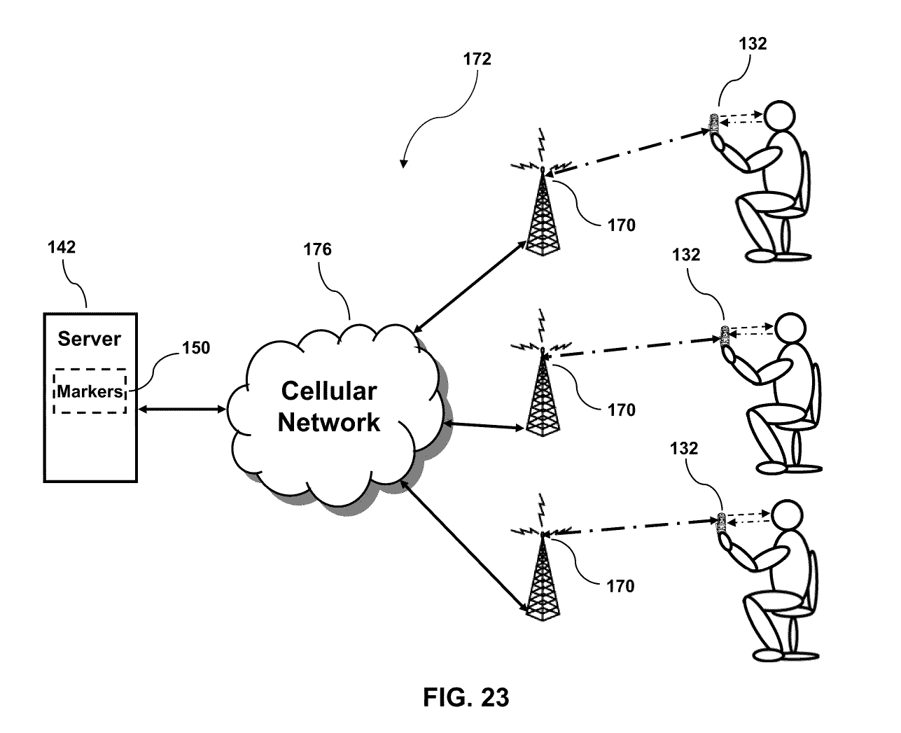

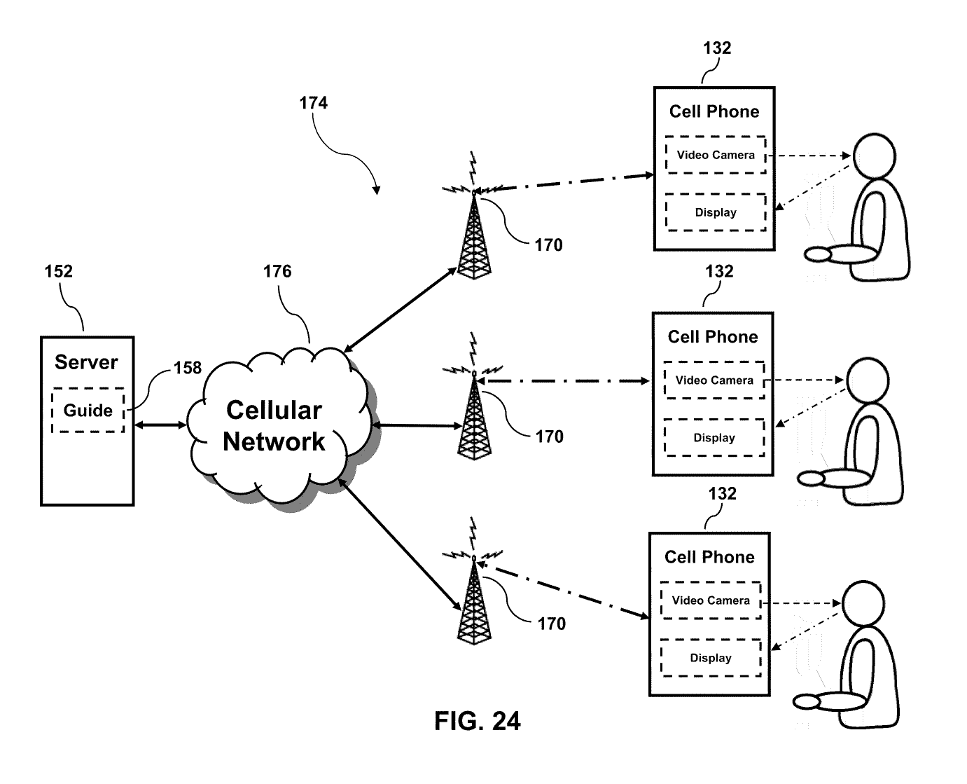

FIGS. 23 and 24 show do-it-yourself photo realistic talking head creation systems 172 and 174 that are substantially the same as the do-it-yourself photo realistic talking head creation systems 120 and 130, respectively, except that the do-it-yourself photo realistic talking head creation systems 172 and 174 have a plurality of the cell phones 132 communicating with the servers 142 and 152, respectively, via cellular network 176. Each of the cell phones 132 communicate wirelessly with the cellular network 176 via the antennas 170.

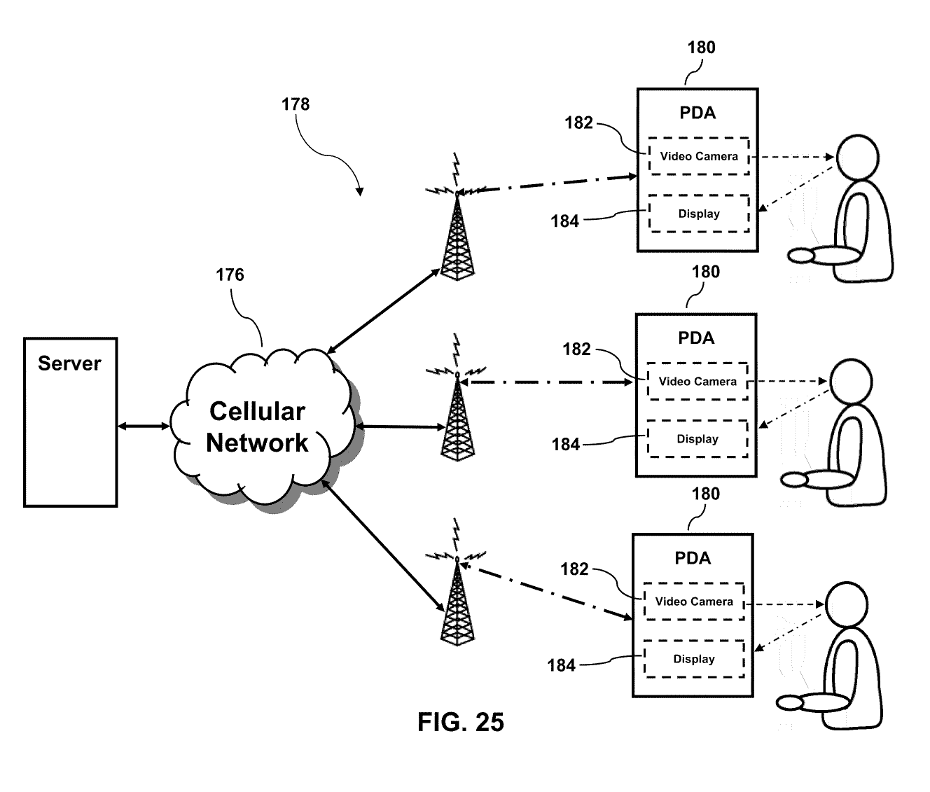

FIG. 25 shows a do-it-yourself photo realistic talking head creation system 178, which is substantially the same as the do-it-yourself photo realistic talking head creation system 172, except that the do-it-yourself photo realistic talking head creation system 178 has a plurality of personal digital assistants (PDA's) 180, each of which have a video camera 182 and a display 184.

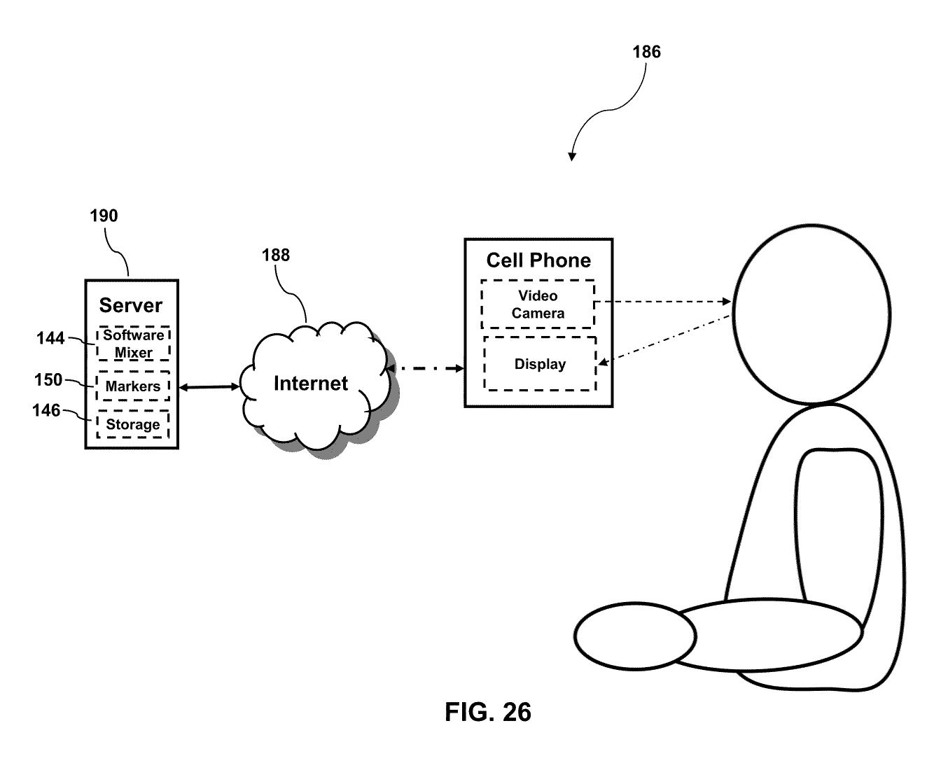

FIG. 26 shows a do-it-yourself photo realistic talking head creation system 186, which is substantially the same as the do-it-yourself photo realistic talking head creation system 120, except that the do-it-yourself photo realistic talking head creation system 186 is connected to internet 188 having server 190 connected thereto. The server 190 has the software mixer 144, the markers 150, and the storage 146, or the server 190 may alternatively and/or additionally have the software mixer 154, the guide 158, and the storage 156.

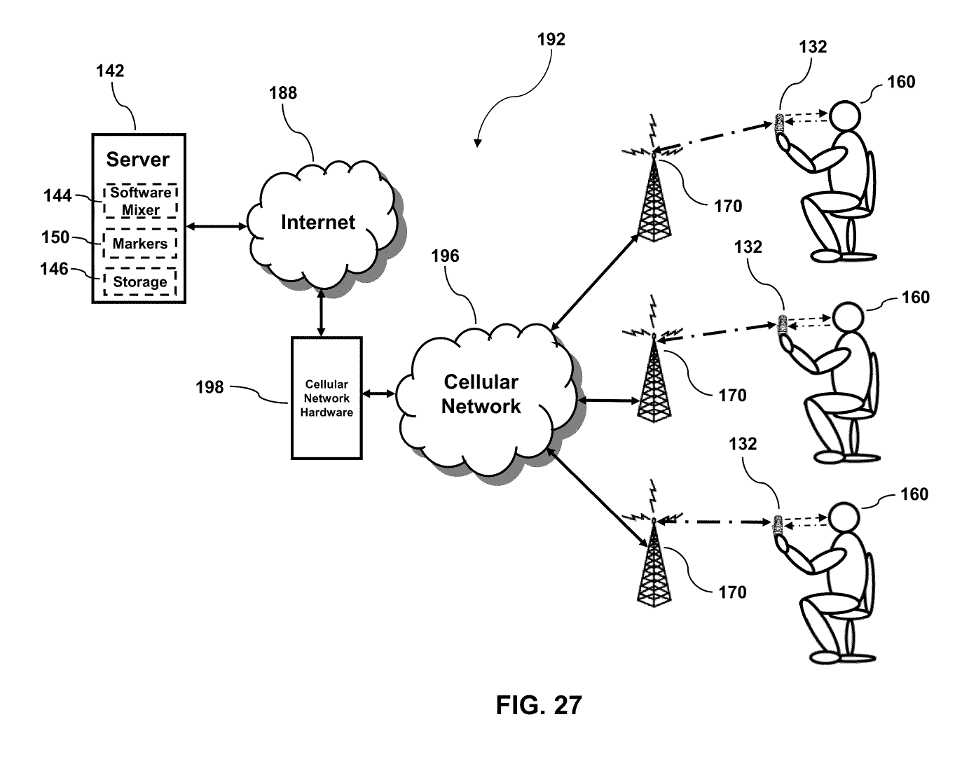

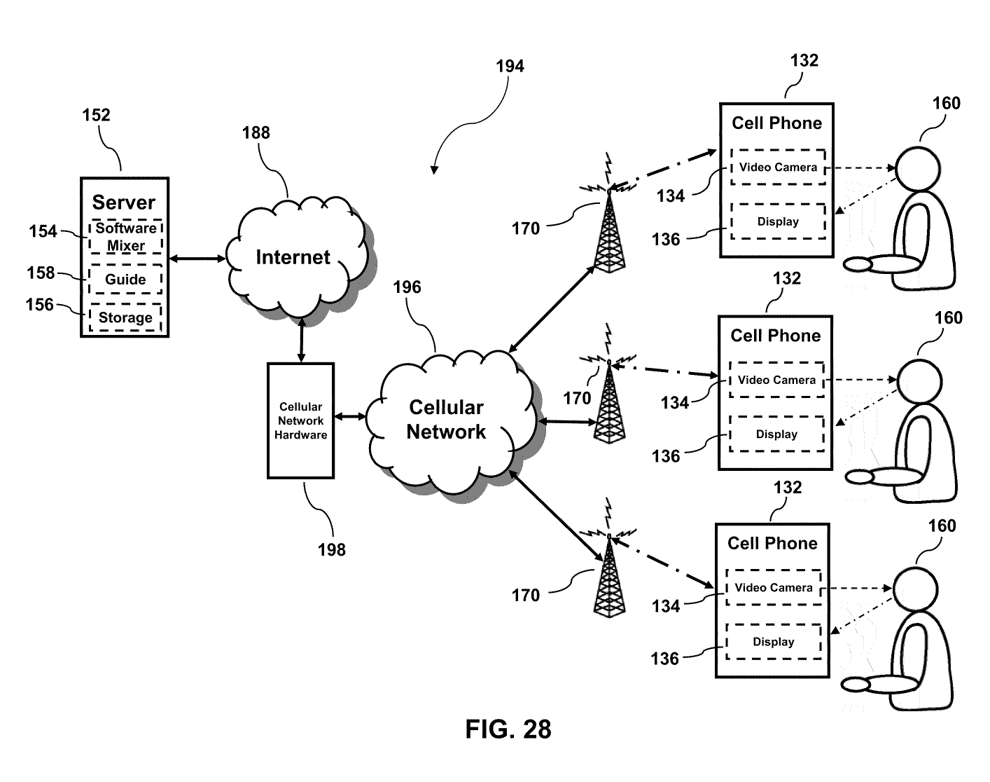

FIGS. 27 and 28 show do-it-yourself photo realistic talking head creation systems 192 and 194, respectively, which are substantially the same as the do-it-yourself photo realistic talking head creation systems 172 and 174, respectively, except that the do-it-yourself photo realistic talking head creation systems 192 and 194 are connected to the internet 188 via wireless cellular network 196 and cellular network hardware 198.

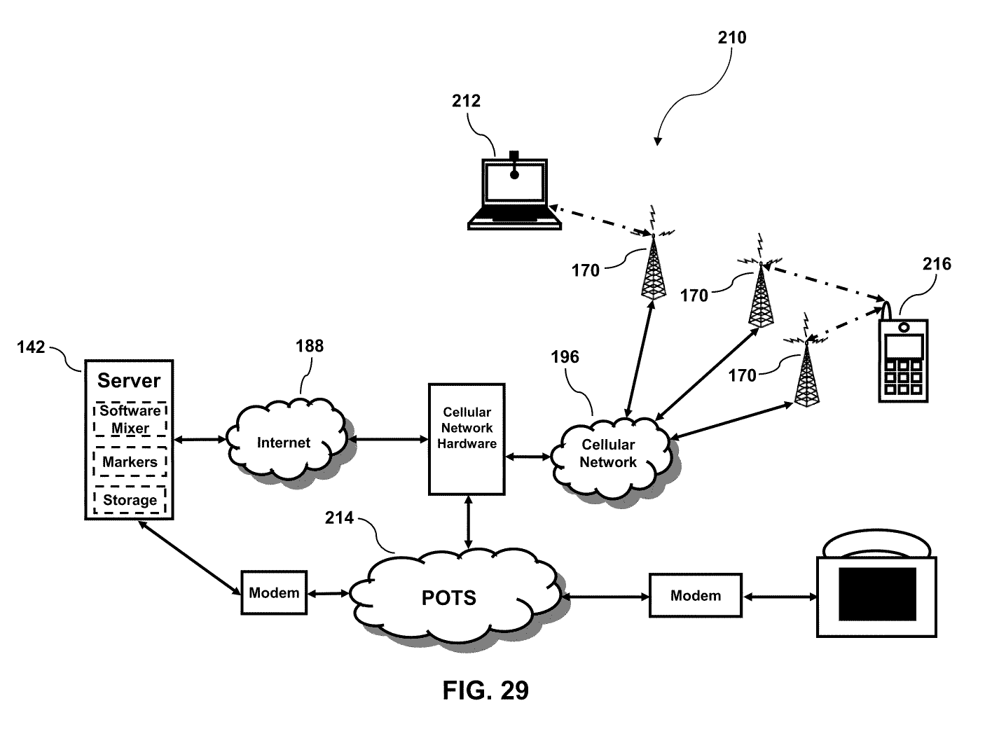

FIG. 29 shows a do-it-yourself photo realistic talking head creation system 210, which is substantially the same as the do-it-yourself photo realistic talking head creation system 192, except that the do-it-yourself photo realistic talking head creation system 210 has laptop computer 212 wirelessly connected to the wireless cellular network 196 via the antennas 170. The wireless cellular network 196 and plain old telephone system (POTS) 214 are each connected to the internet 188, which is connected to the server 142. Portable wireless devices 216 may be used include cell phones, personal digital assistants (PDA's), handheld wireless devices, other suitable portable wireless devices, laptop computers, personal computers, and other computers.

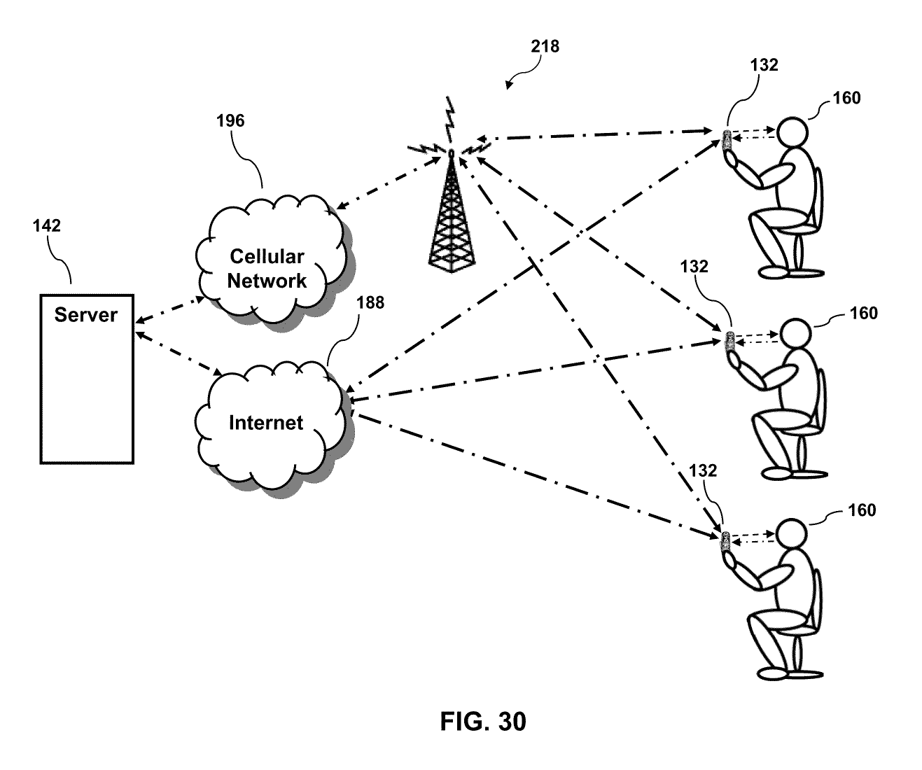

FIG. 30 shows a do-it-yourself photo realistic talking head creation systems 218, which is substantially the same as the do-it-yourself photo realistic talking head creation systems 172, except that the do-it-yourself photo realistic talking head creation system 218 is connected wirelessly to the internet 188 and to the wireless cellular network 196, which are each connected to the server 142.

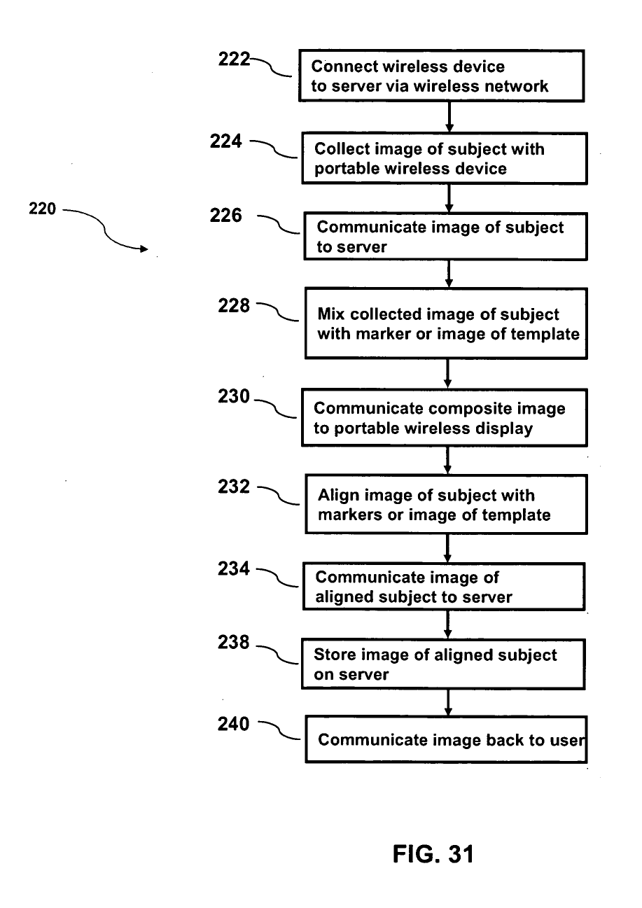

FIG. 31 shows steps of a method of constructing a photo realistic talking head 220, using one or more of the do-it-yourself photo realistic talking head creation systems shown in FIGS. 19-30, comprising wirelessly connecting a wireless device to a server via a network 222, communicating an image of an aligned subject to the server 226, storing the image of the aligned subject on the server 238, and communicating the image back to the subject or user 240.

In more detail, the method of constructing a photo realistic talking head 220 comprises the steps of: wirelessly connecting a wireless device to a server via a network 222, collecting an image of a subject with a portable wireless device, such as a cell phone video camera, personal digital assistant (PDA) video camera, or other suitable device 224, communicating the collected image of the subject to the server 226, mixing the collected image of the subject with preferably markers or alternatively an image of a template 228, communicating a composite image to the portable wireless device, and more particularly to a display of the portable wireless device 230, aligning an image of the subject with an image of the markers or the alternative image 232, communicating an image of the aligned subject to the server 234, storing the image of the aligned subject on the server 238, and communicating the image of the aligned subject to the subject 240.

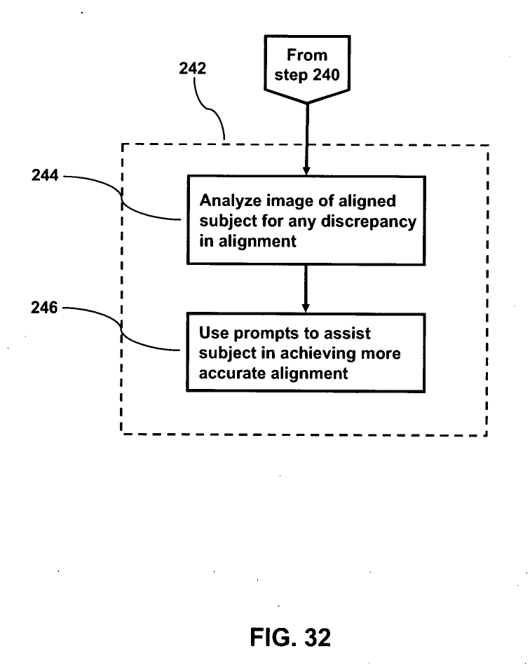

FIG. 32 shows additional optional steps 242 of the method of constructing a photo realistic talking head 220, comprising the steps of: analyzing the image of the aligned subject for any discrepancy in alignment 244, and using prompts, such as audio, voice prompts, and/or video prompts, to assist the subject in achieving more accurate alignment 246.

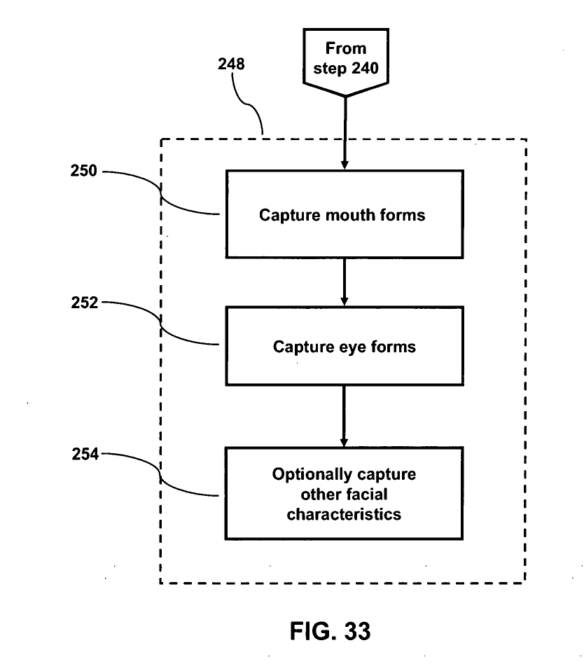

The method of constructing a photo realistic talking head 220 may have additional optional steps, comprising: capturing facial characteristics 248 after the step 240 and/or after the step 246, which are substantially the same as the additional optional steps shown in FIG. 17, and which are repeated here for clarity and understanding in FIG. 33.

The method of constructing a photo realistic talking head 220 may have the additional optional steps, shown in FIG. 33, comprising: capturing facial characteristics 248; including capturing mouth forms 250; capturing eye forms 252; optionally capturing other facial characteristics 254.

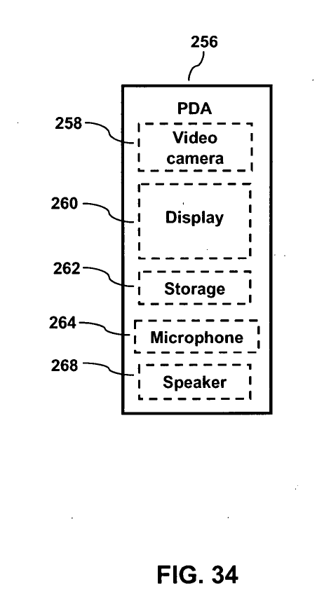

FIG. 34 is a block diagram of a video capture device 256, such as a personal digital assistant (PDA) or other suitable device, that has a video camera 258, display 260, storage 262, microphone 264, and speaker 268, and which may be used with various aforedescribed embodiments of the present invention.

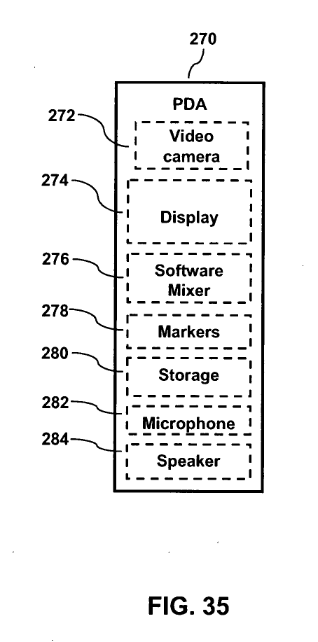

FIG. 35 is a block diagram of an alternate embodiment of a do-it-yourself photo realistic talking head creation system 270, constructed in accordance with the present invention, having a video camera 272, display 260, software mixer 276, markers 278, storage 280, microphone 282, and speaker 284.

The do-it-yourself photo realistic talking head creation system 270 of FIG. 35 comprises substantially all the equipment necessary for a do-it-yourself photo realistic talking head creation system packaged into a single portable device.

The do-it-yourself photo realistic talking head creation system 270 may be a personal digital assistant (PDA) or other suitable device having the video camera 272, the display 260, the software mixer 276, the markers 278 or alternatively and/or additionally the guide, the storage 280, the microphone 282, and the speaker 284.

An image of a subject may be collected by the video camera 272, substantially the same as previously described for the do-it-yourself photo realistic talking head creation systems shown in any of FIGS. 19-30. The software mixer 276 creates a composite image of the collected image of the subject and the markers 278 or alternatively and/or additionally the guide that is displayed on the display 260, which the subject may use to align himself or herself with, and the storage 280 may then be used to store ones of selected images, substantially the same as previously described for the do-it-yourself photo realistic talking head creation systems shown in any of FIGS. 19-30.

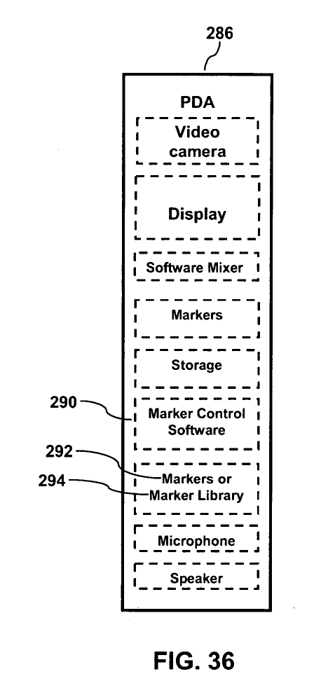

FIG. 36 shows an alternate embodiment of a do-it-yourself photo realistic talking head creation system 286, which is substantially the same as the do-it-yourself photo realistic talking head creation system 270, except that the do-it-yourself photo realistic talking head creation system 286 has marker control software 290, which may be used to control markers 292 individually and/or to control a marker library 294. The do-it-yourself photo realistic talking head creation system 286 may alternatively and/or additionally have guide control software, which may be used to control guides individually and/or to control a guide library.

The do-it-yourself photo realistic talking head creation system 286 of FIG. 36 comprises substantially all the equipment of an entire do-it-yourself photo realistic talking head creation system packaged into a single portable device

III. Creating Photo-Talking Head Content and Incorporation of Branding into Photo-Talking Head Content

FIGS. 2-29 of the drawings show systems and methods for creating photo-talking head content and incorporation of branding into photo-talking head content

A brand may be considered to be a collection of associations, symbols, preferences, and/or experiences associated with and/or connected to a product, a service, a person, a profile, a characteristic, an attribute, or any other artifact or entity.

Brands have become important parts of today's social environment, culture, and the economy, and are sometimes referred to as “personal philosophies” and/or “cultural accessories”.

The brand may be a symbolic construct created within the minds of people, and may comprise all the information and expectations associated with a product, individual, entity, and/or service.

Brands may be associated with attributes, characteristics, descriptions, profiles, and/or other associations that describe and/or relate the brands to the “personal philosophies”, likes, dislikes, preferences, demographics, relationships, and other characteristics of individuals, businesses and/or entities.

Branding may then be used to incorporate advertising into information and/or content, such as, for example, photo realistic talking head content, communicated to individuals, businesses and/or entities

A. Creating Photo-Talking Head Content

The photo realistic talking head system of the present invention comprises a photo realistic talking head library creation apparatus, a photo realistic talking head library creation server device, a photo realistic talking head content creation apparatus, a photo realistic talking head content creation server device, a brand association server device, and a content distribution server device.

The photo realistic talking head library creation apparatus and the photo realistic talking head library creation server device may alternatively be referred to as a photo-realistic talking head server in the description and/or the drawings, and is directed toward the creation of the photo-realistic talking head library.

The photo realistic talking head content creation apparatus and the photo realistic talking head content creation server device may alternatively be referred to as a production server in the description and/or the drawings, and is directed toward the creation of photo-realistic talking head content.

The content distribution server device may alternatively be referred to as a show server in the description and/or the drawings, and is directed toward the distribution of branded content to recipients.

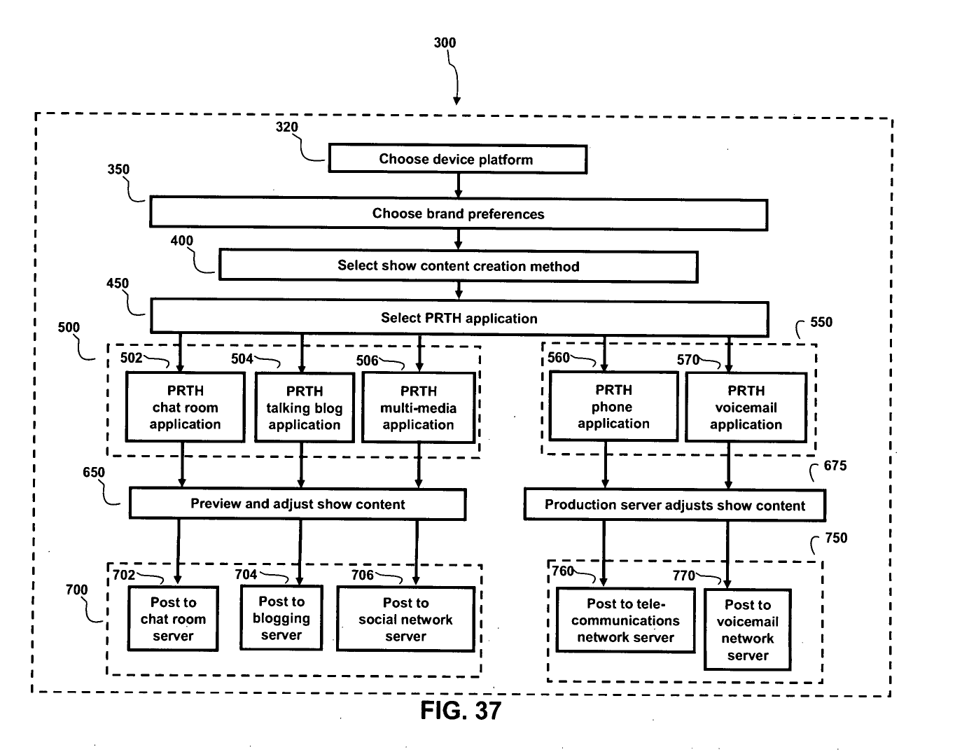

FIGS. 37, 38, and 40-65 show various aspects of creating photo-realistic content.

FIG. 37 is a schematic representation of a show content creation and uploading method (300) showing show content creation and uploading. A user chooses a device platform (320). The user chooses his or her brand preferences (350), selects a content creation method (400), and using either the photo-realistic talking head chat (510), photo-realistic talking head blog (520), photo-realistic talking head multi-media (530), photo-realistic talking head phone (560), or photo-realistic talking head voicemail application (570), creates photo-realistic talking head shows, the user manually adjust the show (650), and then posts to the appropriate server, such as a photo-realistic talking head chat room server (700), photo-realistic talking head blogging server (710), or a photo-realistic talking head enabled social networking server (720). If using the photo-realistic talking head phone or voice mail applications, adjusting is done by a software program (675), then the content is sent to the appropriate server, such as a telecommunications network server (730), or voicemail server (740) without adjustment.

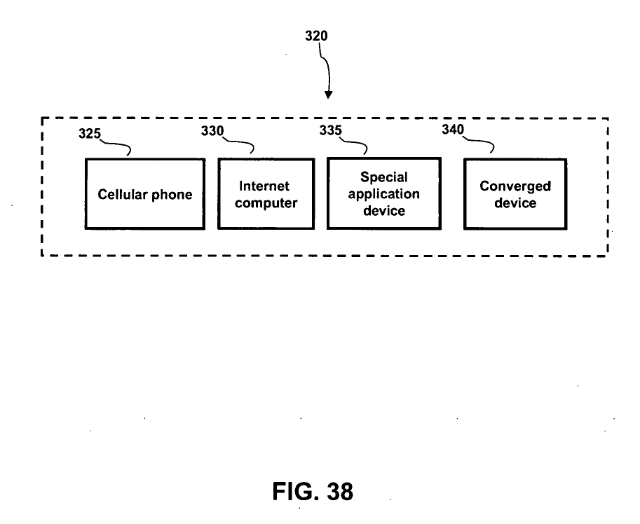

FIG. 38 is a schematic representation of selected device platforms that may be used with photo-realistic talking head applications (320) that depicts selected device platforms for photo-realistic talking head applications, including, but not limited to a cellular phone (325), internet computer (330), special application device (335), or converged device (340). A special application device is any device that used for a specific task whether be consumer or business device. An example of a specific application device is a handheld inventory tracking device with wireless access to tie into a server. A converged device may include: cellular access, Wifi/WiMax type access, full or qwerty keyboard, email access, multi-media player, video camera, and camera, or other suitable devices.

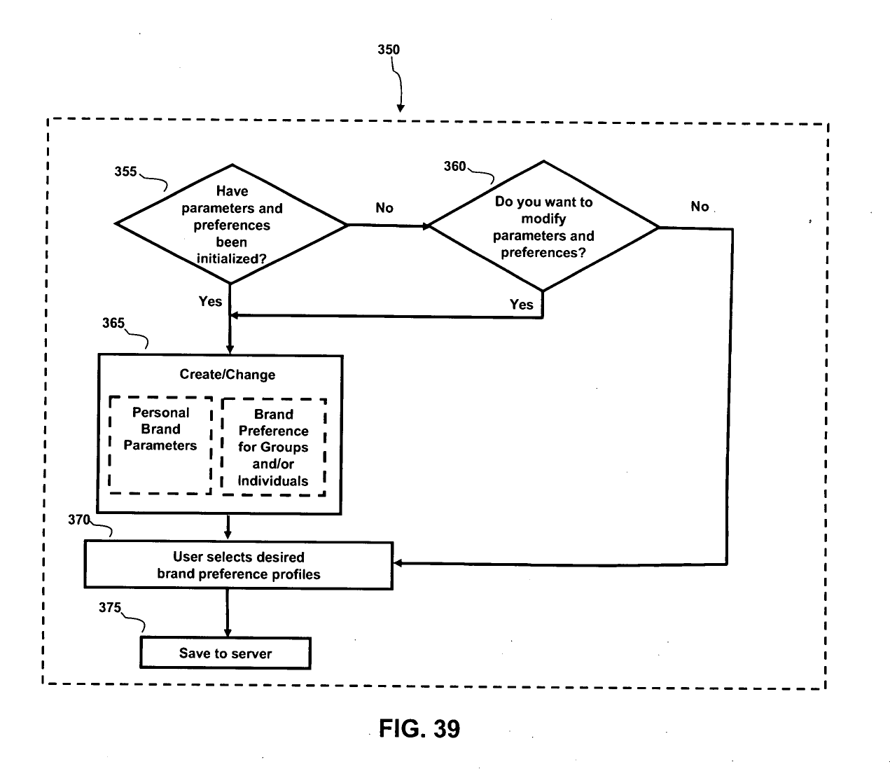

FIG. 39 is a schematic representation of a process for caller personalized brand placement (350), including caller personalized brand placement is shown. A user is asked (355) if parameters and preferences have been initialized. Parameters are the users personal brand parameters they set. Preferences are identifiers the user gives to groups and/or individuals. If the answer is no, the user is asked (360) if they want to modify any parameters and preferences. If the answer to (355) or (360) is yes, the user creates or changes (365) one or more of the parameters and preferences. After completing the (365) or answering no to (360) the user selects the brand preference profiles (370) for the specific event or events they are engaging in. The user then saves the changes, creations, and event profiles (370) to server.

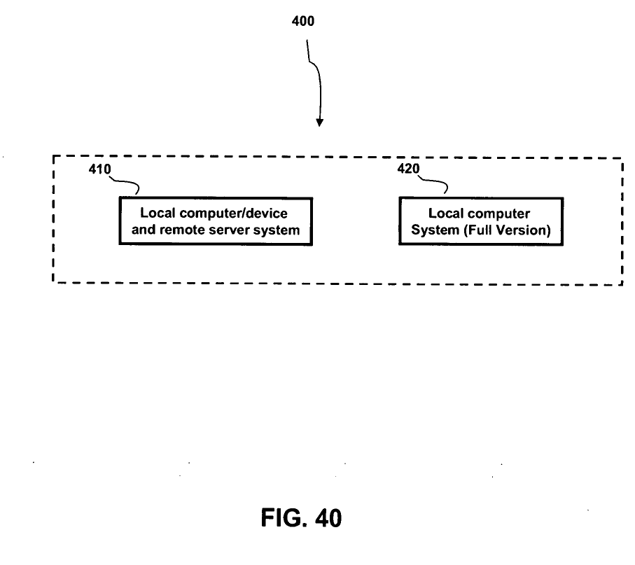

FIG. 40 is a schematic representation of show content creation methods (400). A user may produce content with any of devices (320), or other suitable devices, with creative assistance via a remote server system (410), or with a local computer system (Full Version) (420) and/or the other suitable systems and/or methods that may be sui suitable for creating photo-realistic talking head system.

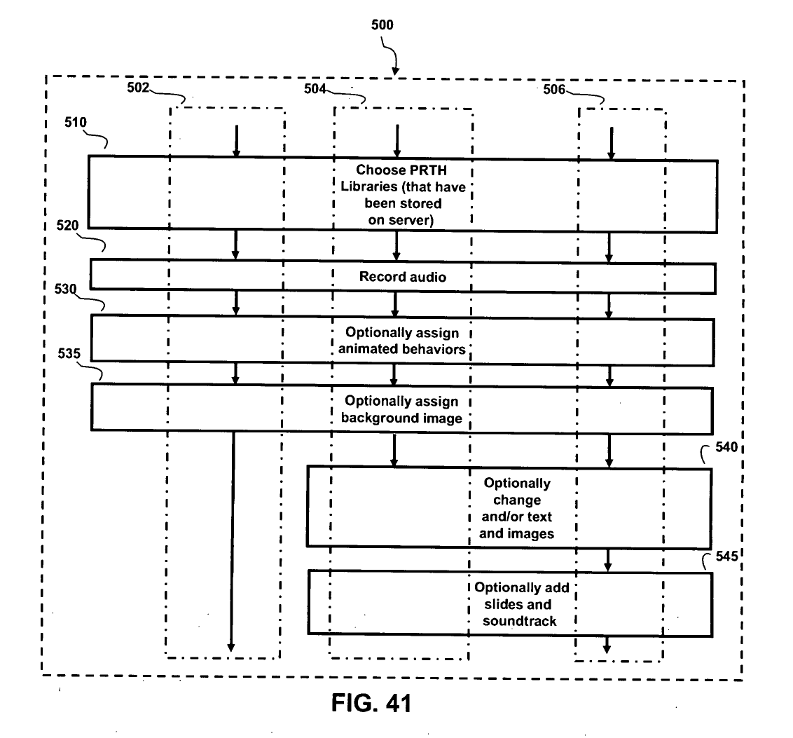

FIG. 41 is a schematic representation of a process for creating photo-realistic talking head content for chat, blog or multi-media applications (500). After a user selects and launches (450) one of the photo-realistic talking head applications (502) (504) (506), the user then chooses their personal photo-realistic talking head or other character as their avatar (510), records vocal audio files (520), optionally assigns animated behaviors (530), which are scripted motions stored and associated with the photo-realistic talking head library, optionally assigns a background image (535), optionally assigns text and/or images (540), and optionally assigns slideshows and/or soundtrack music (545).

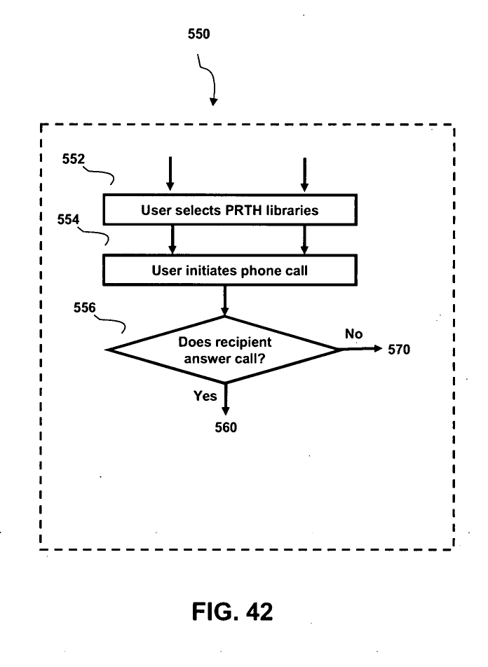

FIG. 42 is a schematic representation of a process for creating photo-realistic talking head content for phone, or voicemail applications (550). The user selects photo-realistic talking head libraries to use as their avatar (552) and then initiates a phone call (554). After the phone call is placed, the split occurs whether the recipient answers the phone call (556). If the recipient answers the call the phone application begins, if the caller does not answer the voice mail application begins.

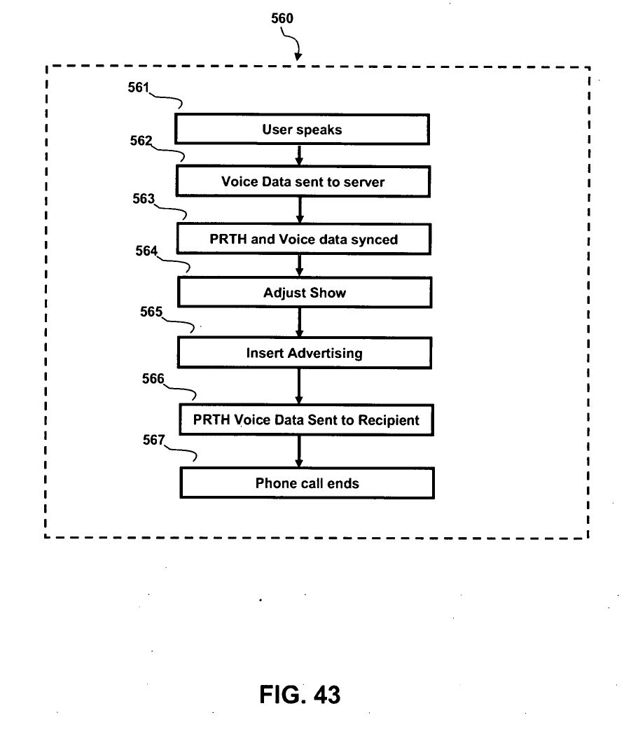

FIG. 43 is a schematic representation of a photo-realistic talking head phone application (560). The user speaks (561), and user voice data is sent to the server as Voice Data (562). The application synchronizes photo-realistic talking head and voice data (563), makes any adjustments to the show (564), inserts advertising based on the preferences and parameters (565) and sends the all the data to the recipient (567). The phone call can continue in this loop until the phone call ends (567).

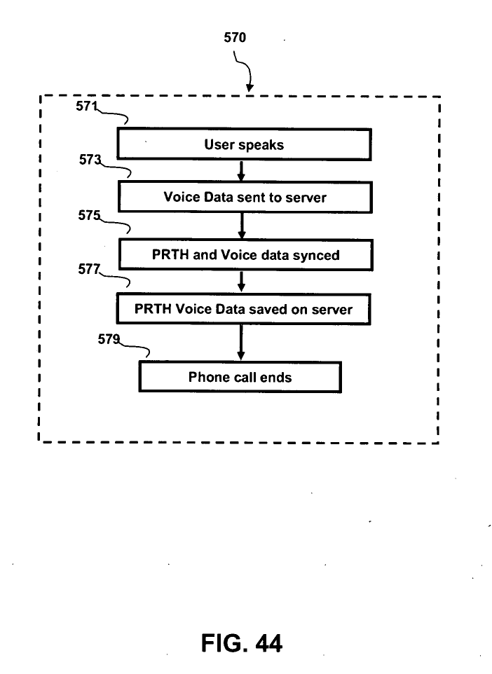

FIG. 44 is a schematic representation of a photo-realistic talking head voice mail application (570). The user speaks (571), and user voice data is sent to the server as Voice Data (573). The application synchronizes the photo-realistic talking head and voice data (575), the photo-realistic talking head voice data is saved on the server (577) for the recipient to pick up later, and the phone call ends (579).

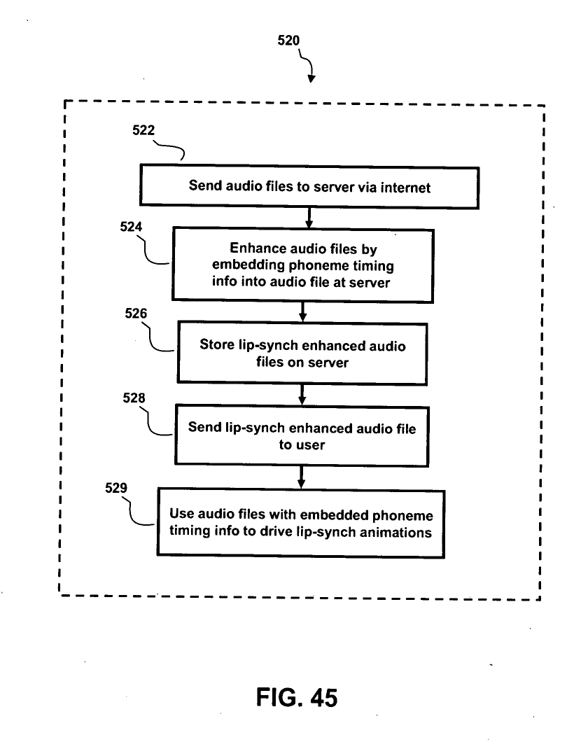

FIG. 45 is a schematic representation of a process for embedding lip synchronization data (520). After vocal audio has been recorded, a user sends the audio file to the production server via an internet connection (522). A Vocal Analysis and Lip Synchronization Application on the production server analyzes audio files and embeds phoneme timing info into an audio file (524). The lip synch enhanced audio files are then stored in the production server asset library (526), and sent back to the user via the internet (528). Users can then drive lip synchronized photo-realistic talking head animations with the embedded phoneme timing information (529).

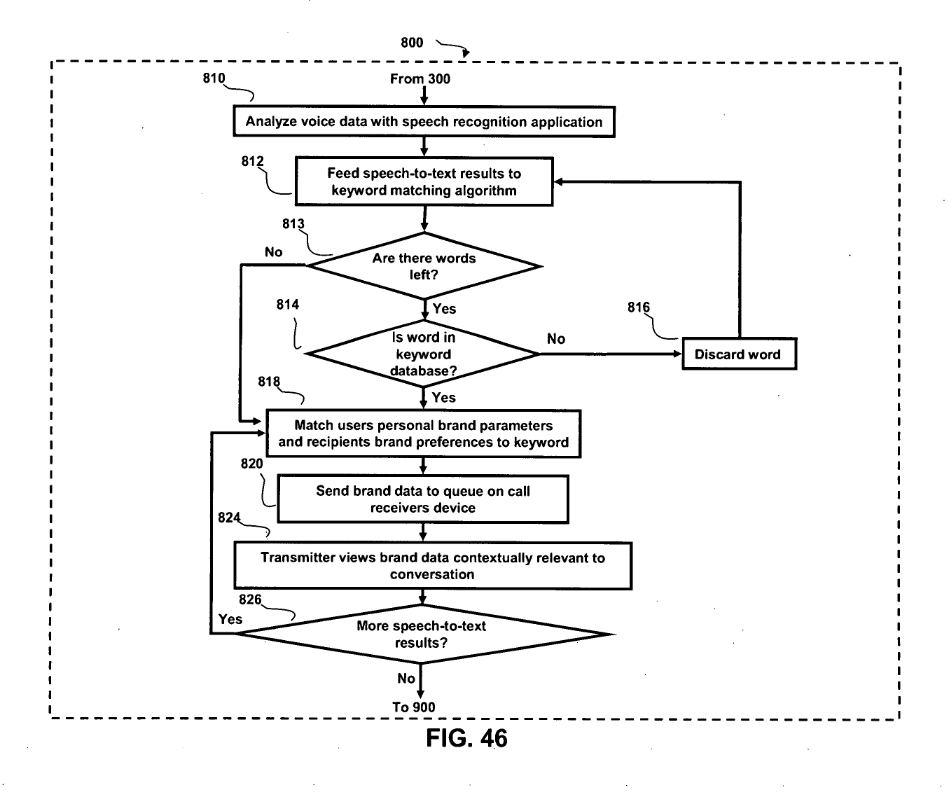

FIG. 46 is a schematic representation of a process for inserting branding by matching words associated with a user's parameters and preferences and a recipient's parameters and preferences (800) depicting the process of inserting branding (advertising, personal brand, etc.) through matching words associated with the user's parameters and preferences and the recipient's parameters and preferences. The user's voice channel signal is analyzed at the server with a speech recognition application (810). Speech-to-text results are fed to a keyword matching algorithm (812). The application checks to determine if words are left (813). If yes, the application checks to see if the word is in the keyword database (814). If not, then it discards the word (816). The user and the recipient parameters are used to match keyword with a brand (818). The brand data is sent to a brand queue on the call recipient's device (820). Brand history is associated with the user's contact information and conversation (824). The call recipient clicks a brand queue to view brand information contextually relevant to the conversation (824). If there are more speech-to-text results, then the application downloads the next brand (826).

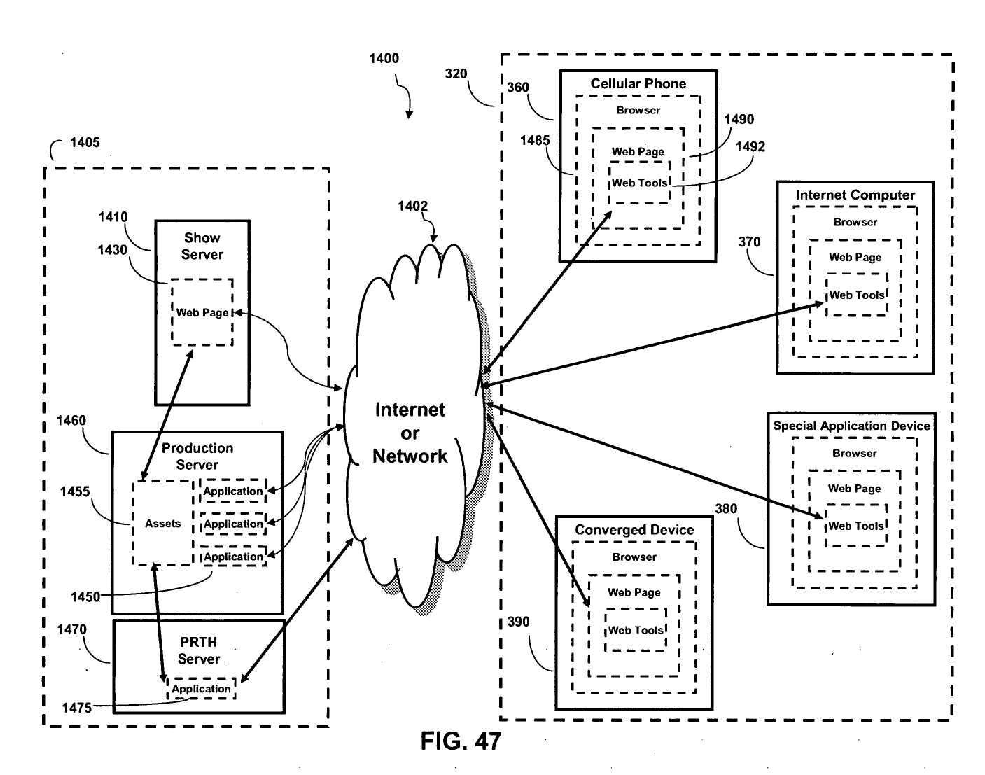

FIG. 47 is a schematic representation of a distributed web application network (1400). The various devices (320): cellular phone (360), internet computers (370), special application device (380), and converged device (390) are networked over the internet or other network (1402) to a system of servers (1405) including, but not limited to a show server (1410) containing web pages (1430), a production server (1460) containing virtualized instances of web applications (1450) and user assets (1455), and a photo-realistic talking head server (1470) containing the photo-realistic talking head application (1475). The user uses a web browser (1485) based light weight front end web tool client (1492) embedded in a web page (1490) to interface with the production server, show server, and photo-realistic talking head server.

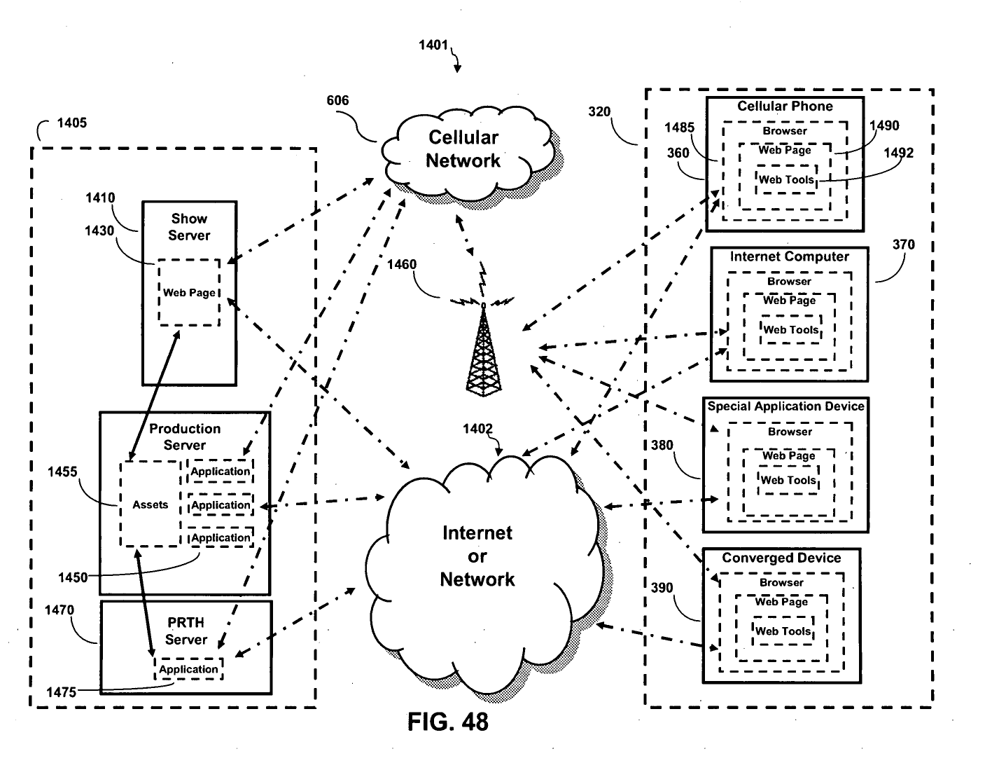

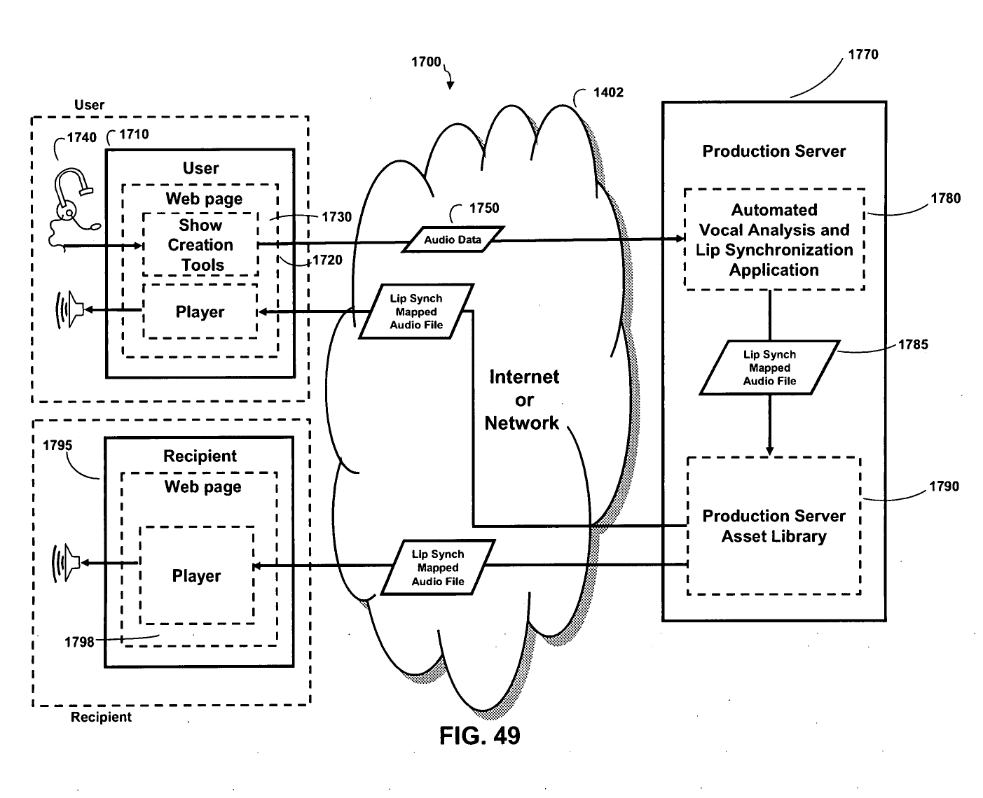

FIG. 48 is a schematic representation of another distributed web application network (1401). The various devices (320): cellular phone (360), internet computers (370), special application device (380), and converged device (390) are networked over the internet (1402) and/or cell phone network (3500) to a system of servers (1405) including, but not limited to a show server (1410) containing web pages (1430), an production server (1460) containing virtualized instances of web applications (1450) and user assets (1455), and a photo-realistic talking head server (1470) containing the photo-realistic talking head application (1475). The user uses a web browser (1485) based light weight front end web tool client (1492) embedded in a web page (1490) to interface with the production server, show server and photo-realistic talking head server.

The photo realistic talking head system of the present invention comprises a photo realistic talking head library creation apparatus, a photo realistic talking head library creation server device, a photo realistic talking head content creation apparatus, a photo realistic talking head content creation server device, a brand association server device, and a content distribution server device.

The photo realistic talking head library creation apparatus and the photo realistic talking head library creation server device may alternatively be referred to as a photo-realistic talking head server in the description and/or the drawings, and is directed toward the creation of the photo-realistic talking head library.

The photo realistic talking head content creation apparatus and the photo realistic talking head content creation server device may alternatively be referred to as a production server in the description and/or the drawings, and is directed toward the creation of photo-realistic talking head content.

The content distribution server device may alternatively be referred to as a show server in the description and/or the drawings, and is directed toward the distribution of branded content to recipients.

FIG. 49 is a schematic representation of an embedded lip synchronization system and method (1700). A user uses a microphone (1740) to record his or her voice with show creation tools (1730). The audio data (1750) is sent via the internet (1402) to the automated vocal analysis and lip synchronization application (1780) on the production server (1770). The audio data is analyzed with speech recognition software and the extracted phoneme/duration information is merged into the metadata section of the audio file to create a file format containing the phoneme/duration data, phoneme-to-viseme mapping tables and audio data in one multi lip synch mapped audio file (1785). The multi lip synch mapped audio file is stored in the production server asset library (1790) before being sent back to the user's computer (1795) to drive lip synchronization for shows viewed on the player (1798).

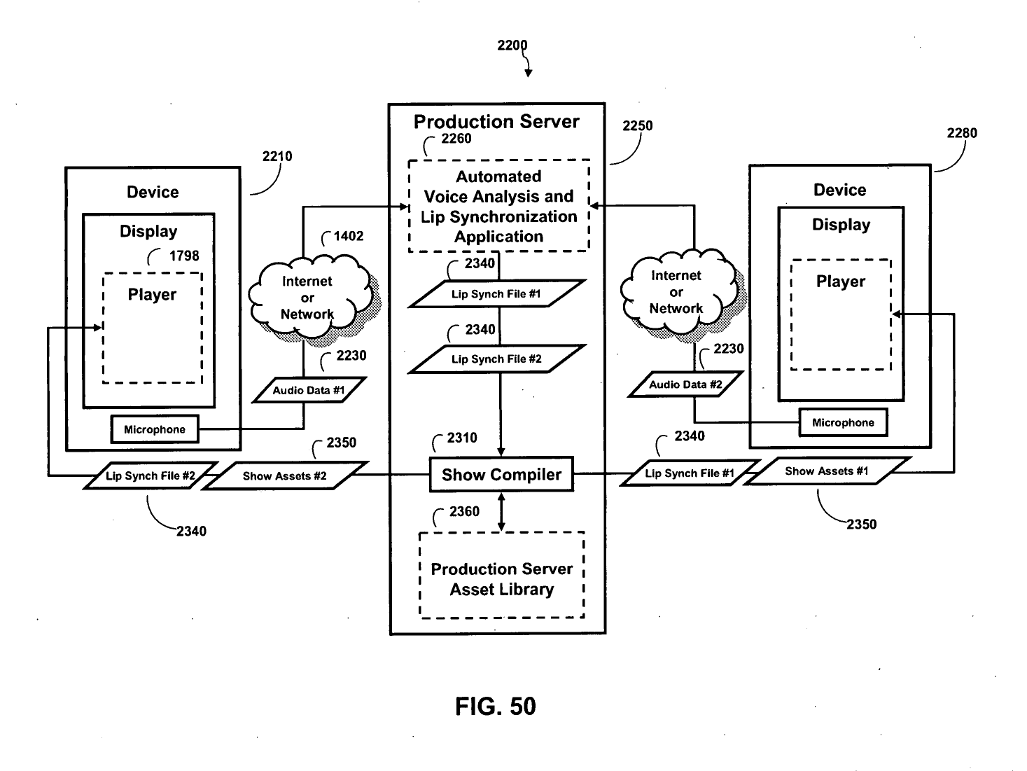

FIG. 50 is a schematic representation of a photo realistic talking head phone (2200). The audio (2230) from both the caller and receiver is analyzed by a vocal analysis and lip synchronization application (2260) residing on a production server (2200) that is part of the telecommunications network. The show is compiled (2310) an the output of the speech-to-text analysis (2340) is sent via the data channel along with the show assets (2350) and is then used for lip synchronization of the caller and receiver's photo-realistic talking head's in the respective players.

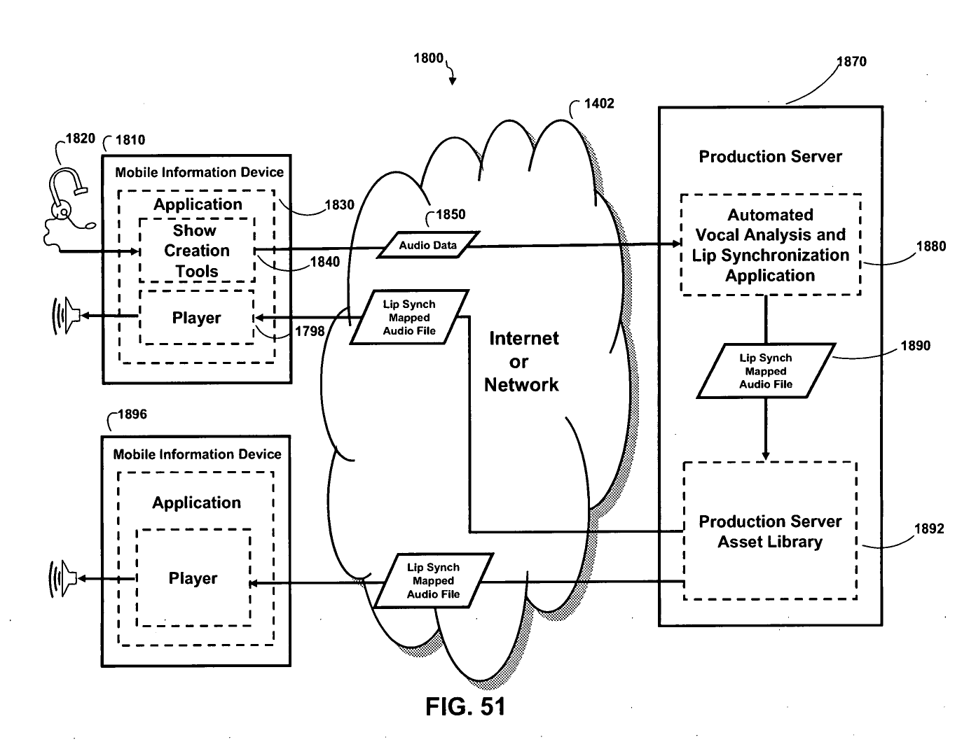

FIG. 51 is a schematic representation of an embedded lip synchronization system and method on a mobile information device (1800). A user uses a microphone (1810) to record their voice with the show creation tools (1830). The audio data (1850) is sent via the telecommunications network (1860) to the vocal analysis and lip synchronization application (1880) on the production server (1870). The audio data is analyzed with speech recognition software and the extracted phoneme/duration information is merged into the metadata section of the audio file to create a file format containing the phoneme/duration data, phoneme-to-viseme mapping tables and audio data in one multi lip synch mapped audio file (1885). The multi lip synch mapped audio file is stored in the production server asset library (1890) before being sent back to the user's web browser to drive lip synchronization for shows viewed on the player (1894).

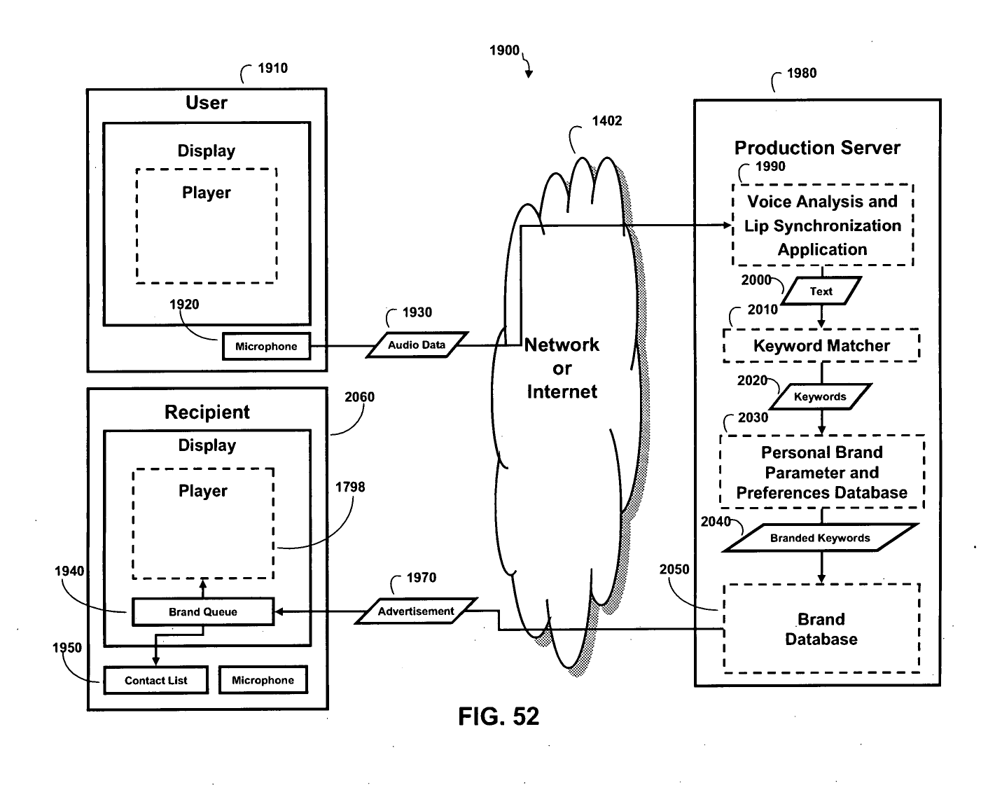

FIG. 52 is a schematic representation of a speech-driven personalized brand placement system (1900). A caller uses their device (1910) to set a series of personal brand parameters and receivers preferences in the database (2030) on the production server (1980) which indicate general purchasing preferences in various brand categories. When a user makes a voice call, their voice is analyzed by a vocal analysis and lip synchronization application (1990) residing on a production server that is part of the telecommunications network or host company. The output of the speech-to-text analysis (2000) is compared to a list of keywords (2020) that are associated with advertisements in a brand database (2050) on the server. Words that do not match an entry in the keyword list are removed, leaving a list of branded keywords (2040). The sender's personal brand parameters are then used with the keyword to select a particular brand (1970) to send to the recipient's device (2060). The title or tag line of the brand is displayed in the brand queue (1940) window below the photo-realistic talking head player (1960). The list of brands is then saved in the contact list (1950) and is associated with the sender's profile. At any time the receiver of the call can click on the advertisement queue to view the list of brands and select one to show in the player.

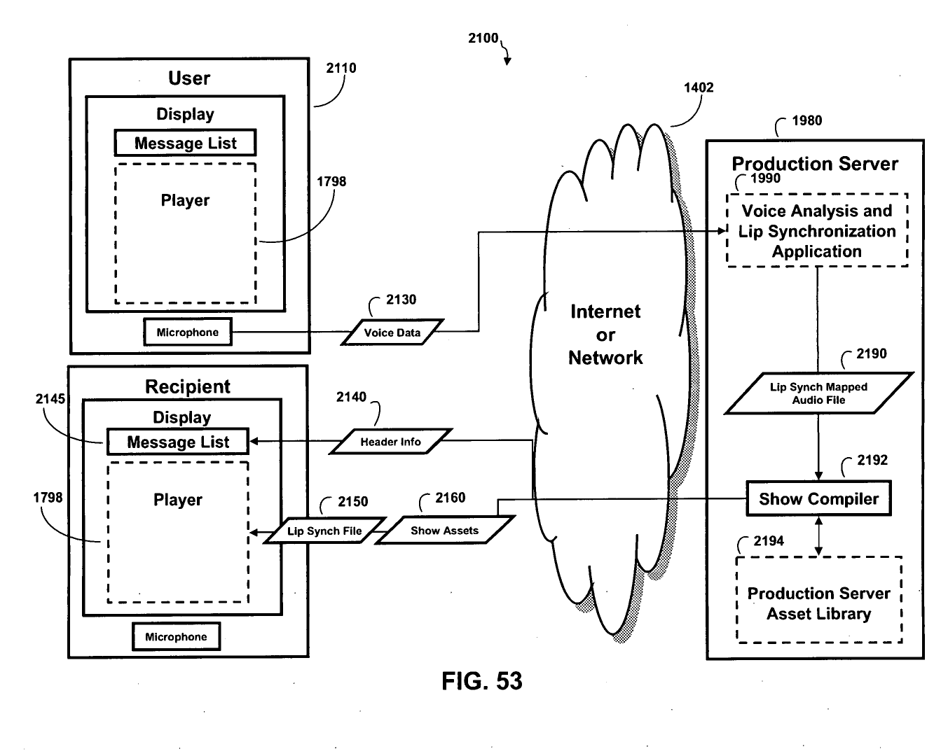

FIG. 53 is a schematic representation of a photo realistic talking head voicemail (2100). A user using a device records a message on the recipient's voicemail. The message is analyzed by a vocal analysis and lip synchronization application (1990) residing on a production server (1980) that is part of the telecommunications or internal or other type of network or Internet. The output of the speech-to-text analysis is added to the metadata of the audio file and is then used for lip synchronization of the sender's photo-realistic talking head. When the recipient clicks on the message in the voice message list (2145), the player (2120) plays the recorded voice message and the photo-realistic talking head of the caller is animated and lip synchs to the message.

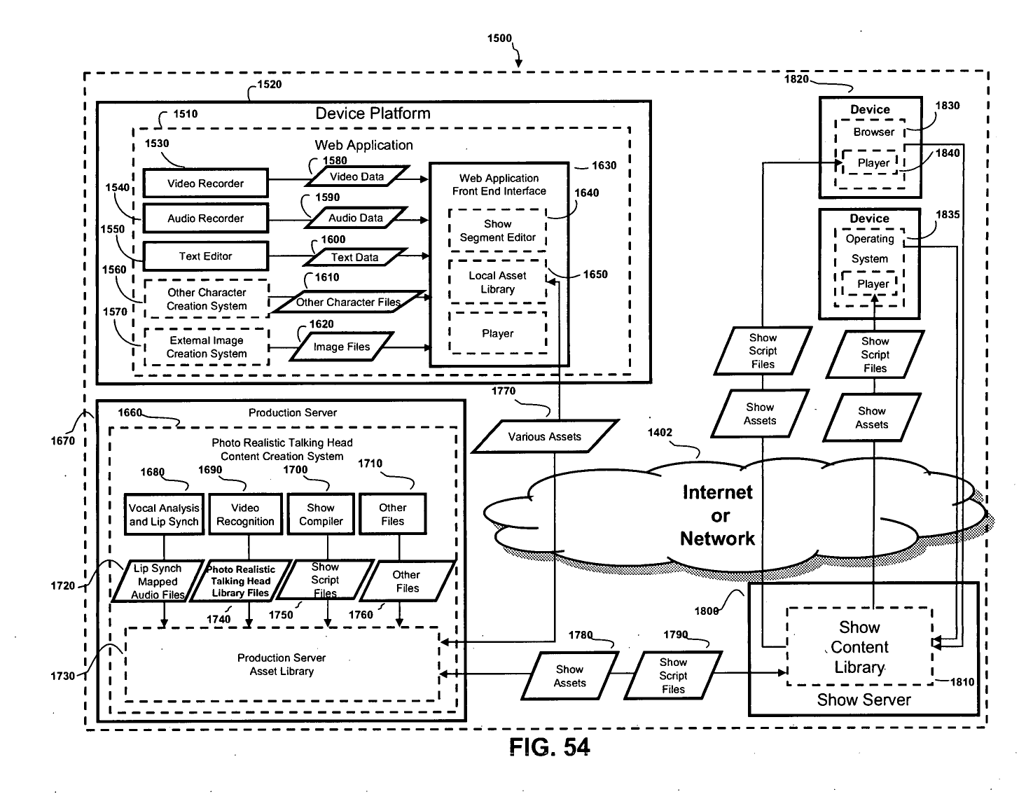

FIG. 54 is a device platform and remote server system, alternatively referred to as a photo realistic talking head web application (1500). The web content producer launches the internet browser-based web application (1510) on the web content producer's computer (1520) which guides the web content producer through the content creation process. The web content producer uses a video recorder (1530) to record themselves visible on screen from the shoulders up speaking the words “army u.f.o's”, blinking, raising their eyebrows, and expressing various emotions, for each of a series of ordered head positions. A library of pre-made guides rendered from 3D human characters is used to assist the web content producer in alignment of their head. The video data is saved and sent via the internet to the production server (1670) where it is analyzed by the video recognition application (1690) of the photo realistic talking head content creation system (1660). Individual video frames representing selected visemes are identified via the phoneme and timing data from the video recognition application, extracted from the video file, aligned with one another using a pixel data comparison algorithm, and cropped to include only the portion that represents the extremes of motion for that position, such as the mouth, eyes or head. The resulting photo realistic talking head library files (1740) are saved in the production server asset library (1730). The web content producer records his/her voice message via the audio recorder (1540). Audio data (1590) from the audio recorder is saved and sent via the internet to the production server where it is analyzed by the vocal analysis and lip synchronization application (1680) using a speech recognition engine. The resulting phoneme timing along with the appropriate lip form mapping information is copied to the metadata section of the audio file and saved as a lip synch mapped audio file (1720) in the production server asset library. The web content producer can use the text editor (1550) to add text or title graphics to the show. The text editor output is text data (1600) that is sent via the internet to the production server where it is saved as a text file in the production server asset library. Production server assets can be, but are not limited to, text files, audio files, lip synch mapped audio files, photo realistic talking head files generated by the photo realistic talking head creation system, other original or licensed character files (1610) generated by other character creation systems (1650), External image creation systems (1570), which are used to create image files (1620) such as background images, movies, sets, or other environments designed to frame the photo-realistic talking head or other character used during a show. These production server assets are the raw materials for creating shows and can be accessed at various points in the show creation procedure and are incorporated into the show by the show compiler (1700). The segment editor (1640) is used to designate and animate the assets that are used in a show script (1790). Various assets (1770) are imported into the local asset library (1650) and animated along a timeline using scripted object behaviors and series of commands to define the scene and animation. This show information is sent from the show segment editor to the show compiler that then creates the show script, encrypts it, and incorporates the show into the web content producer's web page. Completed shows are stored in the show content library (1810) on the show server (1800). The show scripts can then be accessed over the internet by other users' devices (1820) and viewed with the player (1840) via a web browser (1830) or embedded into the operating system (1835).

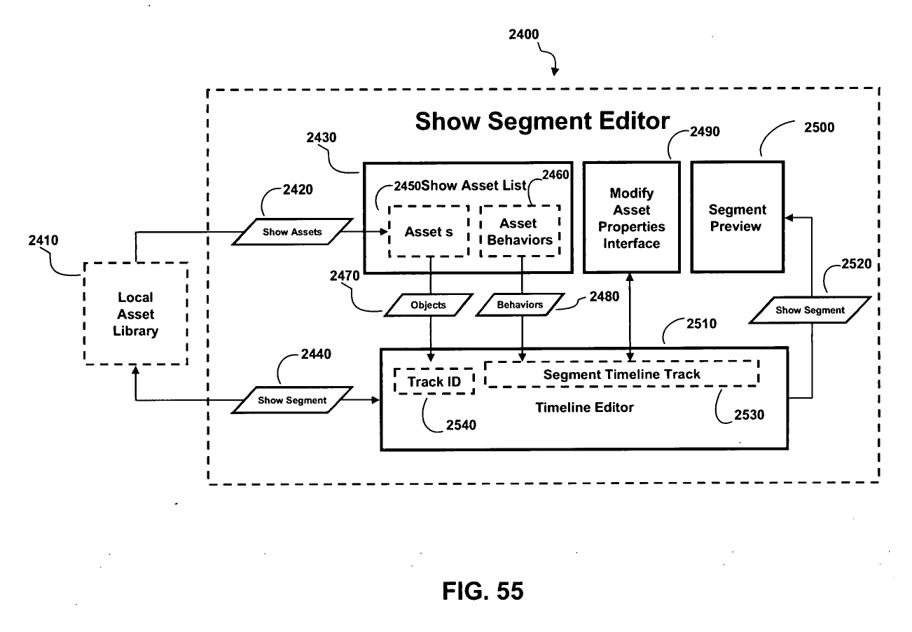

FIG. 55 is a schematic representation of a show segment editor application (2400). Show assets (2420) such as photo-realistic talking head libraries, vocal audio files, background images, and props are imported into the show asset list (2430). The individual show assets (2450) are dragged onto the track ID portion of the timeline editor (2510). Show asset behaviors (2460) are pre-defined, reusable sequences of animation such as head motions, eye motions, arm motions, body motions, or other combinations of such motions, and are placed along the timeline in a chronological sequence to define the show animation. The modify show asset properties interface (2490) Provides methods for adjusting a show asset's parameters such as position, stacking order, and previewing the particular behavior or voice file. The show is exported and saved as a show segment (2440) in the local asset library (2410).

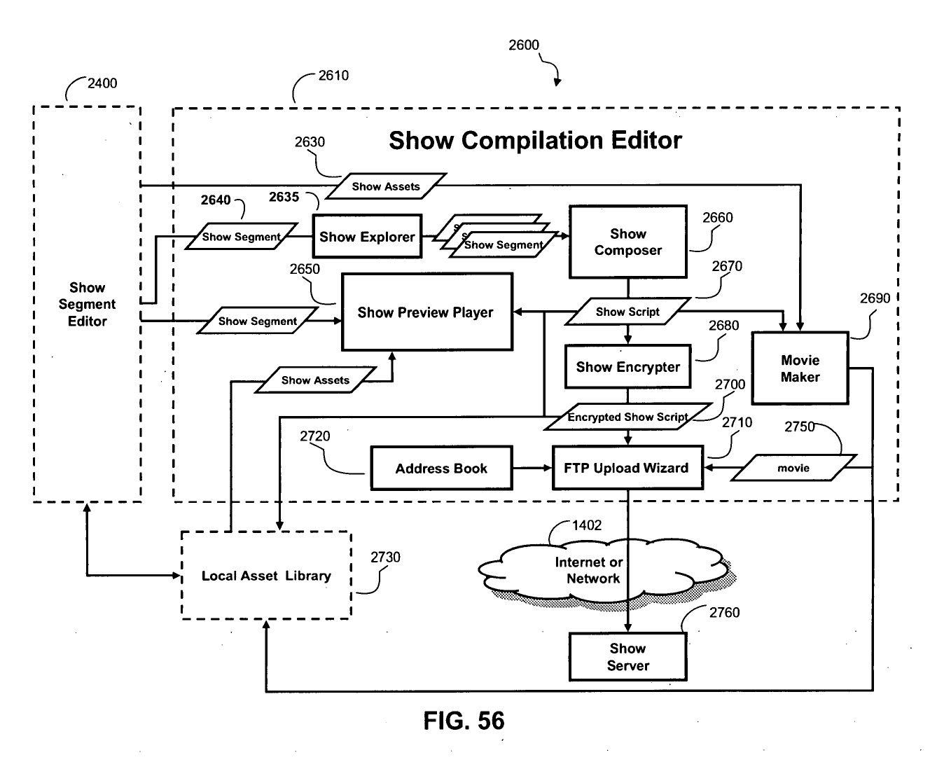

FIG. 56 is a schematic representation of a show compilation editor application (2600). From within the show compilation editor (2610), the show explorer (2635) is used to drag-and-drop show segments (2640) into the show composer (2660) to create longer, complete show scripts (2670). The shows can be previewed in the preview player (2650). Once the producer is satisfied with the content of the show, the completed show scripts can be encrypted with the show encrypter (2680) to make them viewable only with the player, and/or they can be imported into the movie maker (2690) and used to create movies (2750) for viewing with standard digital media players. The shows are saved in the local asset library (2730) and uploaded over the internet (2740) with the ftp upload wizard (2710) to remote web servers. An address book (2720) stores the URL, login and password information for available show servers (2760).

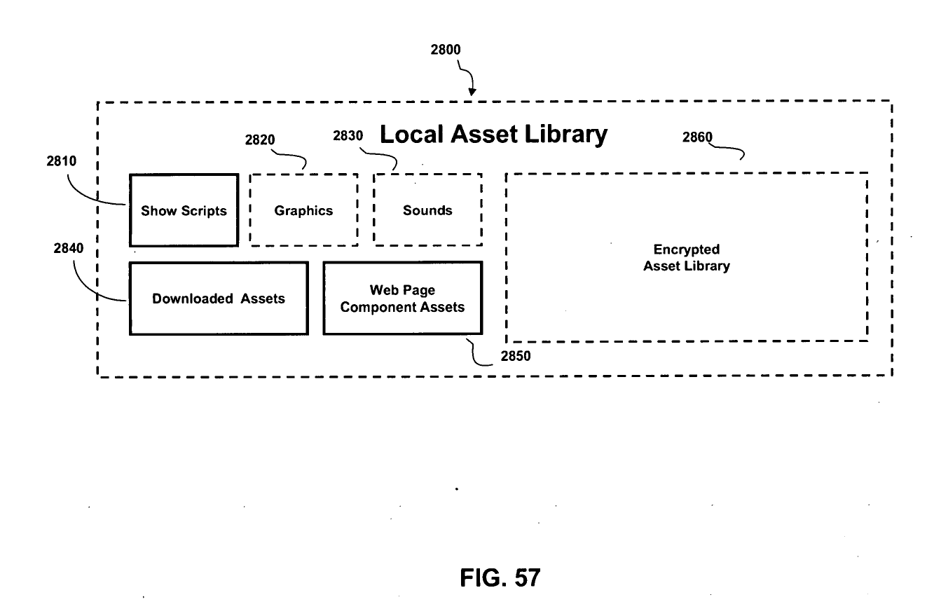

FIG. 57 is a schematic representation of a directory structure of a local asset library (2800). The local asset library comprises folders containing show scripts (2810), graphics (2820), sounds (2830), downloaded assets (2840), and web page component assets (2850), such as icons, button images, and web page background images. The entire contents of the local asset library is also stored in encrypted form in the encrypted asset library (2860) within the local asset library.

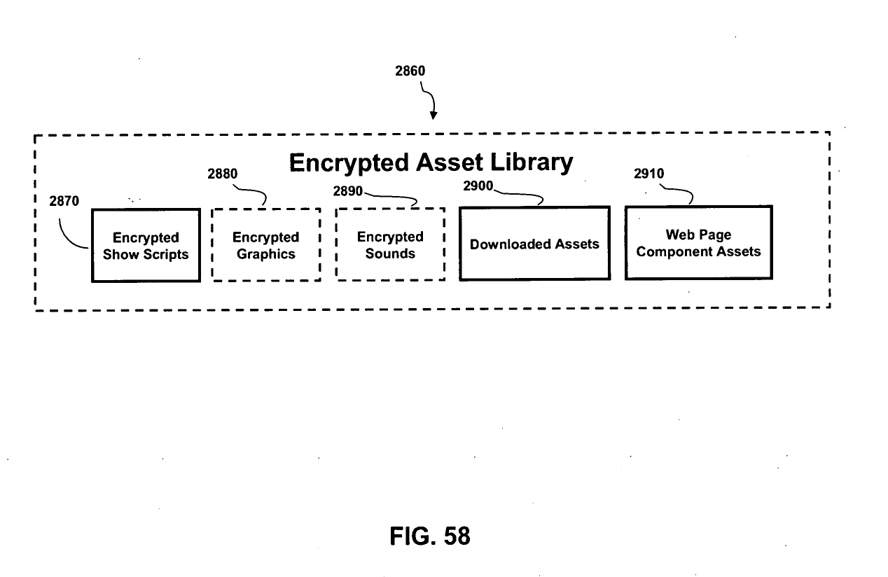

FIG. 58 is a schematic representation of a directory structure of an encrypted asset library (2860). The encrypted asset library comprises folders containing encrypted show scripts (2870), encrypted graphics (2880), encrypted sounds (2890) encrypted downloaded assets (2900), and web page component assets (2910).

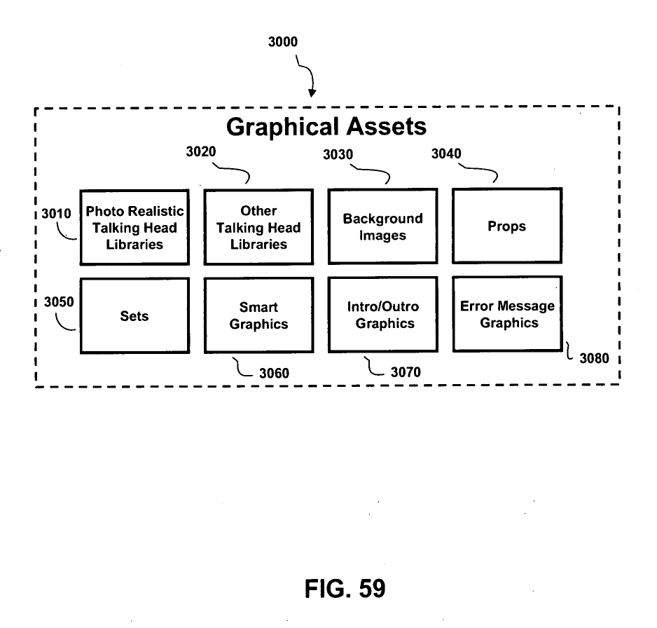

FIG. 59 is a schematic representation of a directory structure of a graphics assets portion of the local asset library (3000). The graphical assets library comprises folders containing photo realistic talking head libraries (3010), other talking head libraries (3020), background images (3030), props (3040), sets (3050), smart graphics (3060), intro/outro graphics (3070), and error message graphics (3080).

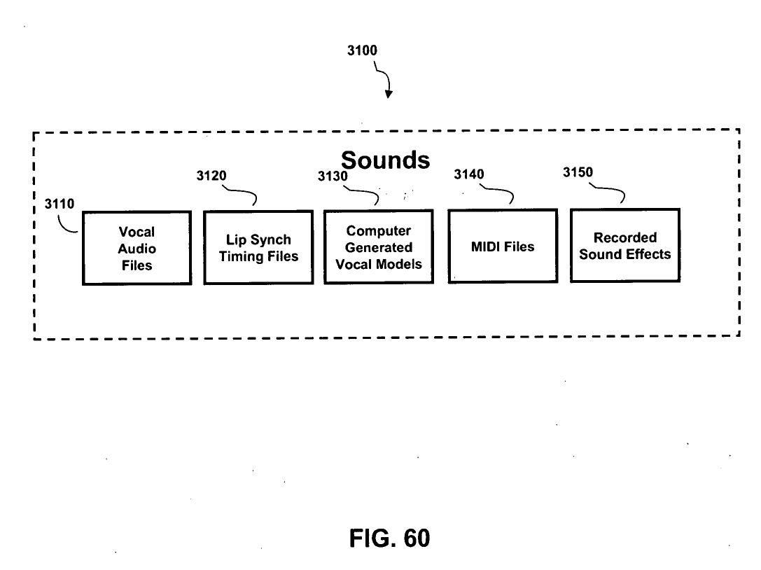

FIG. 60 is a schematic representation of a directory structure of a sound library portion of the local asset library (3100). The sound library comprises folders containing vocal audio files (3110), lip synch timing files (3120), computer generated vocal models (3130), MIDI files (3140), and recorded sound effects (3150).

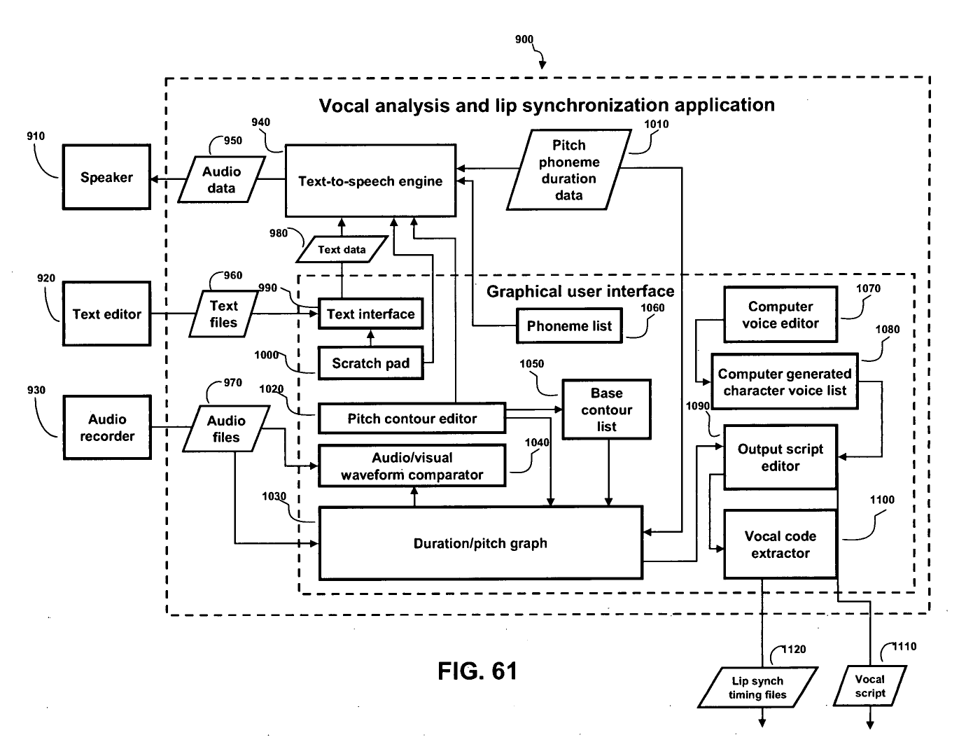

FIG. 61 is a schematic representation of a vocal analysis and lip synchronization application (900). A producer can use any suitable audio recording application (930) to record their vocals and save it as an audio file (970), and enter the corresponding words into any suitable text editor (920) and then save them as a text file (960). Text is imported into the text interface (990) from existing saved text files, or from newly typed text in the scratch pad (1000). The text data is then sent to the text-to-speech engine (940) where it is analyzed for pitch, phoneme, and duration data (1010). The pitch, phoneme, and duration values are sent to the duration/pitch graph interface (1030). The corresponding vocal audio file (970) is imported into the duration/pitch graph interface as well. The pitch/phoneme/duration values are represented as a string of movable nodes along a timeline. Vertical values represent changes in pitch, and horizontal values represent changes the duration interval between phonemes. The accuracy of the synchronization of the phonemes to the vocal file can be tested by listening to both the computer generated voice created from the pitch/phoneme/duration data and the human voice vocal file at the same time. A visual comparison of the two files can be made in the audio/visual waveform comparator (1040). Once the producer is satisfied with synchronization between the computer vocals and the human vocals, the pitch and duration values are sent to the output script editor (1090) where each individual phrase worked on is appended together to form a complete vocal script (1100). The vocal script is then broken back down into individual phrases, given a name based on the words in the phrase and sequentially numbered. The computer voice editor (1070) can be used to create new unique sounding computer generated character voices by adjusting many various parameters that control vocal qualities, such as sex, head size, breathiness, word speed, intonation, etc. The newly created computer generated character voices can be added to the existing computer character voice list (1080). The pitch contour editor (1020) can be used to create custom pitch sequences for adding expression and inflection to computer generated character voice dialog. These custom pitch contours, or base contours can be saved in the base contour list (1050) for reuse. The phoneme list (1060) contains samples of each available phoneme and a representative usage in a word that can be listened to as a reference.

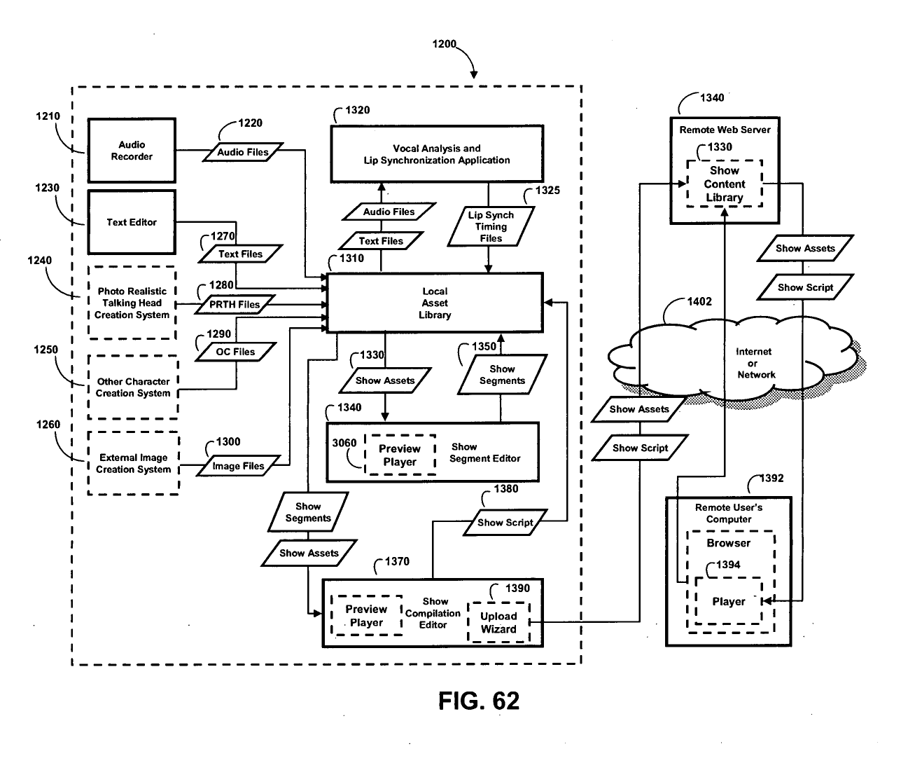

FIG. 62 is a schematic representation of a local computer (Full Version) system, alternatively referred to as a photo realistic talking head content production system (1200). The producer, which is the user who is using the tools to create content, records his or her voice message via the audio recorder (1210). An audio file (1220) from the audio recorder is saved and imported into the local asset library (1310), which is the storage repository that is on a producer or end user's computer that contains all the files that are called upon in a script by the player and used to create a show. The producer's message script that contains the sequence of words that are uttered when creating a voice message is entered into the text editor (1230). The text editor output is a text file (1270) that is saved in the local asset library. From within the vocal analysis and lip synchronization application (1320), the message script text file is imported and then analyzed with a text-to-speech engine to convert the text to phonemes and their associated duration values corresponding to the written words. The phoneme timing information is then manually or automatically synchronized to the producer's original recorded voice file and saved as a lip synch timing file (1325) in the local asset library. The local asset library contains files resident on the producer's computer that can be accessed at various points in the show creation procedure. Local assets can be, but are not limited to text files, audio files, lip synch timing files, Photo Realistic Talking Head files (1280) generated by the Photo Realistic Talking Head creation system (1240) from current patents (basis for continuation in part), other original or licensed character files (1290) generated by other character creation systems (1250), externally created image assets (1300), such as background images, movies, sets, or other environments designed to frame the photo-realistic talking head or other character used during a show. These show assets (1330) are the raw materials for creating shows. The show segment editor (1340) is used to create show segments (1350). Asset files are imported into the segment editor from the local asset library and animated using scripted object behaviors and series of commands to define the scene and animation. The show compilation editor (1370) is an application used to assemble show segments, such as reusable intros, outros, and newly created unique segments, into longer, complete show scripts (1380). Completed shows are stored in the local asset library and can be viewed with the preview player (1360) which is a version of the player that can read scripts and display shows that have not been encrypted yet and is built into the segment editor and the show compilation editor on the producer's computer. The segment editor is also able to encrypt show scripts so they can only be viewed on a remote user's computer (1392) with a player (1394), which is a player that can only read shows that have been encrypted by the show compilation editor. A producer can use an upload wizard (1390), which is a tool for manually or automatically uploading the show scripts and show assets via the internet (1320) to the show content library (1330) on a designated remote web server (1340) upon command.

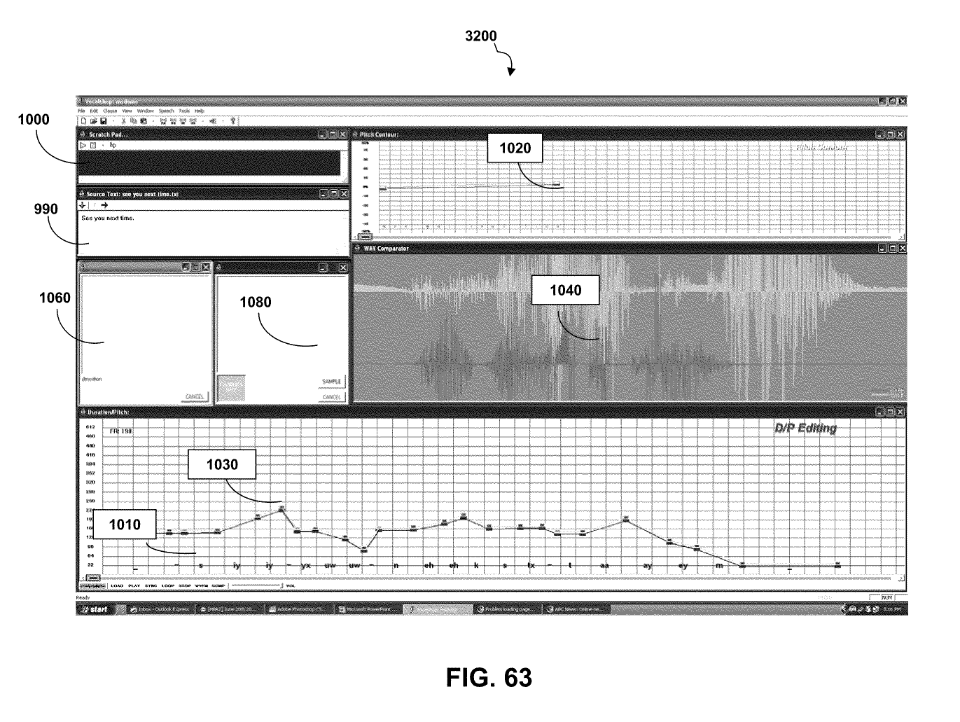

FIG. 63 is a schematic representation of a vocal analysis and lip synchronization application's graphical user interface (3200). The graphical user interface may be used in conjunction with the source text editor (990), scratch pad (1000), phoneme sequence (1010) pitch contour editor (1020), duration/pitch editor (1030), audio/visual waveform comparator (1040), computer generated character voice list (1080), and phoneme sample list (1060).

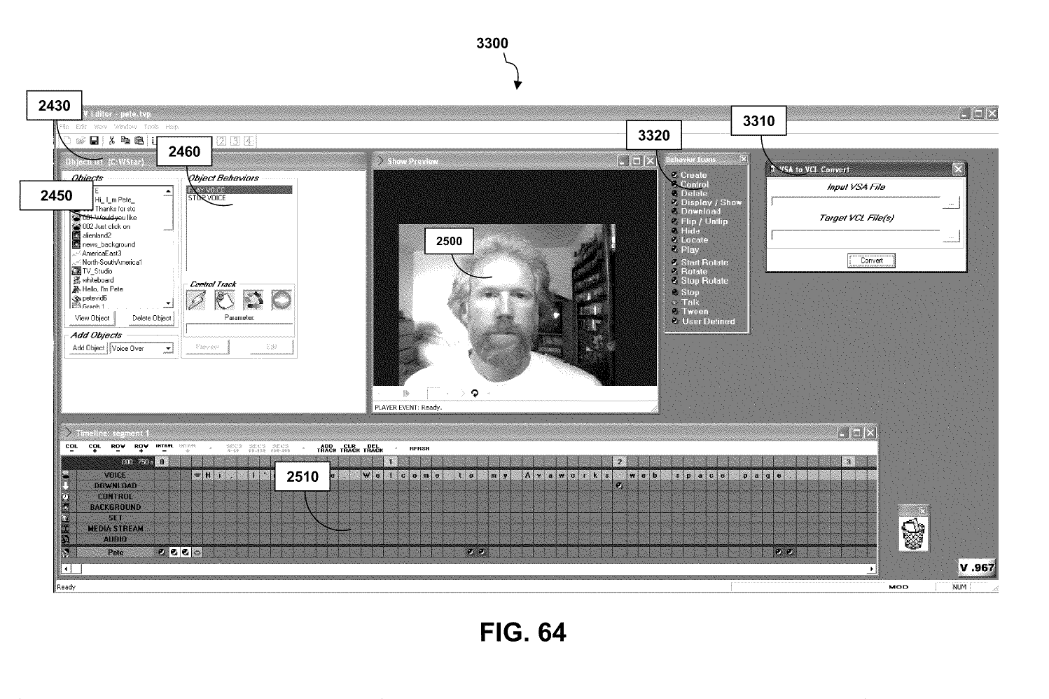

FIG. 64 is a schematic representation of a production segment editor application's graphical user interface (3300). The graphical user interface may be used in conjunction with the show asset list (2430), show assets (2450), asset behaviors (2460), preview player (2500), timeline editor (2510), vocal timing file converter (3310), and behavior icon list (3320).

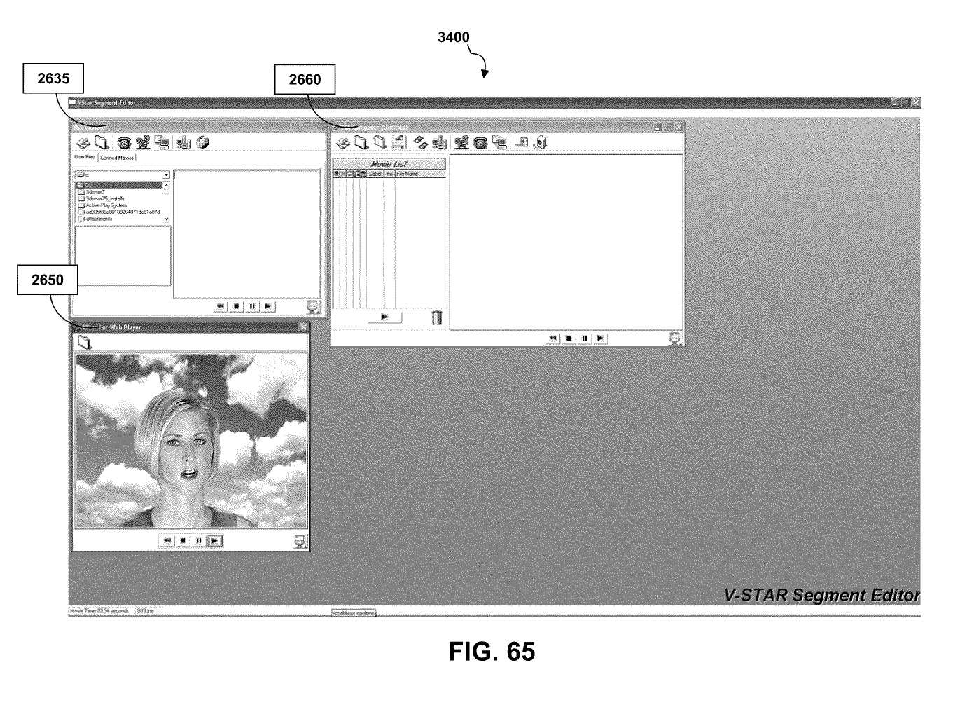

FIG. 65 is a schematic representation of a show compilation editor application's graphical user interface (3400). The graphical user interface may be used in conjunction with the show preview player (2650), show composer (2660), show explorer, and address book.

B. Incorporation of Branding into Photo-Talking Head Content

FIGS. 37, 39, 43, 46-48, 50, 52, 54, and 62 show various aspects of incorporation of branding into photo-realistic head content, and have been previously discussed.

### IV. Distributing Photo-Talking Head Content

FIGS. 37, 43, 44, 47-54, 56, and 62 show various aspects of distributing photo-realistic head content, and have been previously discussed.

### V. Viewing Photo-Talking Head Content

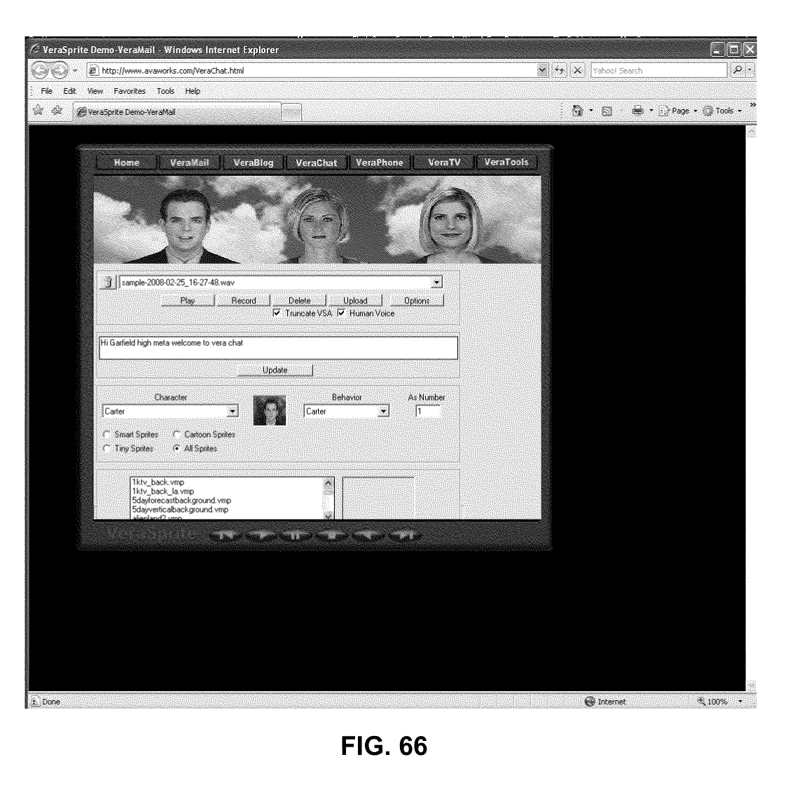

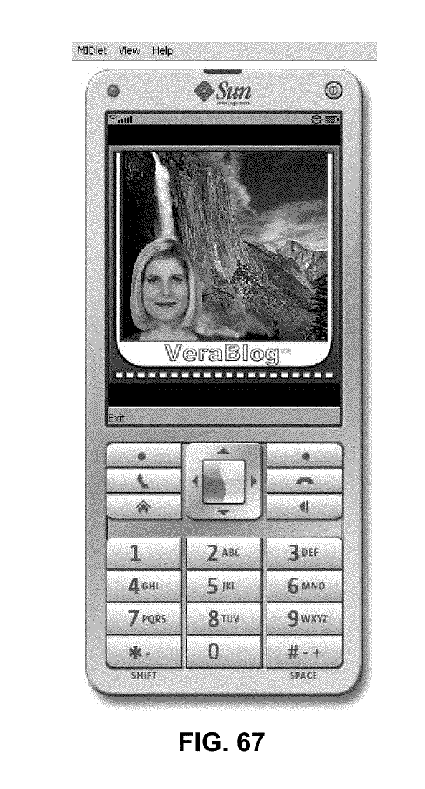

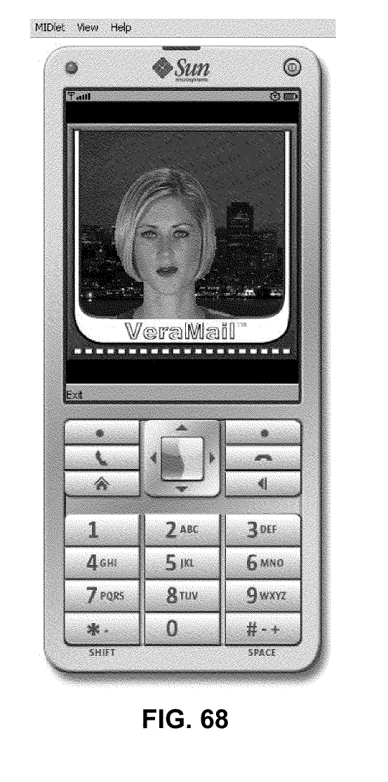

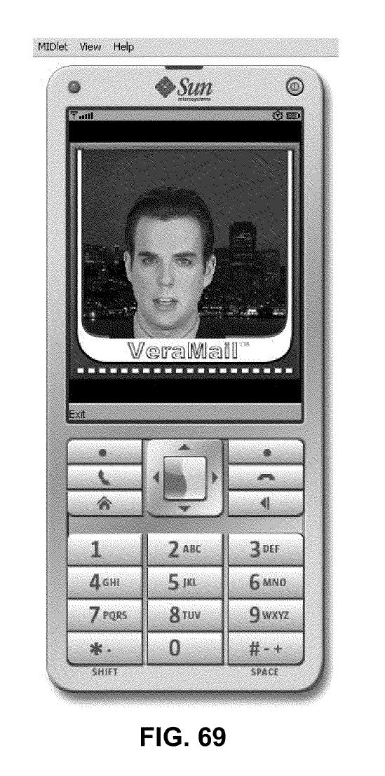

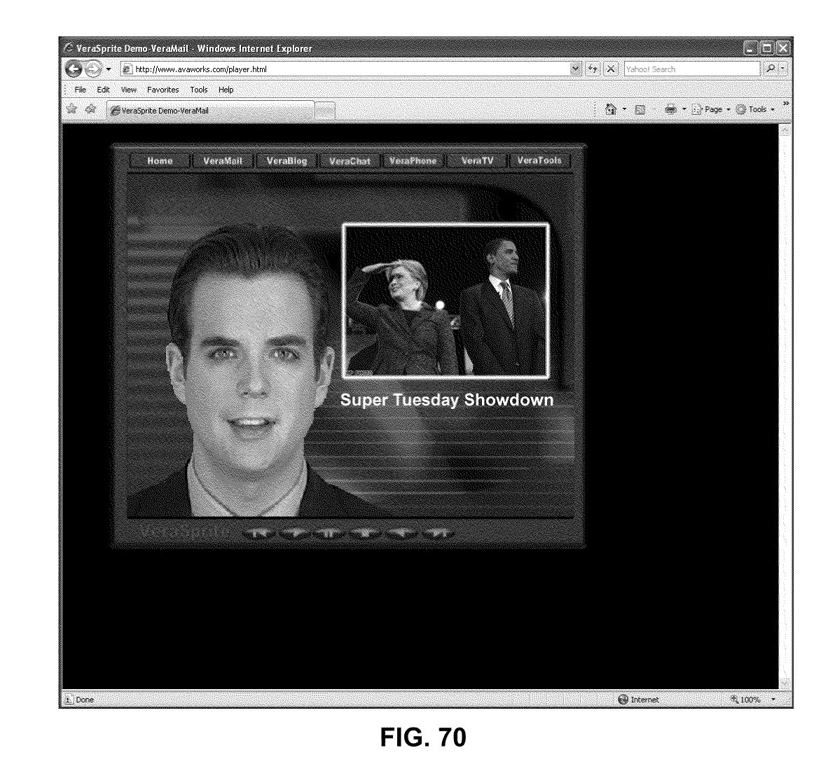

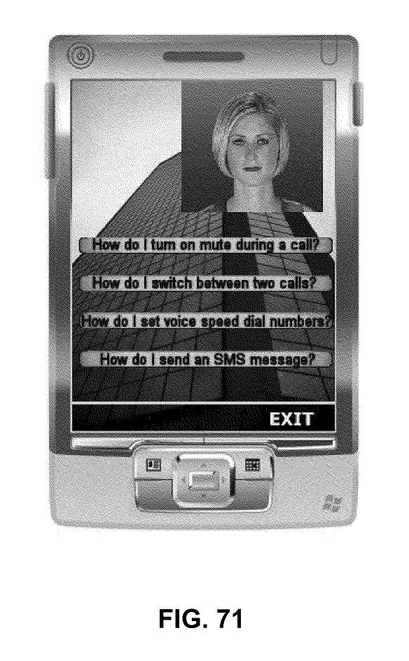

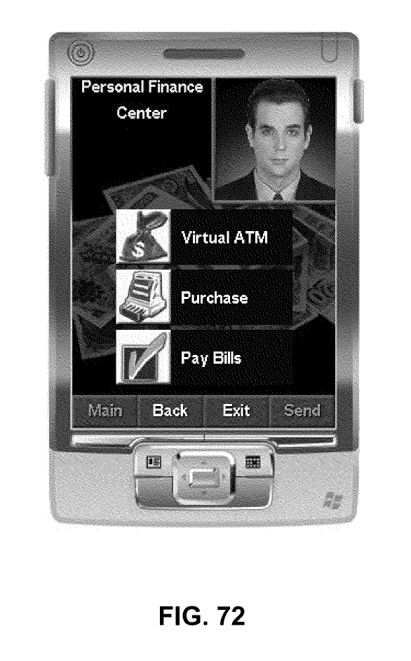

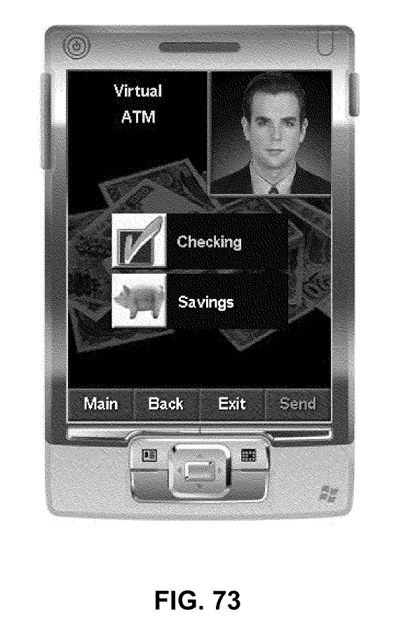

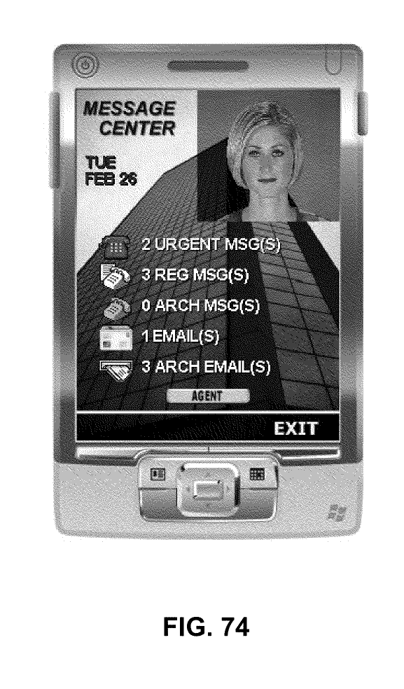

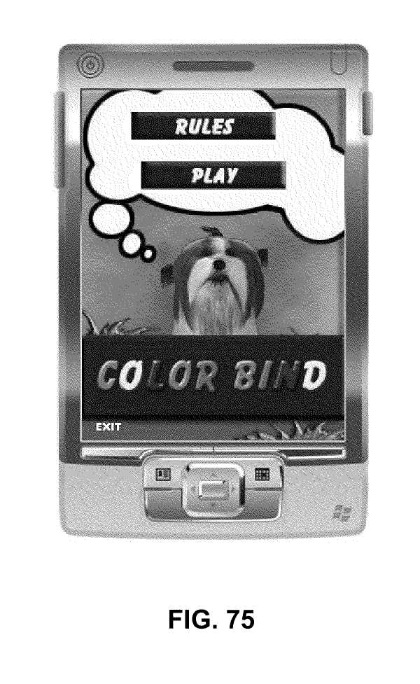

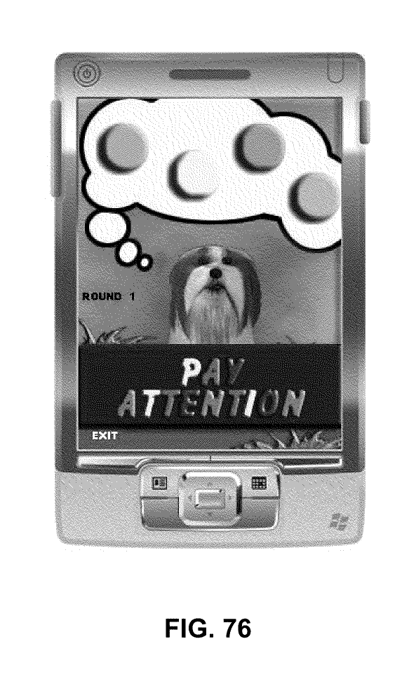

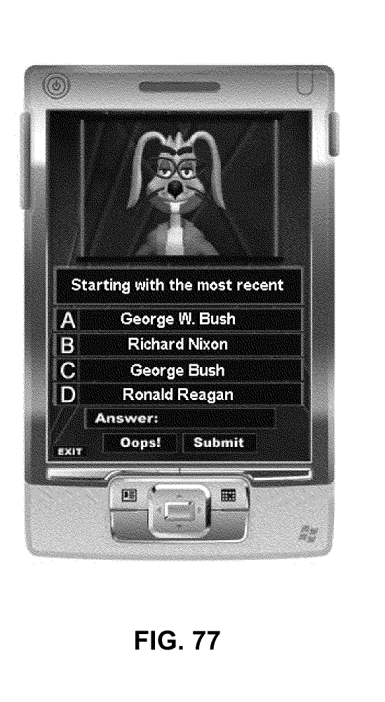

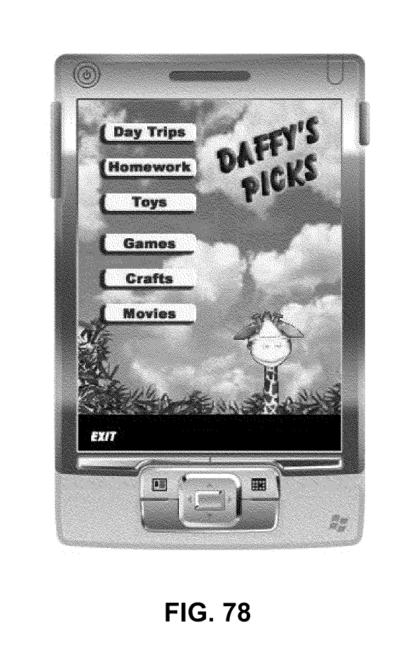

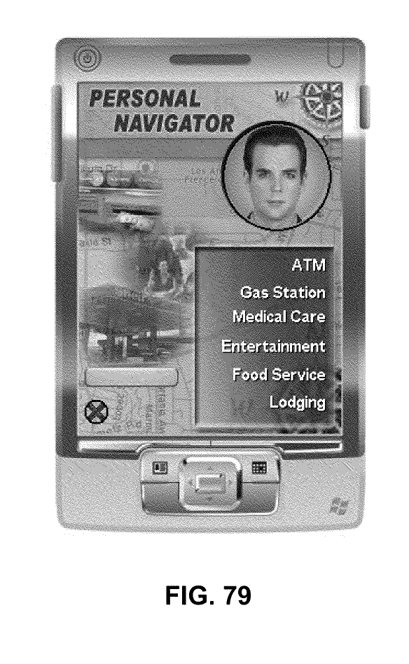

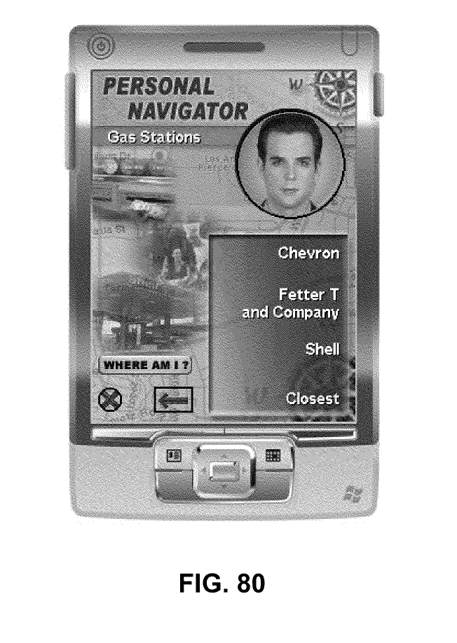

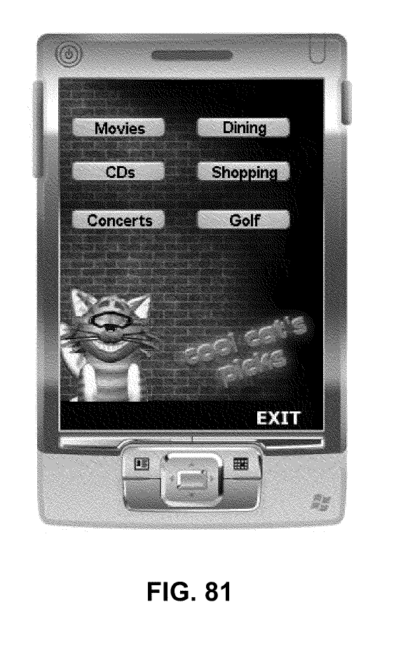

FIGS. 47-54, 62, 66, and 82 show various aspects of viewing photo-realistic head content, and have been previously discussed.

### VI. Additional Detail

A method of the photo realistic talking head creation, content creation, and distribution system and method may then be considered to be at least in part:
A process executing on a hardware device comprising a photo realistic talking head system for creating a photo realistic talking head library, creating photo realistic talking head content, inserting branding into the content, and distributing the content comprising the branding on a distributed network from at least one communications device to at least one other communications device, the photo realistic talking head system comprising a photo realistic talking head library creation apparatus, a photo realistic talking head library creation server device, a photo realistic talking head content creation apparatus, a photo realistic talking head content creation server device, a brand association server device, and a content distribution server device, comprising the steps of:
   (a) creating, at the photo realistic talking head library creation apparatus, the library of photo realistic talking heads;
   (b) storing, at the photo realistic talking head library creation server device, the library of photo realistic talking heads;
   (c) creating, at the photo realistic talking head content creation apparatus, the photo realistic talking head content;
   (d) storing, at the photo realistic talking head content creation server device, the photo realistic talking head content;
   (e) creating, at the photo realistic talking head content creation apparatus, at least one profile;
   (f) associating, at the brand association server device, the at least one profile with the photo realistic talking head content one with the other;
   (g) storing, at the brand association server device, the at least one profile and information identifying the association between the at least one profile and the photo realistic talking head content;
   (h) receiving, at the photo realistic talking head system, at least one instruction from the at least one communications device to communicate the stored photo realistic talking head content to the at least one other communications device;
   (i) retrieving, at the photo realistic talking head content creation server device, the photo realistic talking head content;
   (j) retrieving, at the brand association server device, the information identifying the association between the at least one profile and the photo realistic talking head content and retrieving the at least one profile;
   (k) retrieving, at the brand association server device, at least one stored brand associated with the at least one profile;
   (l) incorporating, at the photo realistic talking head content creation server device, the at least one stored brand associated with the at least one profile and the photo realistic talking head content into the photo realistic talking head content;
   (m) communicating, from the photo realistic talking head content distribution server device, the photo realistic talking head content comprising the at least one stored brand associated with the at least one profile and the photo realistic talking head content to the at least one other communications device.
The at least one profile may comprise at least one profile associated with at least one user of the at least one communications device and/or the at least one profile comprises at least one profile associated with at least one user of the at least one other communications device.
The at least one profile may then comprise at least one first profile associated with at least one user of the at least one communications device and at least one second profile associated with at least one other user of the at least one other communications device.
The at least one stored brand associated with the at least one profile and the photo realistic talking head content may comprise at least one advertisement associated with the at least one profile.
The at least one stored brand associated with the at least one profile and the photo realistic talking head content may comprise at least one advertisement associated with the at least one first profile and the at least one second profile.
The brand association server device may comprise at least one database comprising the at least one stored brand associated with the at least one profile.
The step of (a) creating, at the photo realistic talking head library creation apparatus, the library of photo realistic talking heads comprises at least the following steps:
   selecting, by a controller, an alignment template from a library of alignment templates,
      the photo realistic talking head library creation apparatus comprising the controller,
      each of the alignment templates being different one from the other and representational of an alignment template frame of a photo realistic human talking head having an alignment template head angular position, comprising a template head tilt, a template head nod, and a template head swivel component,
      each of the alignment template frames different one form the other,
      each of the alignment templates head angular positions different one from the other;
   collecting an image of a human subject with a video camera,
      a handheld device comprising the video camera,
      the photo realistic talking head library creation apparatus comprising the handheld device comprising the video camera;
   communicating, by the handheld device, the collected image of the human subject to a mixer,
      the photo realistic talking head library creation apparatus comprising the mixer;
   mixing, by the mixer, the collected image of the human subject with an image of the selected alignment template in the mixer, thus, creating a composite image of the human subject and the selected alignment template;
   communicating, from the mixer, the composite image to the handheld device comprising a display for display to the human subject, the display adapted to facilitate the human subject aligning an image of a head of the human subject with the image of the selected alignment template;
   substantially aligning the head of the human subject, having a human subject head angular position, comprising a human subject head tilt, a human subject head nod, and a human subject head swivel component, with the image of the selected alignment template head at substantially the same angular position as the selected alignment template head angular position;
   collecting, by the handheld device, an image of the substantially aligned human subject;
   communicating, by the handheld device, the image of the substantially aligned human subject to the photo realistic talking head library creation server device;
   wherein the step (b) of storing, at the photo realistic talking head library creation server device, the library of photo realistic talking heads comprises storing, by the photo realistic talking head library creation server device, the image of the substantially aligned human subject in a library of collected images,
      each of the collected images having a different human subject angular position, which is substantially the same as a the selected alignment template head angular position,
      each of the stored images representing a different frame of a photo realistic human talking head.
The photo realistic talking head content is from the group consisting of: photo realistic talking head content, a photo realistic talking head synchronized to a spoken voice of a human subject, a photo realistic talking head, at least one portion of a photo realistic talking head, a photo realistic talking head depicting animated behavior of a human subject, at least one frame of an image of a human subject, at least one portion of at least one frame of an image of a human subject, a plurality of frames of images of a human subject, a plurality of portions of at least one frame of an image of a human subject, a plurality of portions of a plurality of frames of a plurality of images of a human subject, a plurality of frames of a plurality of images of a human subject representing an animated photo realistic talking head, a plurality of frames of a photo realistic talking head library representing an animated photo realistic talking head, text, at least one image, a plurality of images, at least one background image, a plurality of background images, at least one video, a plurality of videos, audio, music, multimedia content, and any combination of one or more thereof.
The photo realistic talking head library comprises a plurality of stored images, each stored image of the plurality of stored images representing a different frame of an image of a human subject of the library of photo realistic talking heads, the step of (a) creating, at the photo realistic talking head library creation apparatus, the library of photo realistic talking heads further comprises:
   associating the each stored image of the plurality of stored images representing the different frame of the image of the human subject of the library of photo realistic talking heads with a different phoneme of a plurality of different phonemes;
the step of (b) storing, at the photo realistic talking head library creation server device, the library of photo realistic talking heads further comprises:
   storing, at the photo realistic talking head library creation server device, information identifying the association of the each associated stored image of the plurality of stored images representing the different frame of the image of the human subject of the library of photo realistic talking heads associated with the different phoneme of the plurality of different phonemes and storing the different phoneme of the plurality of different phonemes.
The storing, at the photo realistic talking head library creation server device, information identifying the association of the each associated stored image of the plurality of stored images representing the different frame of the image of the human subject of the library of photo realistic talking heads associated with the different phoneme of the plurality of different phonemes comprises:
   storing the information identifying the association of the each associated stored image of the plurality of stored images representing the different frame of the image of the human subject of the library of photo realistic talking heads associated with the different phoneme of the plurality of different phonemes in at least one database.
Following from immediately above, the step of (c) creating, at the photo realistic talking head content creation apparatus, the photo realistic talking head content comprises at least the following steps:
   receiving, at the photo realistic talking head content creation apparatus, at least one phoneme representational of a voice of a human subject;
   determining, at the photo realistic talking head content creation apparatus, at least one closest matching phoneme of the plurality of different phonemes stored at the photo realistic talking head content creation apparatus that substantially matches the at least one phoneme representational of the voice of the human subject;
   retrieving, at the photo realistic talking head content creation apparatus, the information identifying the association between the at least one phoneme corresponding to the at least one closest matching phoneme and the each associated stored image of the plurality of stored images representing the different frame of the image of the human subject of the library of photo realistic talking heads;
   incorporating, at the photo realistic talking head content creation apparatus, the different frame of the image of the human subject of the library of photo realistic talking heads corresponding to the at least one phoneme corresponding to the at least one closest matching phoneme into the photo realistic talking head content.
The step of (c) creating, at the photo realistic talking head content creation apparatus, the photo realistic talking head content may comprise at least the following steps:
   receiving, at the photo realistic talking head content creation apparatus, at least two phonemes representational of a voice of a human subject;
   determining, at the photo realistic talking head content creation apparatus, at least two closest matching phonemes of the plurality of different phonemes stored at the photo realistic talking head content creation apparatus that substantially match the at least two phonemes representational of the voice of the human subject;
   retrieving, at the photo realistic talking head content creation apparatus, information identifying the association between the at least two phonemes corresponding to the at least two closest matching phonemes and at least two associated stored images of the plurality of stored images representing different frames of the image of the human subject of the library of photo realistic talking heads;
   incorporating, at the photo realistic talking head content creation apparatus, the different frames of the image of the human subject of the library of photo realistic talking heads corresponding to the at least two phonemes corresponding to the at least two closest matching phonemes into the photo realistic talking head content.
Following from immediately above, the at least two phonemes may comprise a sequence of a plurality of phonemes.
The photo realistic talking head library comprises a plurality of stored images, each stored image of the plurality of stored images representing a different frame of an image of a human subject of the library of photo realistic talking heads, the step of (a) creating, at the photo realistic talking head library creation apparatus, the library of photo realistic talking heads further comprises:
   associating the each stored image of the plurality of stored images representing the different frame of the image of the human subject of the library of photo realistic talking heads with a different phoneme of a plurality of different phonemes;
the step of (b) storing, at the photo realistic talking head library creation server device, the library of photo realistic talking heads further comprises:
   storing, at the photo realistic talking head library creation server device, information identifying the association of the each associated stored image of the plurality of stored images representing the different frame of the image of the human subject of the library of photo realistic talking heads associated with the different phoneme of the plurality of different phonemes and storing the different phoneme of the plurality of different phonemes.
Following from immediately above, the step of (c) creating, at the photo realistic talking head content creation apparatus, the photo realistic talking head content comprises at least the following steps:
   receiving, at the photo realistic talking head content creation apparatus, at least one phoneme representational of a voice of a human subject;
   determining, at the photo realistic talking head content creation apparatus, at least one closest matching phoneme of the plurality of different phonemes stored at the photo realistic talking head content creation apparatus that substantially matches the at least one phoneme representational of the voice of the human subject;
   retrieving, at the photo realistic talking head content creation apparatus, the information identifying the association between the at least one phoneme corresponding to the at least one closest matching phoneme and the each associated stored image of the plurality of stored images representing the different frame of the image of the human subject of the library of photo realistic talking heads;
   incorporating, at the photo realistic talking head content creation apparatus, the different frame of the image of the human subject of the library of photo realistic talking heads corresponding to the at least one phoneme corresponding to the at least one closest matching phoneme into the photo realistic talking head content.
Again, the at least one profile may comprise at least one profile associated with at least one user of the at least one communications device.
Again, the at least one profile may comprise at least one profile associated with at least one user of the at least one other communications device.
Yet again, the at least one profile comprises at least one first profile associated with at least one user of the at least one communications device and at least one second profile associated with at least one other user of the at least one other communications device.
Yet again, the at least one stored brand associated with the at least one profile and the photo realistic talking head content comprises at least one advertisement associated with the at least one profile.
Following from above, the at least one stored brand associated with the at least one profile and the photo realistic talking head content comprises at least one advertisement associated with the at least one first profile and the at least one second profile.
Following from above, the brand association server device comprises at least one database comprising the at least one stored brand associated with the at least one profile.
Again, the step of (c) creating, at the photo realistic talking head content creation apparatus, the photo realistic talking head content may comprise at least the following steps:
   receiving, at the photo realistic talking head content creation apparatus, at least two phonemes representational of a voice of a human subject;
   determining, at the photo realistic talking head content creation apparatus, at least two closest matching phonemes of the plurality of different phonemes stored at the photo realistic talking head content creation apparatus that substantially match the at least two phonemes representational of the voice of the human subject;
   retrieving, at the photo realistic talking head content creation apparatus, information identifying the association between the at least two phonemes corresponding to the at least two closest matching phonemes and at least two associated stored images of the plurality of stored images representing different frames of the image of the human subject of the library of photo realistic talking heads;
   incorporating, at the photo realistic talking head content creation apparatus, the different frames of the image of the human subject of the library of photo realistic talking heads corresponding to the at least two phonemes corresponding to the at least two closest matching phonemes into the photo realistic talking head content.

Although the present invention has been described in considerable detail with reference to certain preferred versions thereof, other versions are possible. Therefore, the spirit and scope of the appended claims should not be limited to the description of the preferred versions contained herein.

What is claimed is:

1. A process executing on a hardware device comprising a photo realistic talking head system for creating a photo realistic talking head library, creating photo realistic talking head content, inserting branding into the content, and distributing the content comprising the branding on a distributed network from at least one communications device to at least one other communications device, the photo realistic talking head system comprising a photo realistic talking head library creation apparatus, a photo realistic talking head library creation server device, a photo realistic talking head content creation apparatus, a photo realistic talking head content creation server device, a brand association server device, and a content distribution server device, comprising the steps of:
(a) creating, at the photo realistic talking head library creation apparatus, the library of photo realistic talking heads;
(b) storing, at the photo realistic talking head library creation server device, the library of photo realistic talking heads;
(c) creating, at the photo realistic talking head content creation apparatus, the photo realistic talking head content;
(d) storing, at the photo realistic talking head content creation server device, the photo realistic talking head content;
(e) creating, at the photo realistic talking head content creation apparatus, at least one profile;
(f) associating, at the brand association server device, the at least one profile with the photo realistic talking head content one with the other;
(g) storing, at the brand association server device, the at least one profile and information identifying the association between the at least one profile and the photo realistic talking head content;
(h) receiving, at the photo realistic talking head system, at least one instruction from the at least one communications device to communicate the stored photo realistic talking head content to the at least one other communications device;
(i) retrieving, at the photo realistic talking head content creation server device, the photo realistic talking head content;
(j) retrieving, at the brand association server device, the information identifying the association between the at least one profile and the photo realistic talking head content and retrieving the at least one profile;
(k) retrieving, at the brand association server device, at least one stored brand associated with the at least one profile;
(l) incorporating, at the photo realistic talking head content creation server device, the at least one stored brand associated with the at least one profile and the photo realistic talking head content into the photo realistic talking head content;
(m) communicating, from the photo realistic talking head content distribution server device, the photo realistic talking head content comprising the at least one stored brand associated with the at least one profile and the photo realistic talking head content to the at least one other communications device.

2. The process executing on the hardware device of claim 1, wherein the at least one profile comprises at least one profile associated with at least one user of the at least one communications device.

3. The process executing on the hardware device of claim 1, wherein the at least one profile comprises at least one profile associated with at least one user of the at least one other communications device.

4. The process executing on the hardware device of claim 1, wherein the at least one profile comprises at least one first profile associated with at least one user of the at least one communications device and at least one second profile associated with at least one other user of the at least one other communications device.

5. The process executing on the hardware device of claim 1, wherein the at least one stored brand associated with the at least one profile and the photo realistic talking head content comprises at least one advertisement associated with the at least one profile.

6. The process executing on the hardware device of claim 5, wherein the at least one stored brand associated with the at least one profile and the photo realistic talking head content comprises at least one advertisement associated with the at least one first profile and the at least one second profile.

7. The process executing on the hardware device of claim 1, wherein the brand association server device comprises at least one database comprising the at least one stored brand associated with the at least one profile.

8. The process executing on the hardware device of claim 1, wherein the step of (a) creating, at the photo realistic talking head library creation apparatus, the library of photo realistic talking heads comprises at least the following steps:
selecting, by a controller, an alignment template from a library of alignment templates,
the photo realistic talking head library creation apparatus comprising the controller,
each of the alignment templates being different one from the other and representational of an alignment template frame of a photo realistic human talking head having an alignment template head angular position, comprising a template head tilt, a template head nod, and a template head swivel component,
each of the alignment template frames different one form the other,
each of the alignment templates head angular positions different one from the other;
collecting an image of a human subject with a video camera,
a handheld device comprising the video camera,
the photo realistic talking head library creation apparatus comprising the handheld device comprising the video camera;
communicating, by the handheld device, the collected image of the human subject to a mixer,
the photo realistic talking head library creation apparatus comprising the mixer;
mixing, by the mixer, the collected image of the human subject with an image of the selected alignment template in the mixer, thus, creating a composite image of the human subject and the selected alignment template;
communicating, from the mixer, the composite image to the handheld device comprising a display for display to the human subject, the display adapted to facilitate the human subject aligning an image of a head of the human subject with the image of the selected alignment template;
substantially aligning the head of the human subject, having a human subject head angular position, comprising a human subject head tilt, a human subject head nod, and a human subject head swivel component, with the image of the selected alignment template head at substantially the same angular position as the selected alignment template head angular position;
collecting, by the handheld device, an image of the substantially aligned human subject;
communicating, by the handheld device, the image of the substantially aligned human subject to the photo realistic talking head library creation server device;
wherein the step (b) of storing, at the photo realistic talking head library creation server device, the library of photo realistic talking heads comprises
storing, by the photo realistic talking head library creation server device, the image of the substantially aligned human subject in a library of collected images,
each of the collected images having a different human subject angular position, which is substantially the same as a the selected alignment template head angular position,
each of the stored images representing a different frame of a photo realistic human talking head.

9. The process executing on the hardware device of claim 1, wherein the photo realistic talking head content is from the group consisting of: photo realistic talking head content, a photo realistic talking head synchronized to a spoken voice of a human subject, a photo realistic talking head, at least one portion of a photo realistic talking head, a photo realistic talking head depicting animated behavior of a human subject, at least one frame of an image of a human subject, at least one portion of at least one frame of an image of a human subject, a plurality of frames of images of a human subject, a plurality of portions of at least one frame of an image of a human subject, a plurality of portions of a plurality of frames of a plurality of images of a human subject, a plurality of frames of a plurality of images of a human subject representing an animated photo realistic talking head, a plurality of frames of a photo realistic talking head library representing an animated photo realistic talking head, text, at least one image, a plurality of images, at least one background image, a plurality of background images, at least one video, a plurality of videos, audio, music, multimedia content, and any combination of one or more thereof.

10. The process executing on the hardware device of claim 1, wherein the photo realistic talking head library comprises a plurality of stored images, each stored image of the plurality of stored images representing a different frame of an image of a human subject of the library of photo realistic talking heads, the step of (a) creating, at the photo realistic talking head library creation apparatus, the library of photo realistic talking heads further comprises:
associating the each stored image of the plurality of stored images representing the different frame of the image of the human subject of the library of photo realistic talking heads with a different phoneme of a plurality of different phonemes;
the step of (b) storing, at the photo realistic talking head library creation server device, the library of photo realistic talking heads further comprises:
storing, at the photo realistic talking head library creation server device, information identifying the association of the each associated stored image of the plurality of stored images representing the different frame of the image of the human subject of the library of photo realistic talking heads associated with the different phoneme of the plurality of different phonemes and storing the different phoneme of the plurality of different phonemes.

11. The process executing on the hardware device of claim 10, wherein the storing, at the photo realistic talking head library creation server device, information identifying the association of the each associated stored image of the plurality of stored images representing the different frame of the image of the human subject of the library of photo realistic talking heads associated with the different phoneme of the plurality of different phonemes comprises:
storing the information identifying the association of the each associated stored image of the plurality of stored images representing the different frame of the image of the human subject of the library of photo realistic talking heads associated with the different phoneme of the plurality of different phonemes in at least one database.

12. The process executing on the hardware device of claim 10, wherein the step of (c) creating, at the photo realistic talking head content creation apparatus, the photo realistic talking head content comprises at least the following steps:
receiving, at the photo realistic talking head content creation apparatus, at least one phoneme representational of a voice of a human subject;
determining, at the photo realistic talking head content creation apparatus, at least one closest matching phoneme of the plurality of different phonemes stored at the photo realistic talking head content creation apparatus that substantially matches the at least one phoneme representational of the voice of the human subject;
retrieving, at the photo realistic talking head content creation apparatus, the information identifying the association between the at least one phoneme corresponding to the at least one closest matching phoneme and the each associated stored image of the plurality of stored images representing the different frame of the image of the human subject of the library of photo realistic talking heads;
incorporating, at the photo realistic talking head content creation apparatus, the different frame of the image of the human subject of the library of photo realistic talking heads corresponding to the at least one phoneme corresponding to the at least one closest matching phoneme into the photo realistic talking head content.

13. The process executing on the hardware device of claim 10, wherein the step of (c) creating, at the photo realistic talking head content creation apparatus, the photo realistic talking head content comprises at least the following steps:
receiving, at the photo realistic talking head content creation apparatus, at least two phonemes representational of a voice of a human subject;
determining, at the photo realistic talking head content creation apparatus, at least two closest matching phonemes of the plurality of different phonemes stored at the photo realistic talking head content creation apparatus that substantially match the at least two phonemes representational of the voice of the human subject;
retrieving, at the photo realistic talking head content creation apparatus, information identifying the association between the at least two phonemes corresponding to the at least two closest matching phonemes and at least two associated stored images of the plurality of stored images representing different frames of the image of the human subject of the library of photo realistic talking heads;
incorporating, at the photo realistic talking head content creation apparatus, the different frames of the image of the human subject of the library of photo realistic talking heads corresponding to the at least two phonemes corresponding to the at least two closest matching phonemes into the photo realistic talking head content.

14. The process executing on the hardware device of claim 13, wherein the at least two phonemes comprise a sequence of a plurality of phonemes.

15. The process executing on the hardware device of claim 8, wherein the photo realistic talking head library comprises a plurality of stored images, each stored image of the plurality of stored images representing a different frame of an image of a human subject of the library of photo realistic talking heads, the step of (a) creating, at the photo realistic talking head library creation apparatus, the library of photo realistic talking heads further comprises:
associating the each stored image of the plurality of stored images representing the different frame of the image of the human subject of the library of photo realistic talking heads with a different phoneme of a plurality of different phonemes;
the step of (b) storing, at the photo realistic talking head library creation server device, the library of photo realistic talking heads further comprises:
storing, at the photo realistic talking head library creation server device, information identifying the association of the each associated stored image of the plurality of stored images representing the different frame of the image of the human subject of the library of photo realistic talking heads associated with the different phoneme of the plurality of different phonemes and storing the different phoneme of the plurality of different phonemes.

16. The process executing on the hardware device of claim 15, wherein the step of (c) creating, at the photo realistic talking head content creation apparatus, the photo realistic talking head content comprises at least the following steps:
receiving, at the photo realistic talking head content creation apparatus, at least one phoneme representational of a voice of a human subject;
determining, at the photo realistic talking head content creation apparatus, at least one closest matching phoneme of the plurality of different phonemes stored at the photo realistic talking head content creation apparatus that substantially matches the at least one phoneme representational of the voice of the human subject;
retrieving, at the photo realistic talking head content creation apparatus, the information identifying the association between the at least one phoneme corresponding to the at least one closest matching phoneme and the each associated stored image of the plurality of stored images representing the different frame of the image of the human subject of the library of photo realistic talking heads;
incorporating, at the photo realistic talking head content creation apparatus, the different frame of the image of the human subject of the library of photo realistic talking heads corresponding to the at least one phoneme corresponding to the at least one closest matching phoneme into the photo realistic talking head content.

17. The process executing on the hardware device of claim 16, wherein the at least one profile comprises at least one profile associated with at least one user of the at least one communications device.

18. The process executing on the hardware device of claim 16, wherein the at least one profile comprises at least one profile associated with at least one user of the at least one other communications device.

19. The process executing on the hardware device of claim 16, wherein the at least one profile comprises at least one first profile associated with at least one user of the at least one communications device and at least one second profile associated with at least one other user of the at least one other communications device.

20. The process executing on the hardware device of claim 16, wherein the at least one stored brand associated with the at least one profile and the photo realistic talking head content comprises at least one advertisement associated with the at least one profile.

21. The process executing on the hardware device of claim 20, wherein the at least one stored brand associated with the at least one profile and the photo realistic talking head content comprises at least one advertisement associated with the at least one first profile and the at least one second profile.

22. The process executing on the hardware device of claim 16, wherein the brand association server device comprises at least one database comprising the at least one stored brand associated with the at least one profile.

23. The process executing on the hardware device of claim 15, wherein the step of (c) creating, at the photo realistic talking head content creation apparatus, the photo realistic talking head content comprises at least the following steps:
receiving, at the photo realistic talking head content creation apparatus, at least two phonemes representational of a voice of a human subject;
determining, at the photo realistic talking head content creation apparatus, at least two closest matching phonemes of the plurality of different phonemes stored at the photo realistic talking head content creation apparatus that substantially match the at least two phonemes representational of the voice of the human subject;
retrieving, at the photo realistic talking head content creation apparatus, information identifying the association between the at least two phonemes corresponding to the at least two closest matching phonemes and at least two associated stored images of the plurality of stored images representing different frames of the image of the human subject of the library of photo realistic talking heads;
incorporating, at the photo realistic talking head content creation apparatus, the different frames of the image of the human subject of the library of photo realistic talking heads corresponding to the at least two phonemes corresponding to the at least two closest matching phonemes into the photo realistic talking head content.

24. A hardware system comprising a photo realistic talking head system for creating a photo realistic talking head library, creating photo realistic talking head content, inserting branding into the content, and distributing the content comprising the branding on a distributed network from at least one communications device to at least one other communications device, the photo realistic talking head system comprising a photo realistic talking head library creation apparatus, a photo realistic talking head library creation server device, a photo realistic talking head content creation apparatus, a photo realistic talking head content creation server device, a brand association server device, and a content distribution server device, comprising:
(a) means for creating, at the photo realistic talking head library creation apparatus, the library of photo realistic talking heads;
(b) means for storing, at the photo realistic talking head library creation server device, the library of photo realistic talking heads;
(c) means for creating, at the photo realistic talking head content creation apparatus, the photo realistic talking head content;
(d) means for storing, at the photo realistic talking head content creation server device, the photo realistic talking head content;
(e) means for creating, at the photo realistic talking head content creation apparatus, at least one profile;
(f) means for associating, at the brand association server device, the at least one profile with the photo realistic talking head content one with the other;
(g) means for storing, at the brand association server device, the at least one profile and information identifying the association between the at least one profile and the photo realistic talking head content;
(h) means for receiving, at the photo realistic talking head system, at least one instruction from the at least one communications device to communicate the stored photo realistic talking head content to the at least one other communications device;
(i) means for retrieving, at the photo realistic talking head content creation server device, the photo realistic talking head content;
(j) means for retrieving, at the brand association server device, the information identifying the association between the at least one profile and the photo realistic talking head content and retrieving the at least one profile;
(k) means for retrieving, at the brand association server device, at least one stored brand associated with the at least one profile;
(l) means for incorporating, at the photo realistic talking head content creation server device, the at least one stored brand associated with the at least one profile and the photo realistic talking head content into the photo realistic talking head content;
(m) means for communicating, from the photo realistic talking head content distribution server device, the photo realistic talking head content comprising the at least one stored brand associated with the at least one profile and the photo realistic talking head content to the at least one other communications device.

25. A hardware computer readable storage medium comprising a photo realistic talking head system containing computer executable instructions for creating a photo realistic talking head library, creating photo realistic talking head content, inserting branding into the content, and distributing the content comprising the branding on a distributed network from at least one communications device to at least one other communications device, the photo realistic talking head system comprising a photo realistic talking head library creation apparatus, a photo realistic talking head library creation server device, a photo realistic talking head content creation apparatus, a photo realistic talking head content creation server device, a brand association server device, and a content distribution server device, causing one or more computers to:
(a) create, at the photo realistic talking head library creation apparatus, the library of photo realistic talking heads;
(b) store, at the photo realistic talking head library creation server device, the library of photo realistic talking heads;
(c) create, at the photo realistic talking head content creation apparatus, the photo realistic talking head content;
(d) store, at the photo realistic talking head content creation server device, the photo realistic talking head content;
(e) create, at the photo realistic talking head content creation apparatus, at least one profile;
(f) associate, at the brand association server device, the at least one profile with the photo realistic talking head content one with the other;
(g) store, at the brand association server device, the at least one profile and information identifying the association between the at least one profile and the photo realistic talking head content;
(h) receive, at the photo realistic talking head system, at least one instruction from the at least one communications device to communicate the stored photo realistic talking head content to the at least one other communications device;
(i) retrieve, at the photo realistic talking head content creation server device, the photo realistic talking head content;
(j) retrieve, at the brand association server device, the information identifying the association between the at least one profile and the photo realistic talking head content and retrieving the at least one profile;
(k) retrieve, at the brand association server device, at least one stored brand associated with the at least one profile;
(l) incorporate, at the photo realistic talking head content creation server device, the at least one stored brand associated with the at least one profile and the photo realistic talking head content into the photo realistic talking head content;
(m) communicate, from the photo realistic talking head content distribution server device, the photo realistic talking head content comprising the at least one stored brand associated with the at least one profile and the photo realistic talking head content to the at least one other communications device.

26. A hardware apparatus comprising a photo realistic talking head system for creating a photo realistic talking head library, creating photo realistic talking head content, inserting branding into the content, and distributing the content comprising the branding on a distributed network from at least one communications device to at least one other communications device, the photo realistic talking head system comprising a photo realistic talking head library creation apparatus, a photo realistic talking head library creation server device, a photo realistic talking head content creation apparatus, a photo realistic talking head content creation server device, a brand association server device, and a content distribution server device, comprising:
(a) a photo realistic talking head library creator creating, at the photo realistic talking head library creation apparatus, the library of photo realistic talking heads;
(b) a photo realistic talking head library storer storing, at the photo realistic talking head library creation server device, the library of photo realistic talking heads;
(c) a photo realistic talking head content creator creating, at the photo realistic talking head content creation apparatus, the photo realistic talking head content;
(d) a photo realistic talking head content storer storing, at the photo realistic talking head content creation server device, the photo realistic talking head content;
(e) a photo realistic talking head profile creator creating, at the photo realistic talking head content creation apparatus, at least one profile;
(f) an associater associating, at the brand association server device, the at least one profile with the photo realistic talking head content one with the other;
(g) a brand insertion storer storing, at the brand association server device, the at least one profile and information identifying the association between the at least one profile and the photo realistic talking head content;
(h) a receiver receiving, at the photo realistic talking head system, at least one instruction from the at least one communications device to communicate the stored photo realistic talking head content to the at least one other communications device;
(i) a photo realistic talking head content retriever retrieving, at the photo realistic talking head content creation server device, the photo realistic talking head content;
(j) a brand association retriever retrieving, at the brand association server device, the information identifying the association between the at least one profile and the photo realistic talking head content and retrieving the at least one profile;
(k) a brand retriever retrieving, at the brand association server device, at least one stored brand associated with the at least one profile;
(l) an incorporator incorporating, at the photo realistic talking head content creation server device, the at least one stored brand associated with the at least one profile and the photo realistic talking head content into the photo realistic talking head content;
(m) a communicator communicating, from the photo realistic talking head content distribution server device, the photo realistic talking head content comprising the at least one stored brand associated with the at least one profile and the photo realistic talking head content to the at least one other communications device.
